(19) United States
(12) Patent Application Publication
(10) Pub. No.: US 2008/0226888 A1
(43) Pub. Date: Sep. 18, 2008

(54) Cellulose Acylate Film, Polarizing Plate and Liquid Crystal Display Device Using the Same

(75) Inventors: Hiroyuki Kawanishi, Minami-Ashigara-shi (JP); Akiko Watano, Minami-Ashigara-shi (JP)

Correspondence Address: BUCHANAN, INGERSOLL & ROONEY PC, POST OFFICE BOX 1404, ALEXANDRIA, VA, 22313-1404, US

(73) Assignee: FUJIFILM Corporation, Minato-ku (JP)

(21) Appl. No.: 12/047,569

(22) Filed: Mar. 13, 2008

(30) Foreign Application Priority Data
Mar. 14, 2007 (JP) 2007-064987

(51) Int. Cl. B32B 23/00; G02F 1/1335

(52) U.S. Cl. 428/220; 349/96; 349/117

(57) ABSTRACT

A cellulose acylate film comprising a cellulose acylate satisfying formulae (I) to (III),

2.0≦A+B≦2.8 Formula (I)

0.3≦A≦1.4 Formula (II)

0.6≦B≦2.5 Formula (III)
wherein in formulae (I) to (III), A is the substitution degree by an acetyl group to the hydroxyl group of the glucose unit of the cellulose acylate, and B is the substitution degree by an acyl group having a carbon number of 3 or more to the hydroxyl group of the glucose unit of the cellulose acylate, and
wherein a width of a cast film when casting a dope comprising the cellulose acylate is from 2,000 to 4,000 mm, and
the cellulose acylate film is formed through the cast film.

### BACKGROUND OF THE INVENTION

1. Field of the Invention

The present invention relates to a cellulose acylate film, and a polarizing plate and a liquid crystal display device using the cellulose acylate film as an optical compensation sheet.

2. Description of the Related Art

A liquid crystal display device is widely used for a monitor of personal computers or potable appliances or for a television because of its various advantages such as low voltage/low power consumption and capability of downsizing and thinning. For such a liquid crystal display device, various modes have been proposed according to the aligned state of liquid crystal molecules in the liquid crystal cell, but a TN mode creating an aligned state where liquid crystals are twisted at about 90° toward the upper substrate from the lower substrate of the liquid cell is conventionally predominating.

The liquid crystal display device generally comprises a liquid crystal cell, an optical compensation film and a polarizer. The optical compensation film is used for canceling the image coloration or enlarging the viewing angle, and a stretched birefringent film or a film obtained by coating a liquid crystal on a transparent film is used therefor. For example, Japanese Patent 2,587,398 discloses a technique where an optical compensation sheet obtained by coating, aligning and fixing a discotic liquid crystal on a triacetyl cellulose film is applied to a TN-mode liquid crystal cell to enlarge the viewing angle. However, the requirement regarding the viewing angle dependency of a liquid crystal display device for a large-screen television envisaged as being viewed from various angles is severe and this requirement cannot be satisfied by the above-described technique. Therefore, studies are being made on a liquid crystal display device in a mode different from the TN mode, such as IPS (in-plane switching) mode, OCB (optically compensatory bend) mode and VA (vertically aligned) mode. In particular, the VA mode is assured of high contrast and relatively high yield in the production and is being taken note of as a liquid crystal display device for television use.

An optical compensation film is proposed for liquid crystal cells of various modes.

In particular, a cellulose acylate film having two functions as both protective film and optical compensation film of a polarizing plate is being widely used, and various proposals have been made thereon.

Above all, JP-A-2006-169303 and JP-A-2006-169305 have proposed a cellulose acylate favoring a wide developing region of Re and Rth and a small change in optical characteristics due to humidity, and specifically, a retardation developer-containing cellulose acetate propionate film or cellulose acetate butyrate film is disclosed.

The present inventors studied on a cellulose acylate optical film applicable to a large-screen liquid crystal television based on conventional techniques but encountered a problem that as the width of the cast film increases, a film with good performance in terms of optical unevenness is more difficult to obtain.

Thus, it becomes necessary to find means for improving the optical unevenness in an optical compensation film having a large area.

As regards the increase in the width of a cellulose acylate film cast or the width of a film produced, disclosures in JP-A-2007-276185 are known.

### SUMMARY OF THE INVENTION

A first object of the present invention is to obtain a cellulose acylate film, even when having a large area, assured of excellent retardation developability at the front as well as in the thickness direction and reduced in the optical unevenness attributable to the axial variation in the micro region. A second object of the present invention is to provide a liquid crystal display device with high contrast and less display unevenness and a polarizing plate for use in the liquid crystal display device.

As a result of intensive studies to solve those problems, the present inventors have found that it is effective to control the substitution degree of the raw material cellulose acylate of a cellulose acylate film (assuming that the acetyl substitution degree is A and the substitution degree by an acyl group having a carbon number of 3 or more is B) to 2.0≦A+B≦2.8, 0.3≦A≦1.4, and 0.6≦B≦2.5, in particular, to 2.0≦A+B≦2.3, 1.1≦A≦1.4, and 0.6≦B≦0.9.

Conventionally, a mixed fatty acid cellulose ester having an acetyl/propionyl group has been considered to be undesirable, because the mechanical strength of the film is insufficient due to expansion of the aggregation state between polymer chains and weakened interaction between molecular chains. However, in use as a phase difference film or a polarizing plate protective film, there is no problem in practice and for example, as to the handling during the production process, by virtue of remarkable progress of the transport technique in recent years, handling is enabled without problem.

At the time of casting and drying a cellulose acylate film, when the cast width is wide, particularly, in the case of 2,000 mm or more, the drying load becomes large and therefore, it is necessary to set the drying condition to a high-temperature condition and increase the air volume.

In the process of drying the cast film, a half-dry film having a certain thickness, called “surface skin layer”, is formed on the cast film surface.

Formation of a surface skin layer having a certain thickness or more causes non-uniformity in the microstructure of the dried cellulose acylate film, for example, in the orientation degree or crystallinity of the film. Accordingly, when a surface skin layer is formed, optical unevenness is likely to be readily generated.

Intensive investigations on the method not causing the formation of a surface skin layer have lead to the finding that when the substitution degree by an acetyl group and the substitution degree by an acyl group having a carbon number of 3 or more, such as propionyl group, are adjusted to optimal ranges, the free volume between cellulose polymer main chains is increased to allow for a higher drying speed as compared with a cellulose acetate film having the same substitution degrees and at the same time, uniform gelling proceeds in the thickness direction when the dope is gelled in the drying process, as a result, a surface skin layer is not formed or becomes a very thin film. At this time, it has been also newly found that the degree of generation of optical unevenness is extremely low and the unevenness of the film is improved. The present invention has been accomplished based on these findings. In particular, this method is found to be effective in suppressing the optical unevenness when the cast width is 2,000 mm or more.

That is, the above-described objects of the present invention are attained by the following means.

[1] A cellulose acylate film comprising a cellulose acylate satisfying formulae (I) to (III),

2.0≦A+B≦2.8 Formula (I)

0.3≦A≦1.4 Formula (II)

0.6≦B≦2.5 Formula (III)

wherein in formulae (I) to (III), A is the substitution degree by an acetyl group to the hydroxyl group of the glucose unit of the cellulose acylate, and B is the substitution degree by an acyl group having a carbon number of 3 or more to the hydroxyl group of the glucose unit of the cellulose acylate, and

wherein a width of a cast film when casting a dope comprising the cellulose acylate is from 2,000 to 4,000 mm, and

the cellulose acylate film is formed through the cast film.

[2] The cellulose acylate film as described in [1],

wherein the cellulose acylate further satisfies formulae (I′) to (III′):

2.0≦A+B≦2.3 Formula (I′)

1.1≦A≦1.4 Formula (II′)

0.6≦B≦0.9 Formula (III′)

wherein in formulae (I′) to (III′), A and B have the same definitions as in formulae (I) to (III).

[3] The cellulose acylate film as described in [1] or [2], wherein the acyl group having a carbon number of 3 or more is a propionyl group.

[4] The cellulose acylate film as described in any of [1] to [3], wherein retardation values of the cellulose acylate film satisfy formulae (IV) and (V):

90 nm≦Rth≦160 nm Formula (IV)

30 nm≦Re≦80 nm Formula (V)

wherein in formulae (IV) and (V), Rth is a retardation value in a thickness direction of the cellulose acylate film for light at a wavelength of 590 nm at a humidity in an environment of 25° C. and 60% RH, and Re is a retardation value in an in-plane direction of the cellulose acylate film for light at a wavelength of 590 nm at a humidity in an environment of 25° C. and 60% RH (unit: nm).

[5] The cellulose acylate film as described in [1] to [4], wherein a standard deviation of a slow axis angle variation of the cellulose acylate film is 1.0° or less, and a PV value of a thickness of the cellulose acylate film is 1.0 μm or less.

[6] The cellulose acylate film as described in any one of [1] to [5], which comprises at least one kind of retardation developer comprising a rod-like or discotic compound.

[7] The cellulose acylate film as described in any one of [1] to [6], which has been subjected to stretching with a stretch ratio of from 10 to 100%.

[8] The cellulose acylate film as described in any one of [1] to [7], which has been subjected to stretching, wherein, at the starting time of the stretching, the cellulose acylate film had had a residual solvent amount of 1 mass % or less.

[9] The cellulose acylate film as described in any one of [1] to [8], which has a thickness of from 20 to 60 μm.

[10] A polarizing plate comprising: a polarizer: and two transparent protective films disposed on both sides of the polarizer, wherein at least one of the two transparent protective films is the cellulose acylate film in any one of [1] to [9].

[11] A polarizing plate as described in [10], further comprising, on a surface of one of the two transparent protective films, at least one of a hardcoat layer, an antiglare layer and an antireflection layer.

[12] A liquid crystal display device comprising either the cellulose acylate film as described in [1] to [9] or the polarizing plate as described in [10] and [11].

[13] An OCB- or VA-mode liquid crystal display device comprising: two sheets each of which is the polarizing plate as described in [10] or [1,1]; and a cell between the two sheets.

### BRIEF DESCRIPTION OF THE DRAWINGS

FIG. 1 is a schematic view showing one example of the method for laminating the cellulose acylate film at the production of the polarizing plate of the present invention;

FIG. 2 is a cross-sectional view schematically showing one example of the cross-sectional structure of the polarizing plate of the present invention; and

FIG. 3 is a cross-sectional view schematically showing one example of the cross-sectional structure of the liquid crystal display device of the present invention.

### DETAILED DESCRIPTION OF THE INVENTION

The present invention is described in detail below.

### <Cellulose Acylate Film>

The cellulose acylate film of the present invention is described blow,

The cellulose acylate film of the present invention contains a cellulose acylate satisfying the following formulae (I) to (III):

2.0≦A+B≦2.8 Formula (I)

0.3≦A≦1.4 Formula (II)

0.6≦B≦2.5 Formula (III)

(wherein in formulae (I) to (III), A is the substitution degree by an acetyl group to the hydroxyl group of the glucose unit of said cellulose acylate, and B is the substitution degree by an acyl group having a carbon number of 3 or more to the hydroxyl group of the glucose unit of said cellulose acylate).

Furthermore, in the present invention, a cellulose acylate satisfying the following formulae (I′) to (III′) is preferred.

2.0≦A+B≦2.3 Formula (I′)

1.1≦A≦1.4 Formula (II′)

0.6≦B≦0.9 Formula (III′)

(wherein in formulae (I′) to (III′), A and B have the same definitions as in formulae (I) to (III)).

The cellulose acylate for use in the present invention is described in detail below.

### [Cellulose Acylate]

The cellulose acylate for use in the present invention satisfies formulae (I) to (III) and preferably satisfies formulae (I′) to (III′). Also, a mixture of two or more different kinds of cellulose acylates may be used in the present invention.

The cellulose acylate satisfying formulae (I) to (III) (preferably satisfying formulae (I′) to (III′)) is a mixed fatty acid ester of cellulose, obtained by substituting the hydroxyl groups of cellulose by an acetyl group and an acyl group having a carbon number of 3 or more.

The β-1,4-bonded glucose unit constituting cellulose has a free hydroxyl group at the 2-position, 3-position and 6-position. The cellulose acylate is a polymer obtained by esterifying a part or all of these hydroxyl groups by an acyl group. The acyl substitution degree means a ratio at which the cellulose is esterified (the substitution degree is 1 when 100% esterified), with respect to each of the 2-position, 3-position and 6-position.

If A+B is less than 2.0, the hydrophilicity is intensified and when a film is formed, the optical characteristics are susceptible to the ambient humidity, whereas if it exceeds 2.8, the region in which the optical characteristics are expressed becomes small and this gives rise to an adverse effect in usage as a high phase difference film. Also, if B is less than 0.6, the property becomes close to that of cellulose acetate and the optical characteristics are susceptible to the ambient humidity, whereas if B exceeds 2.5, this advantageously causes a problem in the thermal characteristics of film, for example, the thermal expansion coefficient increases.

Preferably, 28% or more of B is a substituent of the 6-position hydroxyl group, more preferably 30% or more, still more preferably 31% or more, is a substituent of the 6-position hydroxyl group; and yet still more preferably, 32% or more is a substituent of the 6-position hydroxyl group.

The sum of substitution degrees of A and B at the 6-position of the cellulose acylate is preferably 0.75 or more, more preferably 0.80 or more, still more preferably 0.85 or more. By virtue of such a cellulose acylate film, a solution for film preparation can be produced with preferred filterability, and a good solution can be produced even in a chlorine-free organic solvent. Furthermore, a solution with low viscosity and good filterability can be produced.

In the present invention, the substitution degree of each substituent can be measured by a method of measuring the substitution state of an acetyl group, a propionyl group or a butyryl group to the 2-position, 3-position and 6-position with use of ¹³C-NMR, described in Y. Tezuka, et al., Carbohydrate Research, Vol. 273, pp. 83-91 (1995).

The acyl group having a carbon member of 3 or more (B) may be an aliphatic group or an aromatic hydrocarbon group and is not particularly limited. Examples thereof include an alkylcarbonyl ester of cellulose, an alkenylcarbonyl ester of cellulose, an aromatic carbonyl ester of cellulose and an aromatic alkylcarbonyl ester of cellulose, which each may have a group substituted thereto. Preferred examples of B include propionyl, butanoyl, keptanoyl, hexanoyl, octanoyl, decanoyl, dodecanoyl, tridecanoyl, tetradecanoyl, hexadecanoyl, octadecanoyl, iso-butanoyl, tert-butanoyl, cyclohexanecarbonyl, oleoyl, benzoyl, naphthylcarbonyl and cinnamoyl. Among these, preferred are propionyl, butanoyl, dodecanoyl, octadecanoyl, tert-butanoyl, oleoyl, benzoyl, naphthylcarbonyl and cinnamoyl, more preferred are propionyl and butanoyl and most preferred is a propionyl group.

Specific examples of the cellulose acylate include cellulose acetate, cellulose acetate propionate and cellulose acetate butyrate. Among these, cellulose acetate propionate is most preferred.

### [Optical Characteristics of Cellulose Acylate Film]

In the context of the present invention, Re(λ) and Rth(λ) indicate the in-plane retardation and the retardation in the thickness direction, respectively, at a wavelength of λ. Re(λ) is measured by making light at a wavelength of λ nm to be incident in the film normal direction in KOBRA 21ADH or WR (manufactured by Oji Scientific Instruments).

In the case where the film measured is a film expressed by a uniaxial or biaxial refractive index ellipsoid, Rth(λ) is calculated by the following method.

The above-described Re(λ) is measured at 6 points in total by making light at a wavelength of λ nm to be incident from directions inclined with respect to the film normal direction in 10° steps up to 50° on one side from the normal direction with the in-plane slow axis (judged by KOBRA 21ADH or WR) being used as the inclination axis (rotation axis) (when the slow axis is not present, an arbitrary direction in the film plane is used as the rotation axis) and based on the retardation values measured, assumed values of average refractive index and film thickness values input, Rth(λ) is calculated by KOBRA 21 ADH or WR.

In the above, when the film has a direction where the retardation value becomes zero at a certain inclination angle from the normal direction with the rotation axis being the in-plane slow axis, the retardation value at an inclination angle larger than that inclination angle is calculated by KOBRA 21 ADH or WR after converting its sign into a negative sign.

Incidentally, after measuring the retardation values from two arbitrary inclined directions by using the slow axis as the inclination axis (rotation axis) (when the slow axis is not present, an arbitrary direction in the film plane is used as the rotation axis), based on the values obtained, assumed values of average refractive index and film thickness values input, Rth can also be calculated according to the following mathematical formulae (21) and (22).

### Mathematical Formula (21):

$$Re ( θ ) = [ nx - \frac{ny \times nz}{\sqrt{\begin{matrix}{\{ ny sin ( {sin}^{- 1} ( \frac{sin ( - θ )}{nx} ) ) \}}^{2} + \\ {\{ nz cos ( {sin}^{- 1} ( \frac{sin ( - θ )}{nx} ) ) \}}^{2}\end{matrix}}} ] \times \frac{d}{cos \{ {sin}^{- 1} ( \frac{sin ( –θ )}{nx} ) \}}$$

Re(θ) above represents the retardation value in the direction inclined at an angle of θ from the normal direction.

In mathematical formula (21), nx represents the refractive index in the in-plane slow axis direction, ny represents the refractive index in the direction crossing with nx at right angles in the plane, nz represents the refractive index in the direction crossing with nx and ny at right angles, and d represents the thickness of the film.

### Mathematical Formula (22):

$$Rth = [ \frac{nx + ny}{2} - nz ] \times d$$

In the case where the film measured is a film incapable of being expressed by a uniaxial or biaxial refractive index ellipsoid or a film not having a so-called optic axis, Rth(λ) is calculated by the following method.

The above-described Re(λ) is measured at 11 points by making light at a wavelength of λ nm to be incident from directions inclined with respect the film normal direction in 10° steps from −50° to +50° with the inclination axis (rotation axis) being the in-plane slow axis (judged by KOBRA 21ADH or WR) and based on the retardation values measured, assumed values of average refractive index and film thickness values input, Rth(λ) is calculated by KOBRA 21ADH or WR.

In the measurement above, as for the assumed value of average refractive index, the values described in Polymer Handbook (John Wiley & Sons, Inc.) and catalogues of various optical films can be used. The average refractive index of which value is unknown can be measured by an Abbe refractometer. The values of average refractive index of main optical films are as follows: cellulose acylate (1.48), cycloolefin polymer (1.52), polycarbonate (1.59), polymethyl methacrylate (1.49) and polystyrene (1.59). When such an assumed value of average refractive index and the film thickness are input, KOBRA 21ADH or WR calculates nx, ny and nz and from these calculated nx, ny and nz, Nz=(nx−nz)/(nx−ny) is further calculated.

The retardation values of the cellulose acylate film of the present invention preferably satisfy the following formulae (IV) and (V):

90 nm≦Rth≦160 nm Formula (IV)

30 nm≦Re≦80 nm Formula (V)

(wherein in formulae (IV) and (V), Rth is the retardation value in the thickness direction of the film for light at a wavelength of 590 nm at the humidity in an environment of 25° C. and 60% RH, and Re is the retardation value in the in-plane direction of the film for light at a wavelength of 590 nm at the humidity in an environment of 25° C. and 60% RH (unit: nm)).

With Re and Rth in these ranges, when the film is mounted on a liquid crystal display device, the viewing angle and contrast are good and this is preferred.

As for the optical characteristics of the cellulose acylate film of the present invention, Re(λ) and Rth(λ) measured for light at a wavelength of λ nm at the humidity in an environment of 25° C. and 60% RH preferably satisfy the following formulae (A) to (D):

0.90≦Re(480)/Re(590)≦1.10 (A)

0.90≦Re(630)/Re(590)≦1.10 (B)

0.90≦Rth(480)/Rth(590)≦1.10 (C)

0.90≦Rth(630)/Rth(590)≦1.10 (D)

It is more preferred to satisfy the following formulae (A1) to (D1):

0.95≦Re(480)/Re(590)≦1.05 (A1)

0.95≦Re(630)/Re(590)≦1.05 (B1)

0.95≦Rth(480)/Rth(590)≦1.05 (C1)

0.95≦Rth(630)/Rth(590)≦1.05 (D1)

The in-plane retardation Re and retardation Rth in the thickness direction of the cellulose acylate film of the present invention both are preferably less changed due to humidity. Specifically, the different ΔRe (=|Re10% RH−Re80% RH|) between the Re value at 25° C.-10% RH and the Re value at 25° C.−80% RH is preferably from 0 to 25 nm, more preferably from 0 to 15 nm, still more preferably from 0 to 10 nm. Also, the different ΔRth (=|Rth10% RH−Rth80% RH|) between the Rth value at 25° C.-10% RH and the Rth value at 25° C.-80% RH is preferably from 0 to 50 nm, more preferably from 0 to 40 nm, still more preferably from 0 to 35 nm.

The standard deviation of the slow axis angle variation of the cellulose acylate film of the present invention is preferably 1.0° or less, and the PV value of the film thickness is preferably 1.0 μm or less.

The slow axis angle variation can be measured by an automatic birefringence meter (KOBRA 21DH, manufactured by Oji Scientific Instruments). The slow axis angles at 13 points over the entire width in the width direction at equal intervals are determined, and the difference between the maximum value and the minimum value of the angles is taken as the slow axis angle valuation.

As for the standard deviation of the slow axis angle variation, the slow axis angle variation described above is calculated at intervals of 1 m in the longitudinal direction, and the average value of the slow axis angle variation for the portion of 100 points (the portion of 100 m) x̅ is calculated according to

$$\overline{x} = \frac{1}{n} {\sum }_{i = 1}^{n} {x}_{i}$$

(wherein xi is each slow axis angle variation and n is 100). Dispersion σ is determined according to the following formula:

$${σ}^{2} = \frac{1}{n} {\sum }_{i = 1}^{n} {( {x}_{i} - \overline{x} )}^{2}$$

and the square root thereof is defined as the standard deviation, that is, the standard deviation of the slow axis angle variation.

The standard deviation of the slow axis angle variation is preferably from 0 to 0.5, more preferably from 0 to 0.45, still more preferably from 0 to 0.4.

By setting the standard deviation of the slow axis angle variation to this range, the slow axis comes to have excellent uniformity in the width and longitudinal directions and is advantageously aligned in terms of the direction over the entire region of a lengthy roll film.

Incidentally, the slow axis angle of a sample (70 mm×100 mm) is calculated by an automatic birefringence meter (KOBRA 21DH, manufactured by Oji Scientific Instruments) from the phase difference when incident light is made to vertically enter the sample.

In the present invention, the PV value (the difference between the highest point (peak) and the lowest point (vally)) of the film thickness can be measured by laser interferometer FX-03 produced by FUJINON CORPORATION. At this time, the measurement area is set to the range of φ=60 mm in diameter.

The thus-measured PV value of the film thickness is preferably 0.6 μm or less, more preferably 0.55 μm or less, and most preferably 0.5 μm or less.

By setting the PV value to the range above, the film thickness unevenness is reduced and this is advantageous in view of surface state.

### [Retardation Developer]

In the present invention, a retardation developer comprising a rod-like or discotic compound may be used for developing the retardation value. At least one kind of a retardation developer can be used. The retardation developer is preferably used in the range from 0.05 to 20 parts by mass, more preferably from 0.1 to 10 parts by mass, still more preferably from 0.2 to 5 parts by mass, and most preferably from 0.5 to 2 parts by mass, per 100 parts by mass of the polymer. Two or more kinds of retardation developers may be used in combination.

The retardation developer preferably has maximum absorption in the wavelength region of 250 to 400 nm and preferably has an aromatic ring and has substantially no absorption in the visible region.

In the context of the present invention, the “aromatic ring” includes an aromatic hydrocarbon ring and an aromatic hetero ring.

The aromatic hydrocarbon ring is preferably a 6-membered ring (that is, benzene ring).

The aromatic hetero ring is generally an unsaturated hetero ring. The aromatic hetero ring is preferably a 5-, 6- or 7-membered ring, more preferably a 5- or 6-membered ring. The aromatic hetero ring generally has a largest number of double bonds. The heteroatom is preferably a nitrogen atom, an oxygen atom or a sulfur atom, more preferably a nitrogen atom. Examples of the aromatic hetero ring include a furan ring, a thiophene ring, a pyrrole ring, an oxazole ring, an isoxazole ring, a thiazole ring, an isothiazole ring, an imidazole ring, a pyrazole ring, a furazan ring, a triazole ring, a pyran ring, a pyridine ring, a pyridazine ring, a pyrimidine ring, a pyrazine ring and a 1,3,5-triazine ring.

As for the aromatic ring, a benzene ring, a condensed benzene ring and biphenyls are preferred. In particular, a 1,3,5-triazine ring is preferably used. Specific preferred examples thereof include compounds disclosed in JP-A-2001-166144.

The number of carbon atoms in the aromatic ring contained in the retardation developer is preferably from 2 to 20, more preferably from 2 to 12, still more preferably from 2 to 8, and most preferably from 2 to 6.

The bonding relationship of two aromatic rings is classified into (a) a case where two aromatic rings form a condensed ring, (b) a case where two aromatic rings are directly bonded by a single bond, and (c) a case where two aromatic rings are bonded through a linking group (a spiro bond cannot be formed because the rings are an aromatic ring). The bonding relationship may be any one of (a) to (c).

Examples of the condensed ring (condensed ring formed by two or more aromatic rings) in (a) include an indene ring, a naphthalene ring, an azulene ring, a fluorene ring, a phenanthrene ring, an anthracene ring, an acenaphthylene ring, a biphenylene ring, a naphthacene ring, a pyrene ring, an indole ring, an isoindole ring, a benzofuran ring, a benzothiophene ring, an indolizine ring, a benzoxazole ring, a benzothiazole ring, a benzimidazole ring, a benzotriazole ring, a purine ring, an indazole ring, a chromene ring, a quinoline ring, an isoquinoline ring, a quinolizine ring, a quinazoline ring, a cinnoline ring, a quinoxaline ring, a phthalazine ring, a pteridine ring, a carbazole ring, an acridine ring, a phenanthridine ring, a xanthene ring, a phenazine ring, a phenothiazine ring, a phenoxathiine ring, a phenoxazine ring and a thianthrene ring. Among these, preferred are a naphthalene ring, an azulene ring, an indole ring, a benzoxazole ring, a benzothiazole ring, a benzimidazole ring, a benzotriazole ring and a quinoline ring.

The single bond in (b) is preferably a bond between carbon atoms of two aromatic rings. Two aromatic rings may be bonded by two or more single bonds to form an aliphatic ring or non-aromatic hetero ring between those two aromatic rings.

The linking group in (c) is also preferably bonded to carbon atoms of two aromatic rings. The linking group is preferably an alkylene group, an alkenylene group, an alkynylene group, —CO—, —O—, —NH—, —S— or a combination thereof. Examples of the linking group comprising the combination are set forth below. In the following examples, right and left sides of the linking group may be reversed.
c1: —CO—O—
c2: —CO—NH—
c3: -alkylene-O—
c4: —NH—CO—NH—
c5: —NH—CO—O—
c6: —O—CO—O—
c7: —O-alkylene-O—
c8: —CO-alkenylene-
c9: —CO-alkenylene-NH—
c10: —CO-alkenylene-O—
c11: -alkylene-CO—O-alkylene-O—CO-alkylene-
c12: —O-alkylene-CO—O-alkylene-O—CO-alkylene-O—
c13: —O—CO-alkylene-CO—O—
c14: —NH—CO-alkenylene-
c15: —O—CO-alkenylene-

The aromatic ring and the linking group each may have a substituent.

Examples of the substituent include a halogen atom (e.g., F, Cl, Br, I), a hydroxyl group, a carboxyl group, a cyano group, an amino group, a nitro group, a sulfo group, a carbamoyl group, a sulfamoyl group, a ureido group, an alkyl group, an alkenyl group, an alkynyl group, an aliphatic acyl group, an aliphatic acyloxy group, an alkoxy group, an alkoxycarbonyl group, an alkoxycarbonylamino group, an alkylthio group, an alkylsulfonyl group, an aliphatic amido group, an aliphatic sulfonamido group, an aliphatic substituted amino group, an aliphatic substituted carbamoyl group, an aliphatic substituted sulfamoyl group, an aliphatic substituted ureido group and a non-aromatic heterocyclic group.

The number of carbon atoms in the alkyl group is preferably from 1 to 8. A chain alkyl group is preferred rather than a cyclic alkyl group, and a linear alkyl group is more preferred. The alkyl group may further have a substituent (e.g., hydroxyl, carboxy, alkoxy, alkyl-substituted amino). Examples of the alkyl group (including a substituted alkyl group) include a methyl group, an ethyl group, an n-butyl group, an n-hexyl group, a 2-hydroxyethyl group, a 4-carboxybutyl group, a 2-methoxyethyl group and a 2-diethylaminoethyl.

The number of carbon atoms in the alkenyl group is preferably from 2 to 8. A chain alkenyl group is preferred rather than a cyclic alkenyl group, and a linear alkenyl group is more preferred. The alkenyl group may further have a substituent. Examples of the alkenyl group include a vinyl group, an allyl group and a 1-hexenyl group.

The number of carbon atoms in the alkynyl group is preferably from 2 to 8. A chain alkynyl group is preferred rather than a cyclic alkynyl group, and a linear alkynyl group is more preferred. The alkynyl group may further have a substituent. Examples of the alkynyl group include an ethynyl group, a 1-butynyl group and a 1-hexynyl group.

The number of carbon atoms in the aliphatic acyl group is preferably from 1 to 10. Examples of the aliphatic acyl group include an acetyl group, a propanoyl group and a butanoyl group.

The number of carbon atoms in the aliphatic acyloxy group is preferably from 1 to 10. Examples of the aliphatic acyloxy group include an acetoxy group.

The number of carbon atoms in the alkoxy group is preferably from 1 to 8. The alkoxy group may further have a substituent (e.g., alkoxy). Examples of the alkoxy group (including a substituted alkoxy group) include a methoxy group, an ethoxy group, a butoxy group and a methoxyethoxy group.

The number of carbon atoms in the alkoxycarbonyl group is preferably from 2 to 10. Examples of the alkoxycarbonyl group include a methoxycarbonyl group and an ethoxycarbonyl group.

The number of carbon atoms in the alkoxycarbonylamino group is preferably from 2 to 10. Examples of the alkoxycarbonylamino group include a methoxycarbonylamino group and an ethoxycarbonylamino group.

The number of carbon atoms in the alkylthio group is preferably from 1 to 12. Examples of the alkylthio group include a methylthio group, an ethylthio group and an octylthio group.

The number of carbon atoms in the alkylsulfonyl group is preferably from 1 to 8. Examples of the alkylsulfonyl group include a methanesulfonyl group and an ethanesulfonyl group.

The number of carbon atoms in the aliphatic amido group is preferably from 1 to 10. Examples of the aliphatic amido group include an acetamido group.

The number of carbon atoms in the aliphatic sulfonamido group is preferably from 1 to 8. Examples of the aliphatic sulfonamido group include a methanesulfonamido group, a butanesulfonamido group and an n-octanesulfonamido group.

The number of carbon atoms in the aliphatic substituted amino group is preferably from 1 to 10. Examples of the aliphatic substituted amino group include a dimethylamino group, a diethylamino group and a 2-carboxyethylamino group.

The member of carbon atoms in the aliphatic substituted carbamoyl group is preferably from 2 to 10. Examples of the aliphatic substituted carbamoyl group include a methylcarbamoyl group and a diethylcarbamoyl group.

The number of carbon atoms in the aliphatic substituted sulfamoyl group is preferably from 1 to 8. Examples of the aliphatic substituted sulfamoyl group include a methylsulfamoyl group and a diethylsulfamoyl group.

The number of carbon atoms in the aliphatic substituted ureido group is preferably from 2 to 10. Examples of the aliphatic substituted ureido group include a methylureido group.

Examples of the non-aromatic heterocyclic group include a piperidino group and a morpholino group.

The molecular weight of the retardation developer is preferably from 300 to 800.

In the present invention, a rod-like compound having a linear molecular structure, or a discotic compound can be preferably used.

The linear molecular structure means that the molecular structure of the rod-like compound is linear when the structure is thermodynamically most stable. The thermodynamically most stable structure can be determined by crystal structure analysis or molecular orbital computation. For example, the molecular orbital computation is performed using a molecular orbital computation software (e.g., WinMOPAC2000, produced by Fujitsu Ltd.), and a molecular structure giving smallest heat of formation of the compound can be determined. The linear molecular structure means that in a thermodynamically most stable structure determined by the computation above, the angle created by the main chain in the molecular structure is 140° or more.

The rod-like compound having at least two aromatic rings is preferably a compound represented by the following formula (I):

Ar¹-L¹-Ar² Formula (I)

In formula (I), Ar¹ and Ar² each independently represents an aromatic group.

In the context of the present invention, the aromatic group includes an aryl group (aromatic hydrocarbon group), a substituted aryl group, an aromatic heterocyclic group and a substituted aromatic heterocyclic group.

The aryl or substituted aryl group is preferred rather than the aromatic heterocyclic group and the substituted aromatic heterocyclic group. The hetero ring in the aromatic heterocyclic group is generally unsaturated. The aromatic hetero ring is preferably a 5-, 6- or 7-membered ring, more preferably a 5- or 6-membered ring. The aromatic hetero ring generally has a largest number of double bonds. The heteroatom is preferably a nitrogen atom, an oxygen atom or a sulfur atom, more preferably a nitrogen atom or a sulfur atom.

The aromatic ring of the aromatic group is preferably a benzene ring, a furan ring, a thiophene ring, a pyrrole ring, an oxazole ring, a thiazole ring, an imidazole ring, a triazole ring, a pyridine ring, a pyrimidine ring or a pyrazine ring, more preferably a benzene ring.

Examples of the substituent for the substituted aryl group and the substituted aromatic heterocyclic group include a halogen atom (e.g., F, Cl, Br, I), hydroxyl, carboxyl, cyano, amino, an alkylamino group (e.g., methylamino, ethylamino, butylamino, dimethylamino), nitro, sulfo, carbamoyl, an alkylcarbamoyl group (e.g., N-methylcarbamoyl, N-ethylcarbamoyl, N,N-dimethylcarbamoyl), a sulfamoyl group, an alkylsulfamoyl group (e.g., N-methylsulfamoyl, N-ethylsulfamoyl, N,N-dimethylsulfamoyl), a ureido group, an alkylureido group (e.g., N-methylureido, N,N-dimethylureido, N,N,N′-trimethylureido), an alkyl group (e.g., methyl, ethyl, propyl, butyl, pentyl, heptyl, octyl, isopropyl, s-butyl, tert-amyl, cyclohexyl, cyclopentyl), an alkenyl group (e.g., vinyl, allyl, hexenyl), an alkynyl group (e.g., ethynyl, butynyl), an acyl group (e.g., formyl, acetyl, butyryl, hexanoyl, lauryl), an acyloxy group (e.g., acetoxy, butyryloxy, hexanoyloxy, lauryloxy), an alkoxy group (e.g., methoxy, ethoxy, propoxy, butoxy, pentyloxy, heptyloxy, octyloxy), an aryloxy group (e.g., phenoxy), an alkoxycarbonyl group (e.g., methoxycarbonyl, ethoxycarbonyl, propoxycarbonyl, butoxycarbonyl, pentyloxycarbonyl, heptyloxycarbonyl), an aryloxycarbonyl group (e.g., phenoxycarbonyl), an alkoxycarbonylamino group (e.g., butoxycarbonylamino, hexyloxycarbonylamino), an alkylthio group (e.g., methylthio, ethylthio, propylthio, butylthio, pentylthio, heptylthio, octylthio), an arylthio group (e.g., phenylthio), an alkylsulfonyl group (e.g., methylsulfonyl, ethylsulfonyl, propylsulfonyl, butylsulfonyl, pentylsulfonyl, heptylsulfonyl, octylsulfonyl), an amido group (e.g., acetamido, butylamido, hexylamido, laurylamido), and a non-aromatic heterocyclic group (e.g., morpholyl, pyrazinyl).

Among these substituents, preferred are a halogen atom, a cyano group, a carboxyl group, a hydroxyl group, an amino group, an alkylamino group, an acyl group, an acyloxy group, an amido group, an alkoxycarbonyl group, an alkoxy group, an alkylthio group and an alkyl group.

The alkyl moiety in the alkylamino group, alkoxycarbonyl group, alkoxy group and alkylthio group, and the alkyl group each may further have a substituent. Examples of the substituent for the alkyl moiety and the alkyl group include a halogen atom, a hydroxyl group, a carboxyl group, a cyano group, an amino group, an alkylamino group, a nitro group, a sulfo group, a carbamoyl group, an alkylcarbamoyl group, a sulfamoyl group, an alkylsulfamoyl group, a ureido group, an alkylureido group, an alkenyl group, an alkynyl group, an acyl group, an acyloxy group, an alkoxy group, an aryloxy group, an alkoxycarbonyl group, an aryloxycarbonyl group, an alkoxycarbonylamino group, an alkylthio group, an arylthio group, an alkylsulfonyl group, an amido group and a non-aromatic heterocyclic group. Among these substituents for the alkyl moiety and the alkyl group, preferred are a halogen atom, a hydroxyl group, an amino group, an alkylamino group, an acyl group, an acyloxy group, an acylamino group, an alkoxycarbonyl group and an alkoxy group.

In formula (I), L¹ represents a divalent linking group selected from an alkylene group, an alkenylene group, an alkynylene group, an arylene group, —O—, —CO— and a combination thereof.

The alkylene group may have a cyclic structure. The cyclic alkylene group is preferably a cyclohexylene group, more preferably a 1,4-cyclohexylene group. The chain alkylene group is preferably a linear alkylene group rather than an alkylene group having a branch.

The number of carbon atoms in the alkylene group is preferably from 1 to 20, more preferably from 1 to 15, still more preferably from 1 to 10, yet still more preferably from 1 to 8, and most preferably from 1 to 6.

The alkenylene group and alkynylene group each preferably has a chain structure rather than a cyclic structure, more preferably a linear structure rather than a chain structure having a branch.

The number of carbon atoms in the alkenylene group and alkynylene group is preferably from 2 to 10, more preferably from 2 to 8, still more preferably from 2 to 6, yet still more preferably from 2 to 4, and is most preferably a 2-(vinylene or ethynylene) group.

The number of carbon atoms in the arylene group is preferably from 6 to 20, more preferably from 6 to 16, still more preferably from 6 to 12.

In the molecular structure of formula (I), the angle formed by Ar¹ and Ar² via L¹ is preferably 140° or more.

The rod-like compound is more preferably a compound represented by the following formula (2):

Ar¹-L²-X-L³-Ar² Formula (2)

In formula (2), Ar¹ and Ar² each independently represents an aromatic group. The definition and examples of the aromatic group are the same as those for Ar¹ and Ar² in formula (I).

In formula (2), L² and L³ each independently represents a divalent linking group selected from an alkylene group, —O—, —CO— and a combination thereof.

The alkylene group preferably has a chain structure rather than a cyclic structure, more preferably a linear structure rather than a chain structure having a branch.

The number of carbon atoms in the alkylene group is preferably from 1 to 10, more preferably from 1 to 8, still more preferably from 1 to 6, yet still more preferably from 1 to 4, and is most preferably a 1- or 2-(methylene or ethylene) group.

L² and L³ each is preferably —O—CO— or —CO—O—.

In formula (2), X represents a 1,4-cyclohexylene group, a vinylene group or an ethynylene group.

Specific examples of the compounds represented by formulae (1) and (2) are set forth below.

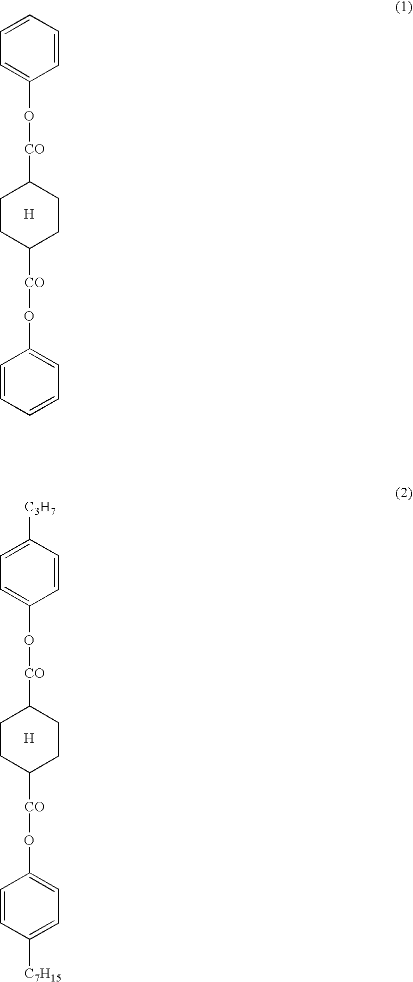

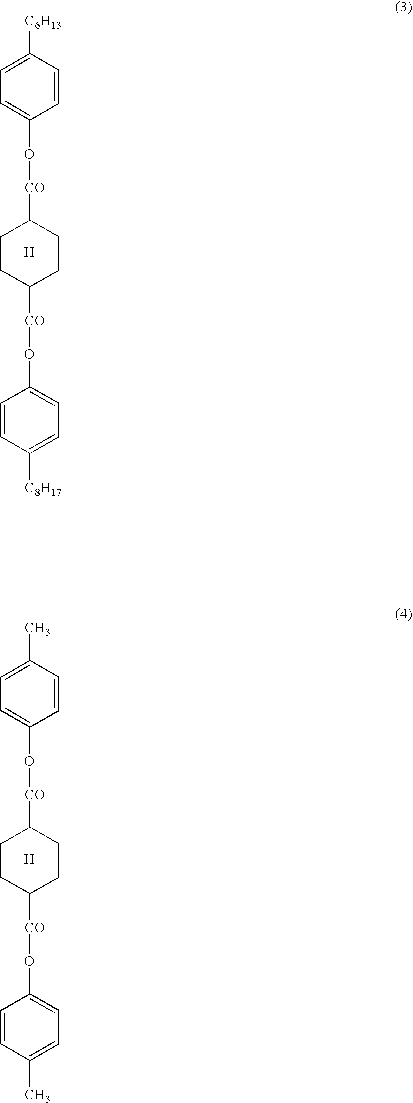

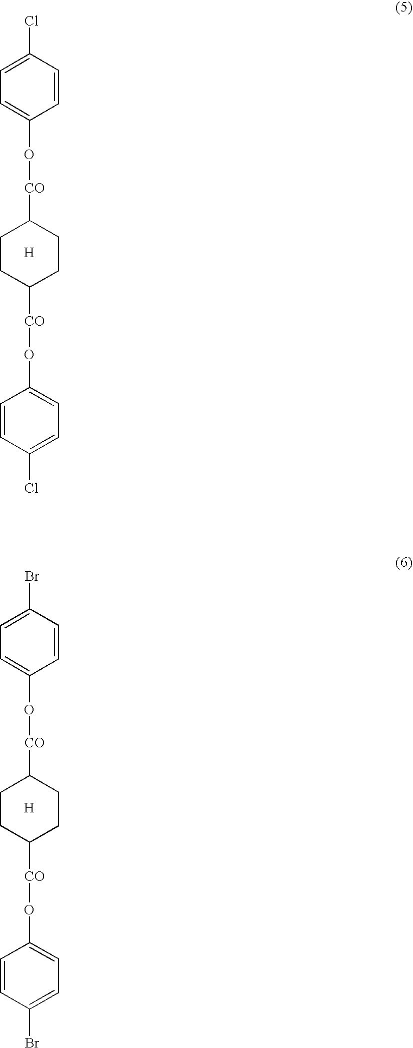

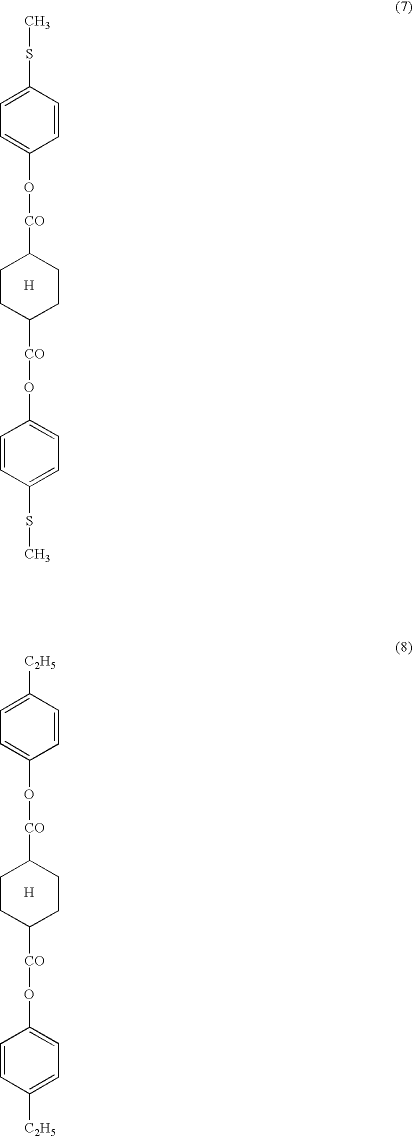

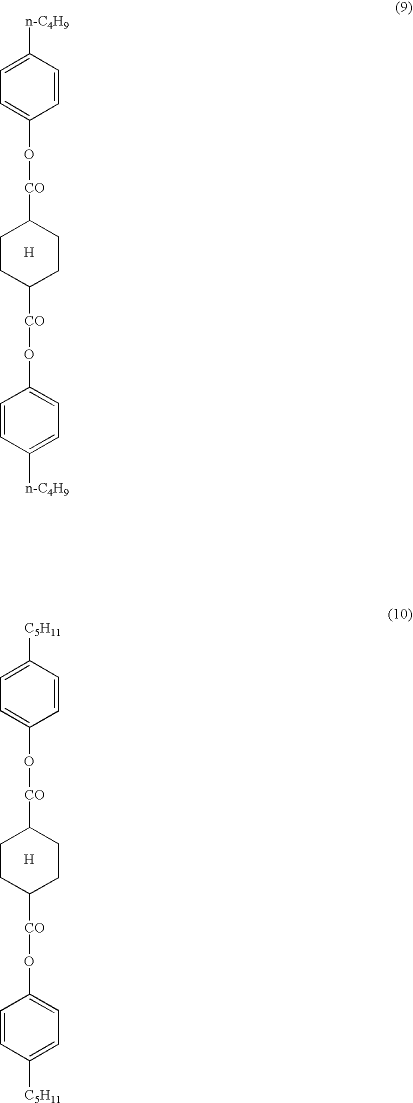

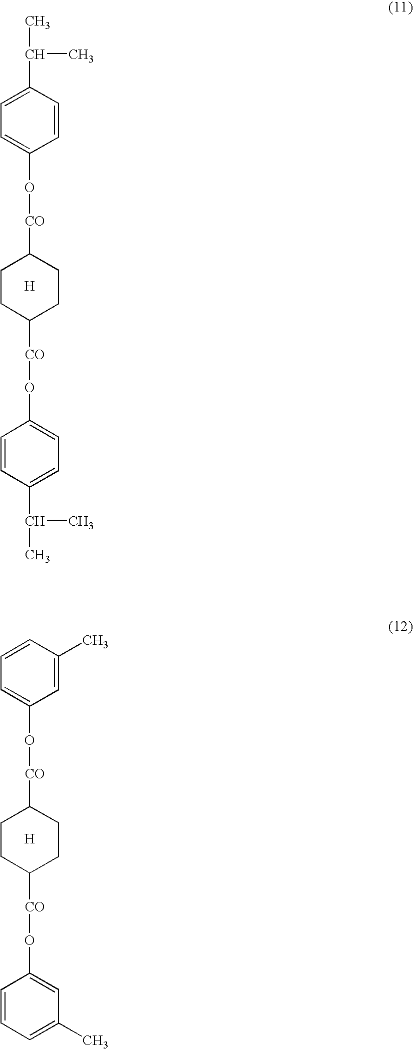

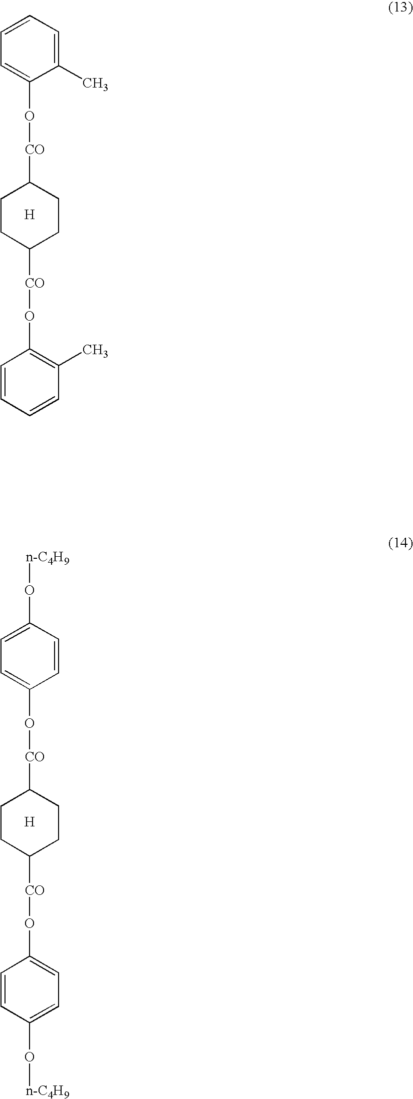

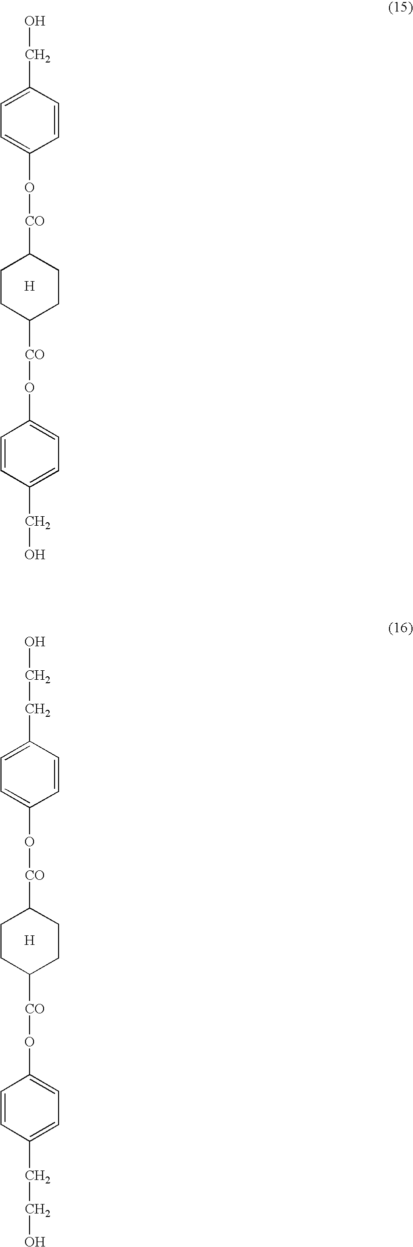

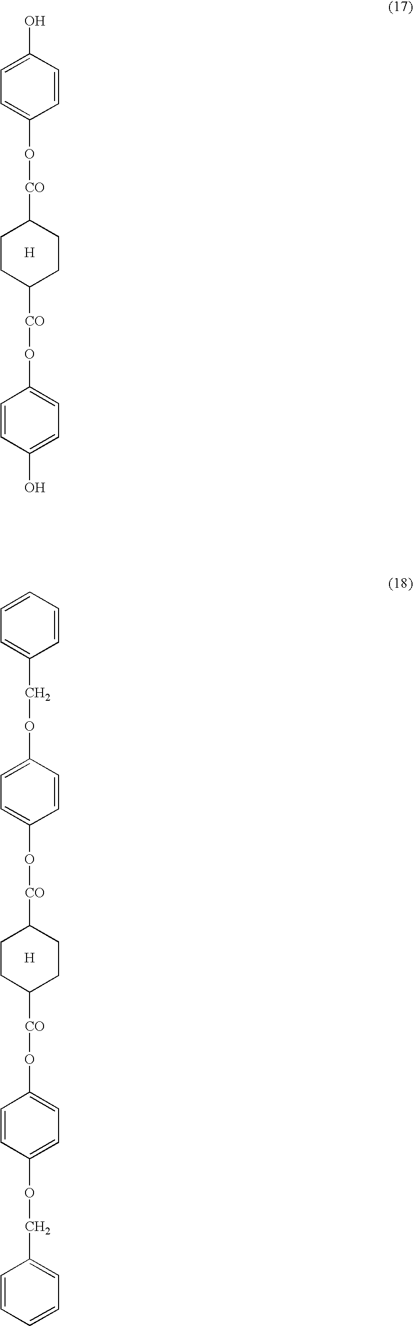

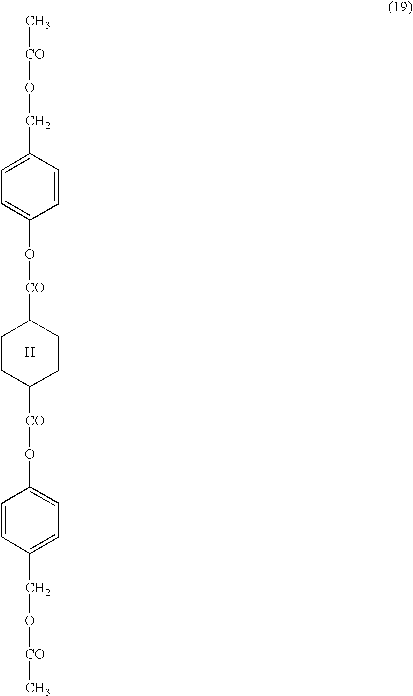

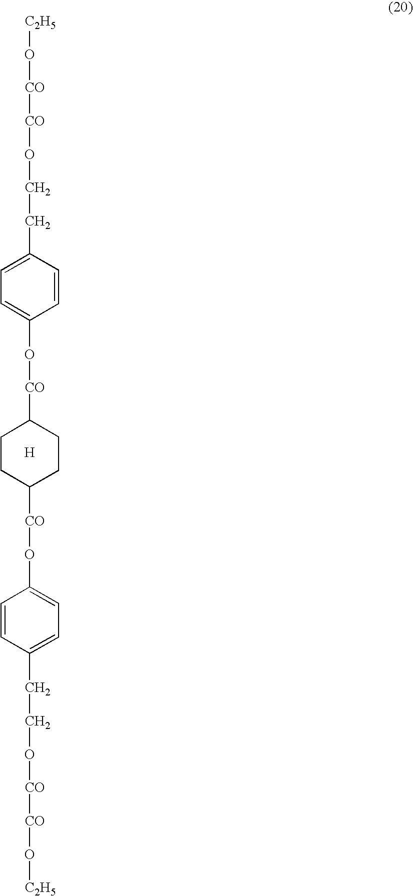

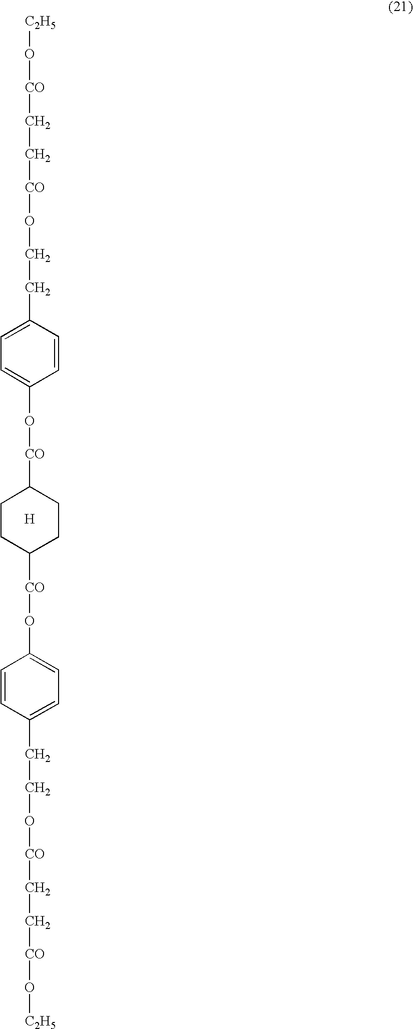

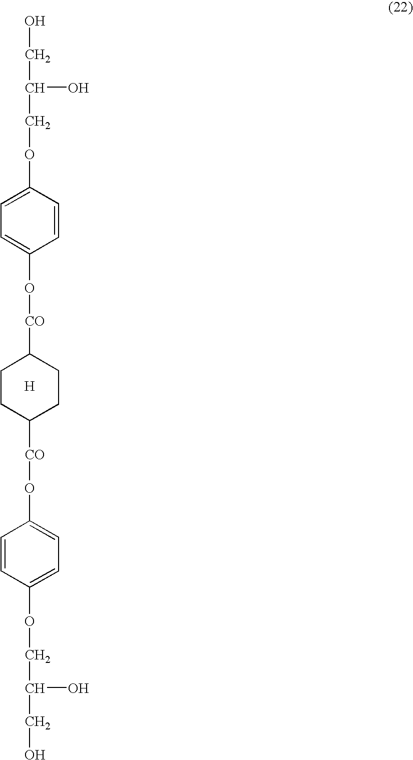

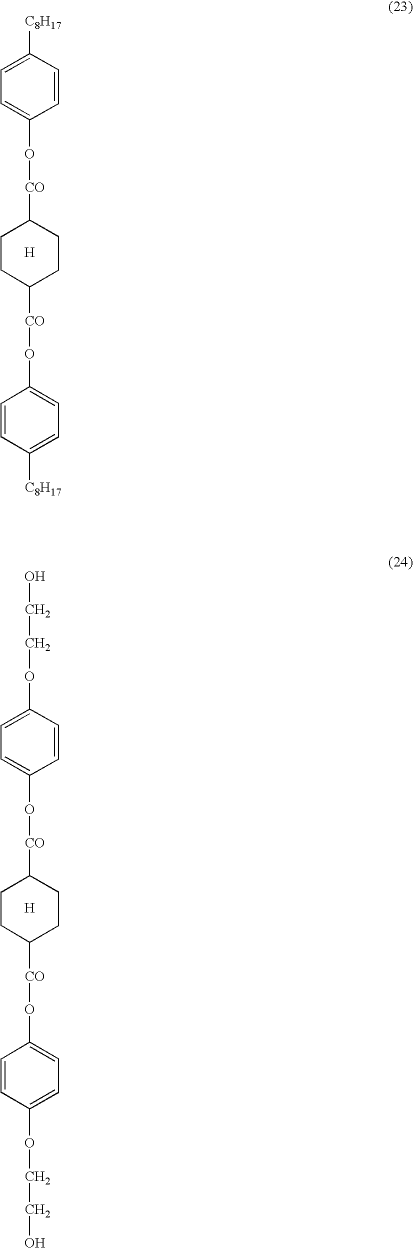

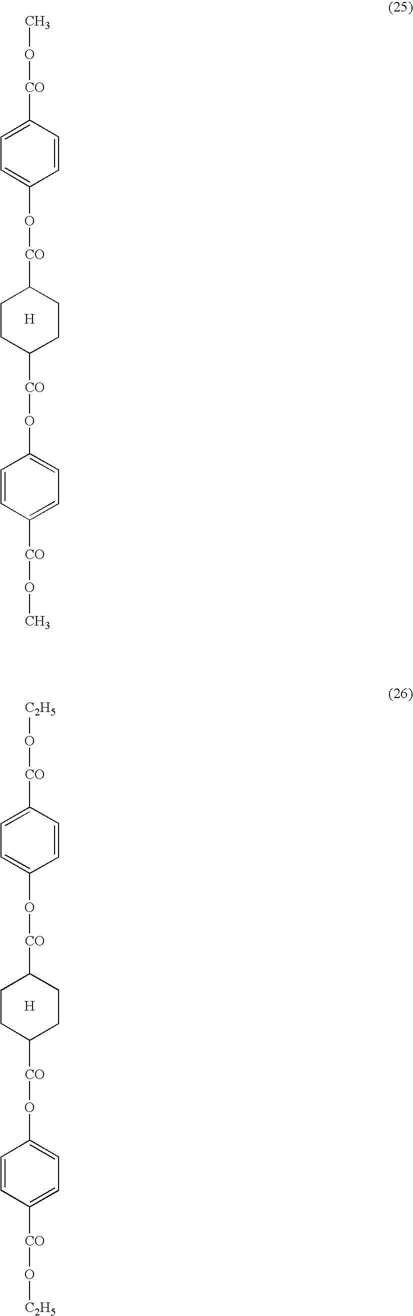

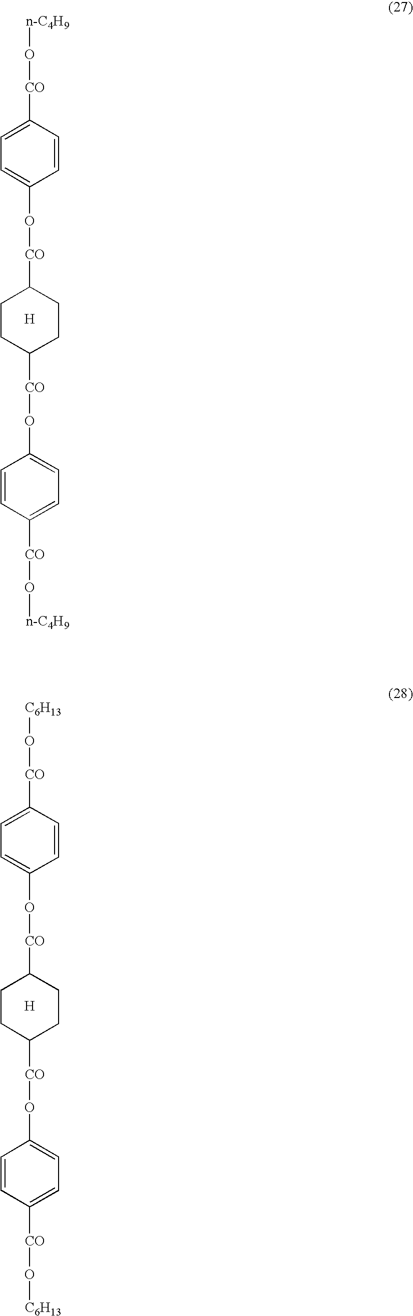

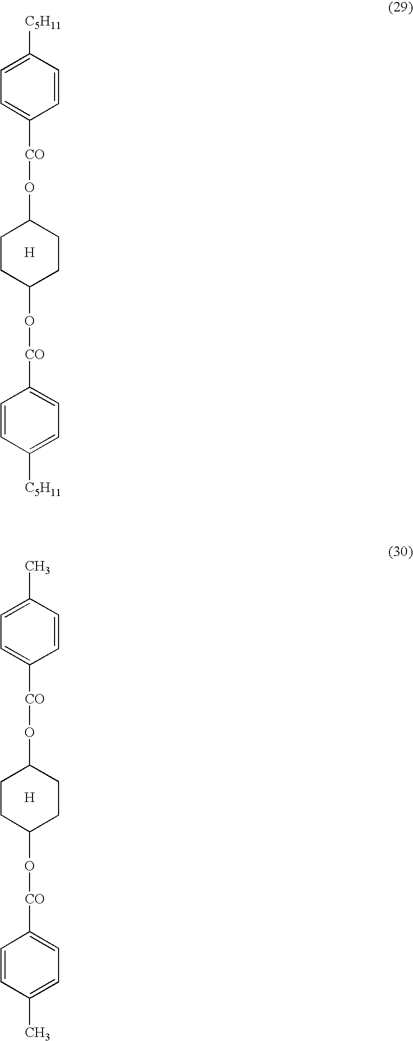

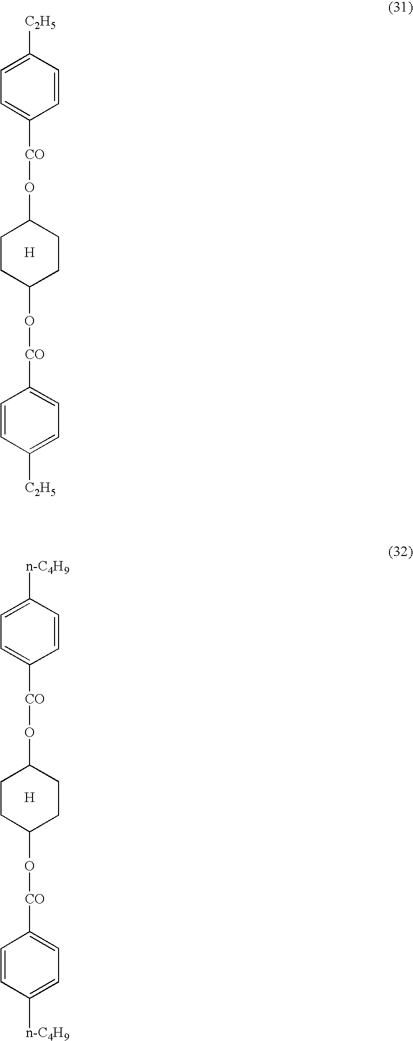

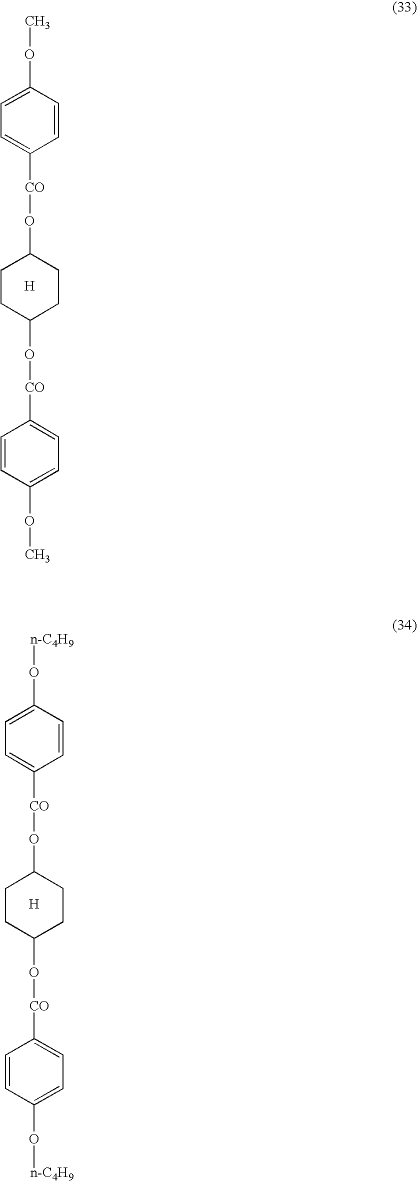

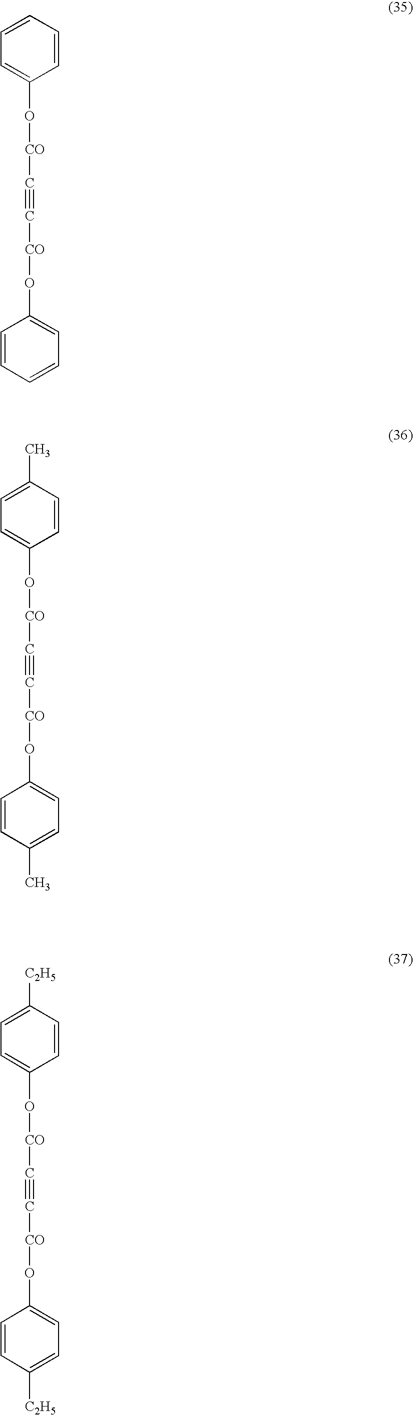

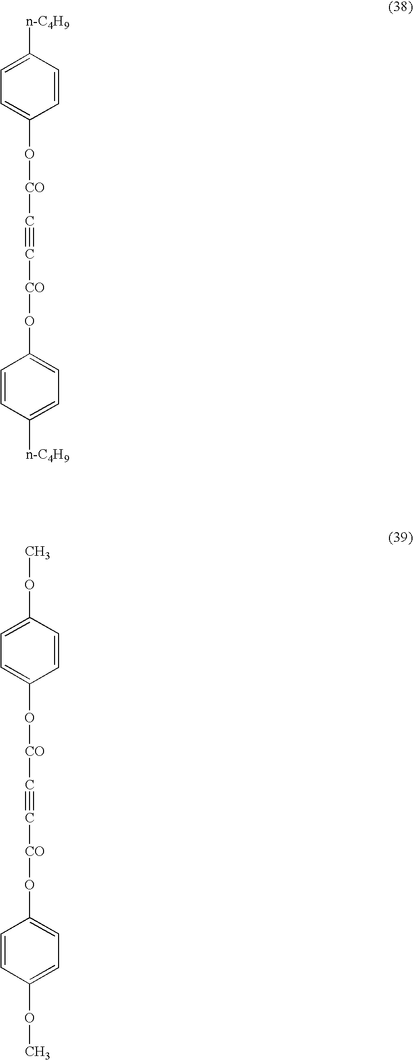

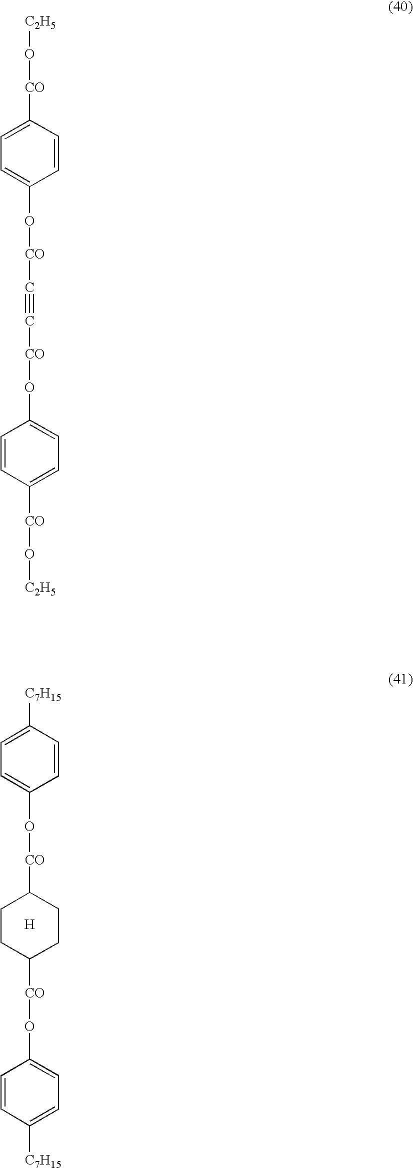

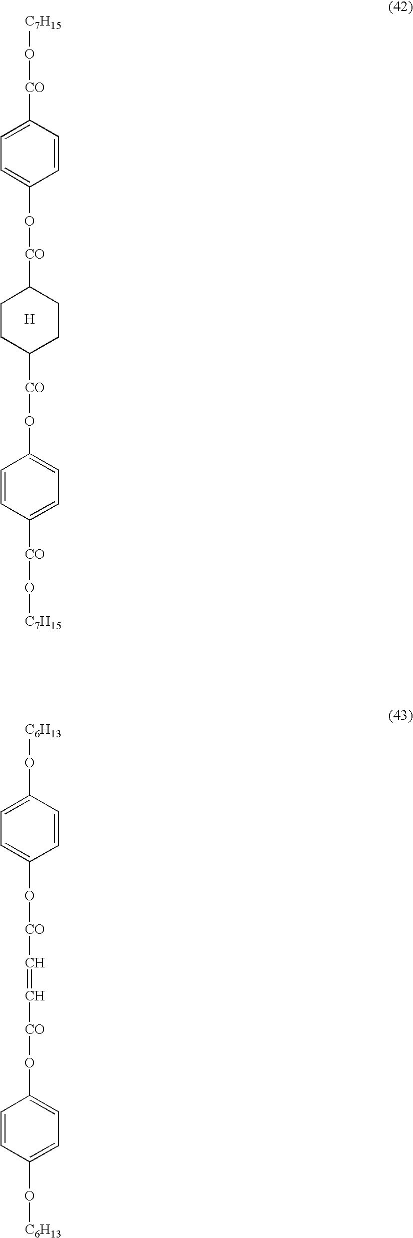

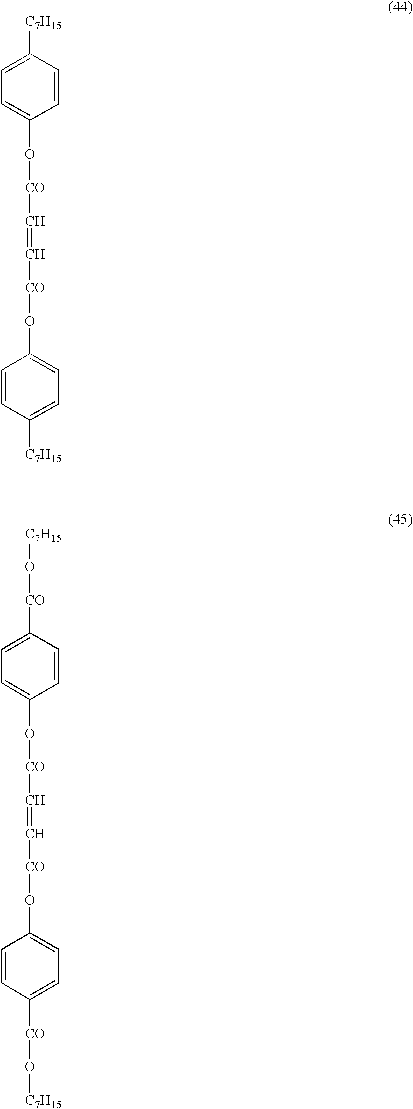

Compounds (1) to (34), (41) and (42) each has two asymmetric carbon atoms at the 1- and 4-positions of the cyclohexane ring. However, since Compounds (1), (4) to (34), (41) and (42) have a symmetrical meso-type molecular structure, these compounds have no optical isomer (optical activity), but only geometric isomers (trans-form and cis-form) are present. The trans-form (1-trans) and cis-form (1-cis) of Compound (1) are shown below.

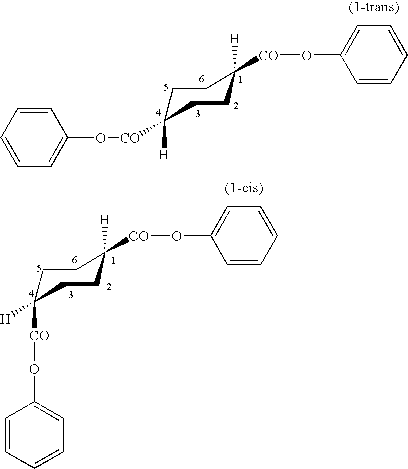

As described above, the rod-like compound preferably has a linear molecular structure and therefore, a trans-form is preferred rather than a cis-form.

Compounds (2) and (3) each has optical isomers (four isomers in total) in addition to geometric isomers. As for the geometric isomers, a trans-form is similarly preferred rather than a cis-form. The optical isomers have no specific difference in the superiority and may be a D-form, an L-form or a racemic form.

In Compounds (43) to (45), the vinylene bond at the center includes a trans-from and a cis-form. From the same reason as above, a trans-form is preferred rather than a cis-form.

A compound represented by the following formula (3) is also preferred.

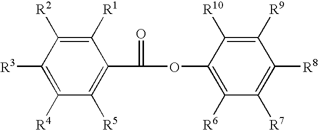

(wherein R¹, R², R³, R⁴, R⁵, R⁶, R⁷, R⁹ and R¹⁰ each independently represents a hydrogen atom or a substituent, and at least one of R¹, R², R³, R⁴ and R⁵ represents an electron-donating group; and R⁸ represents a hydrogen atom, an alkyl group having a carbon number of 1 to 4, an alkenyl group having a carbon number of 2 to 6, an alkynyl group having a carbon number of 2 to 6, an aryl group having a carbon number of 6 to 12, an alkoxy group having a carbon number of 1 to 12, an aryloxy group having a carbon number of 6 to 12, an alkoxycarbonyl group having a carbon number of 2 to 12, an acylamino group having a carbon number of 2 to 12, a cyano group or a halogen atom).

Preferable examples of the compounds represented by formulae (3) are set forth below.

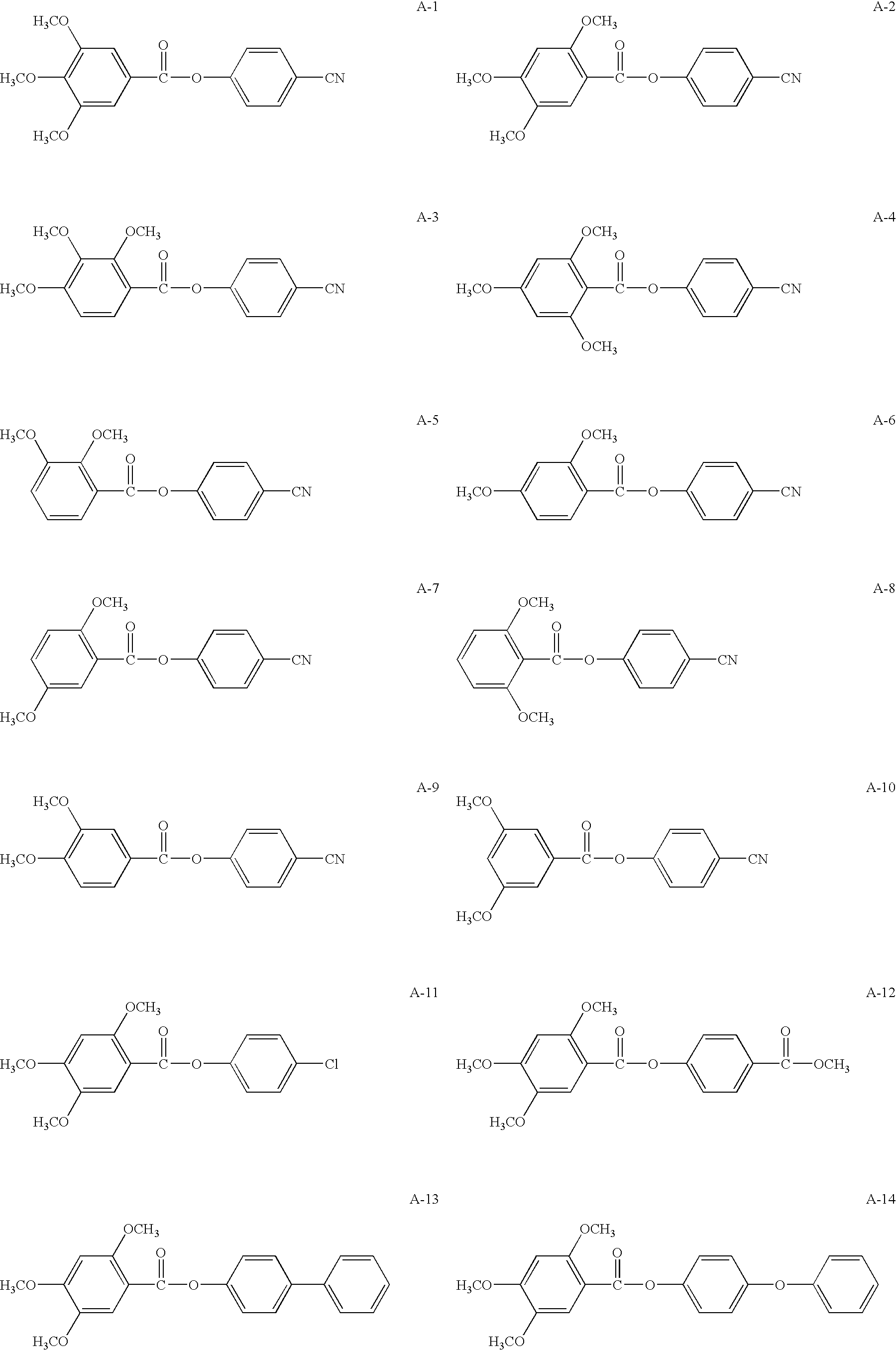

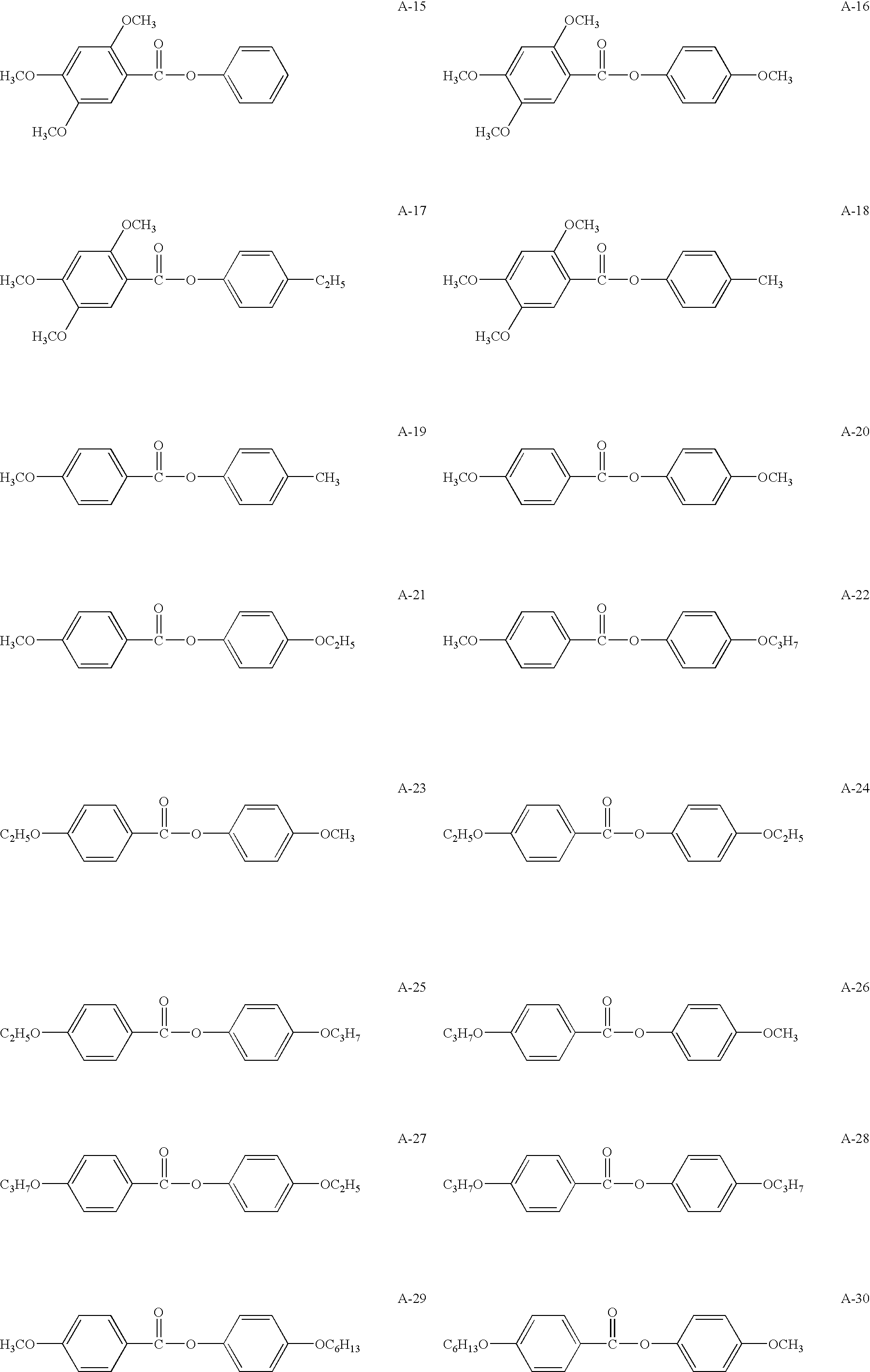

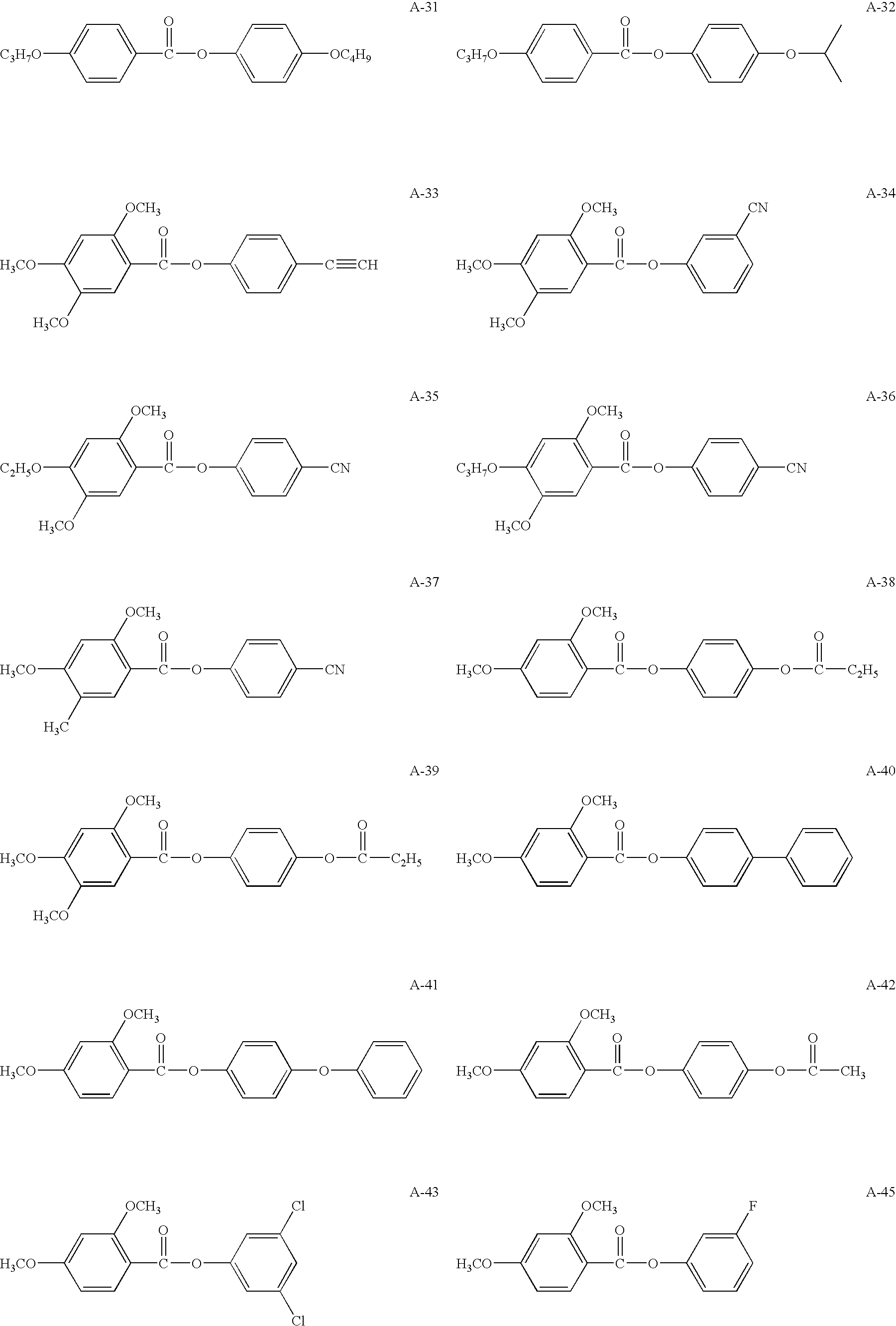

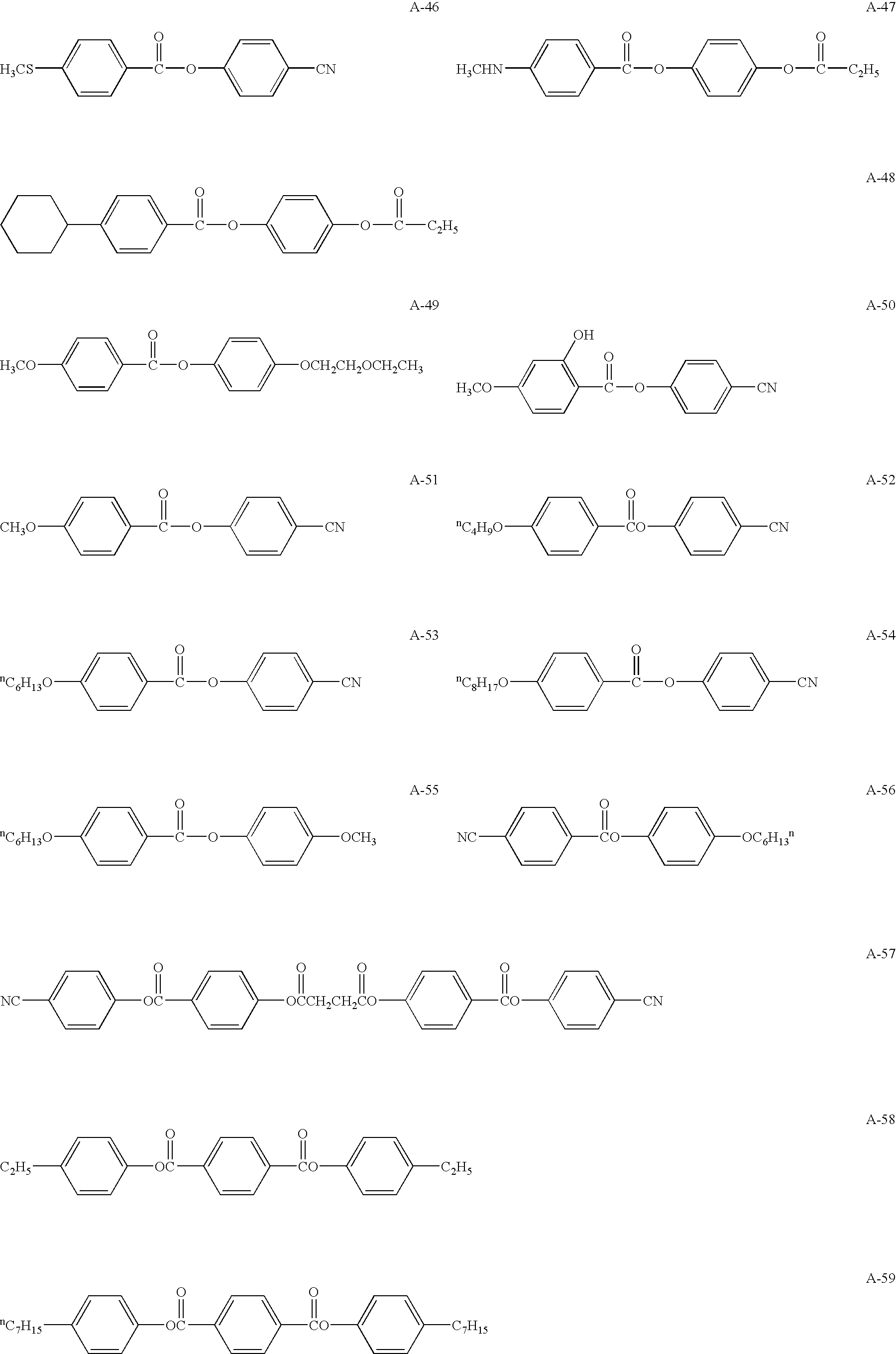

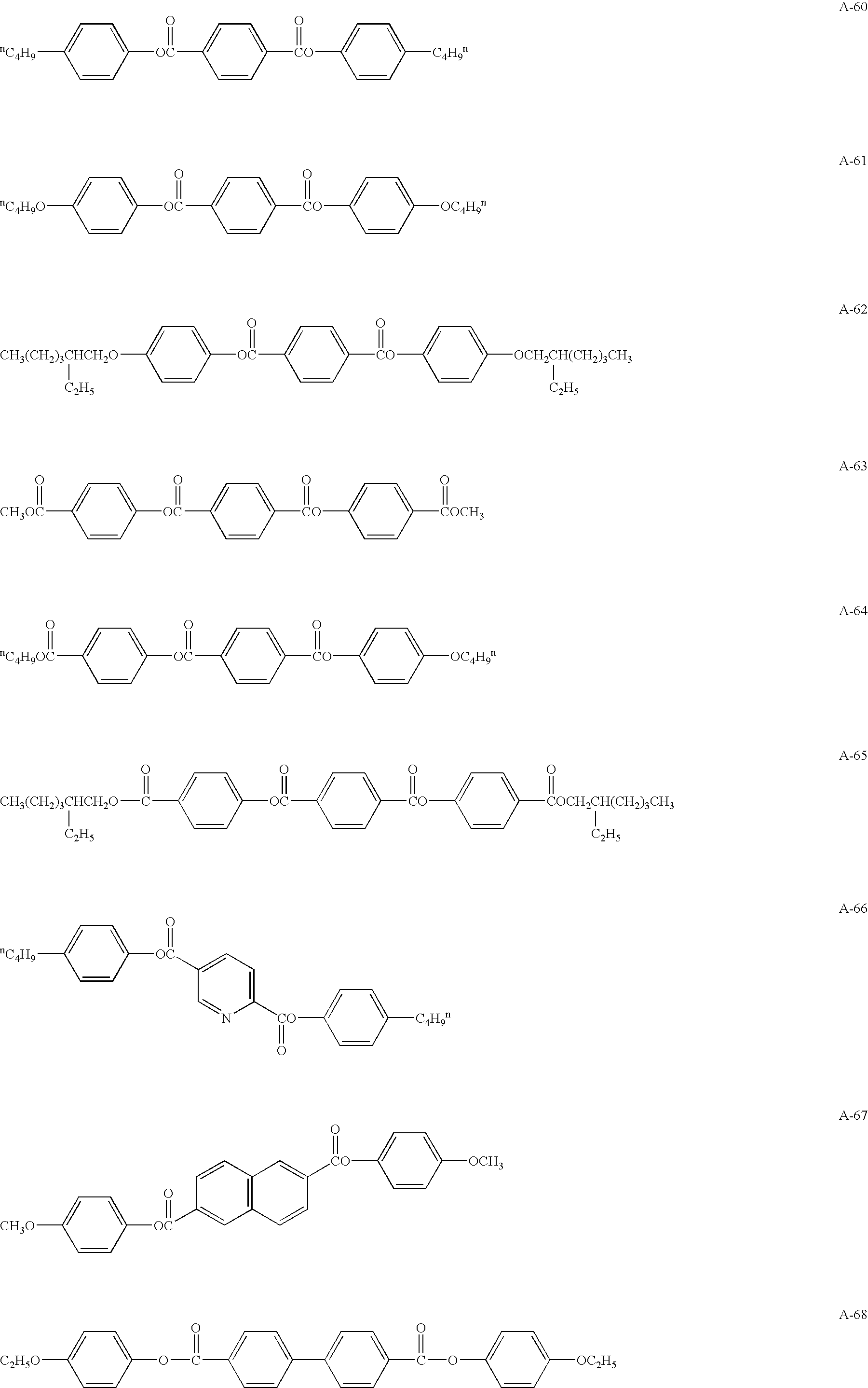

In the present invention, two or more kinds of rod-like compounds may be used in combination.

The rod-like compound can be synthesized by referring to the method described in publications, and the publication includes Mol. Cryst. Liq. Cryst., Vol 53, page 229 (1979), ibid., Vol. 89, page 93 (1982), ibid., Vol. 145, page 111 (1987), ibid., Vol. 170, page 43 (1989), J. Am. Chem. Soc., Vol. 113, page 1349 (1991), ibid., Vol. 118, page 5346 (1996), ibid., Vol. 92, page 1582 (1970), J. Org. Chem., Vol. 40, page 420 (1975), and Tetrahedron, Vol. 48, No. 16, page 3437 (1992).

The discotic compound which can be preferably used as the retardation developer in the present invention is a compound represented by the following formula (I):

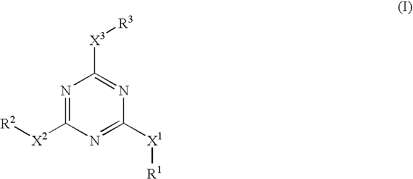

wherein X¹ is a single bond, —NR⁴—, —O— or S—; X² is a single bond, —NR⁵—, —O— or S—; X³ is a single bond, —NR⁶—, —O— or S—; R¹, R² and R³ each is independently an alkyl group, an alkenyl group, an aromatic ring group or a heterocyclic group; and R⁴, R⁵ and R⁶ each is independently a hydrogen atom, an alkyl group, an alkenyl group, an aryl group or a heterocyclic group.

Preferred examples (I-(1) to IV-(10)) of the compound represented by formula (I) are set forth below, but the present invention is not limited to these specific examples.

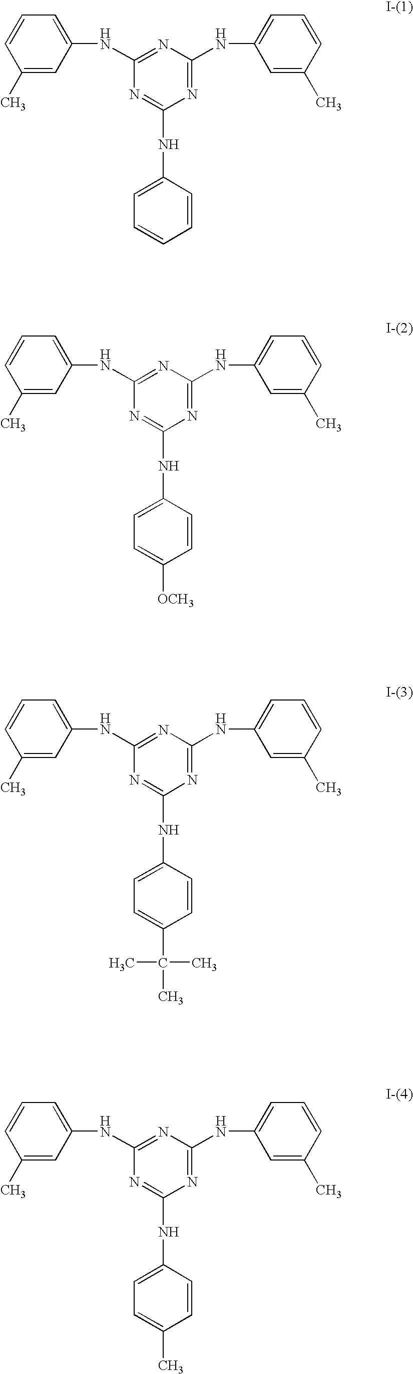

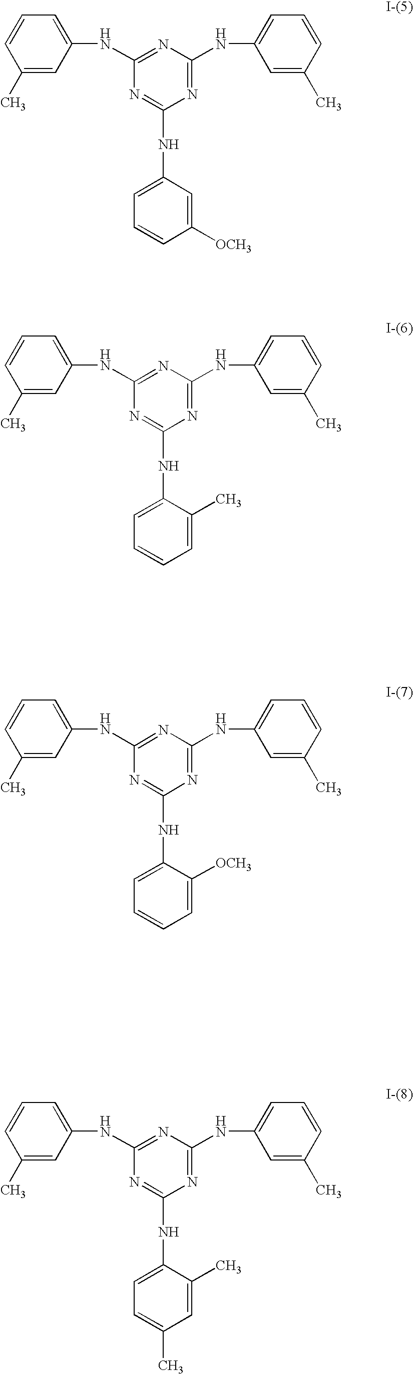

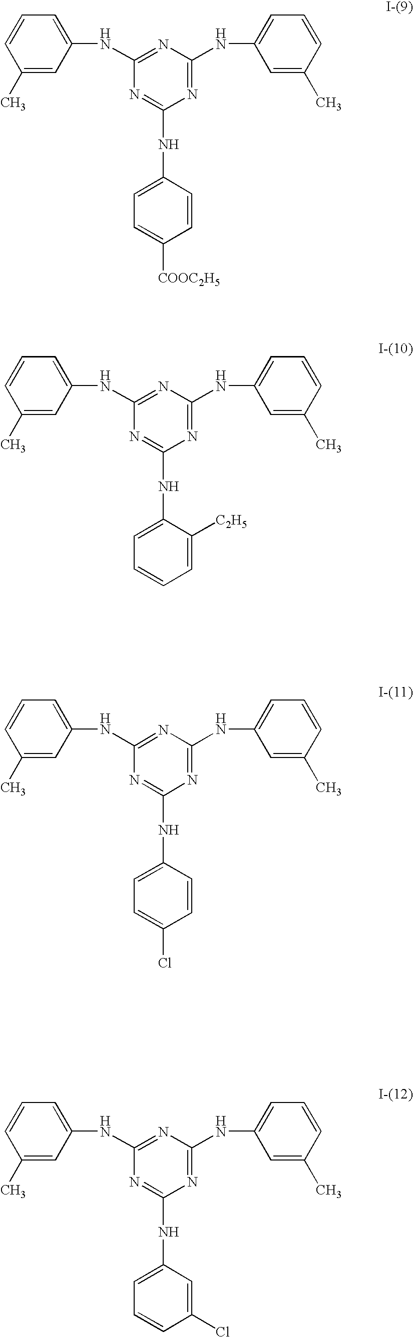

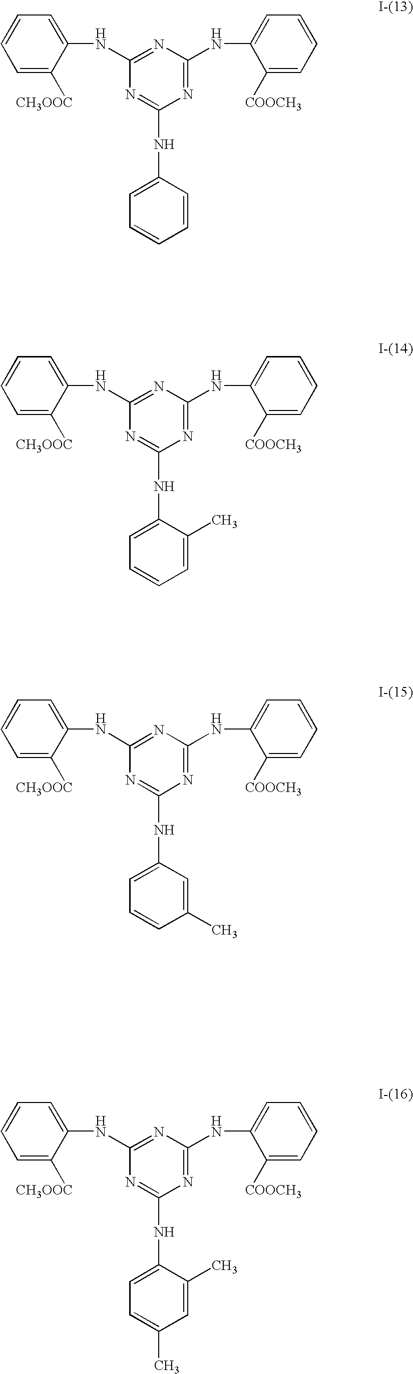

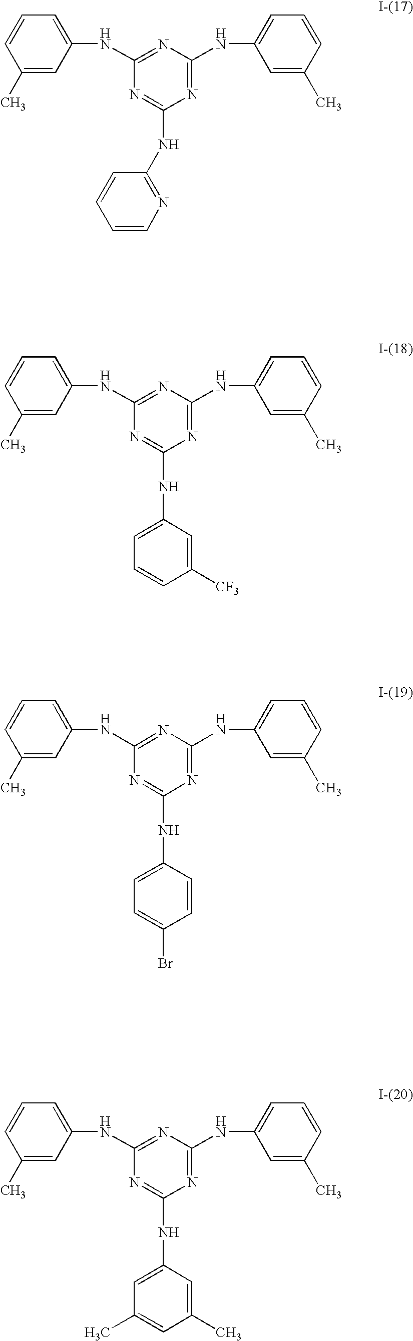

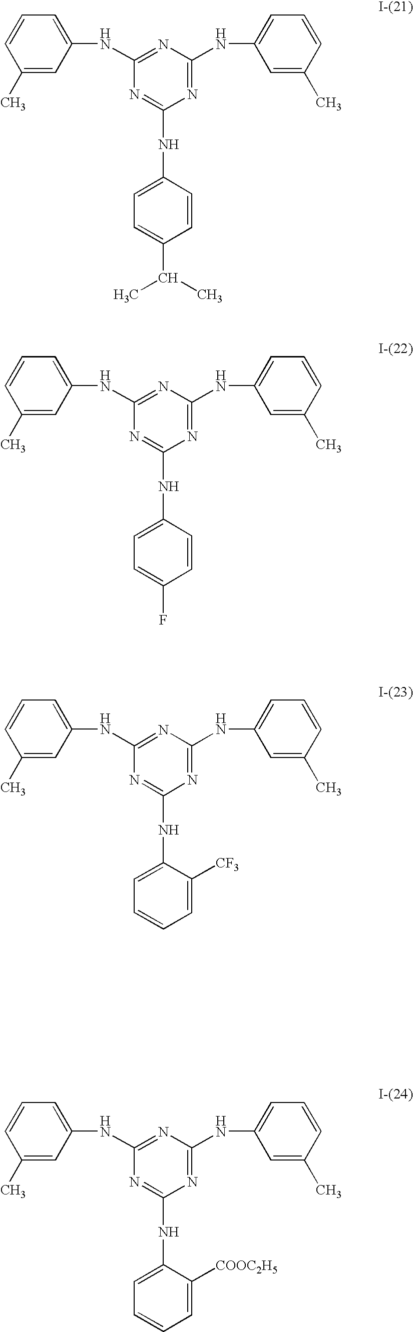

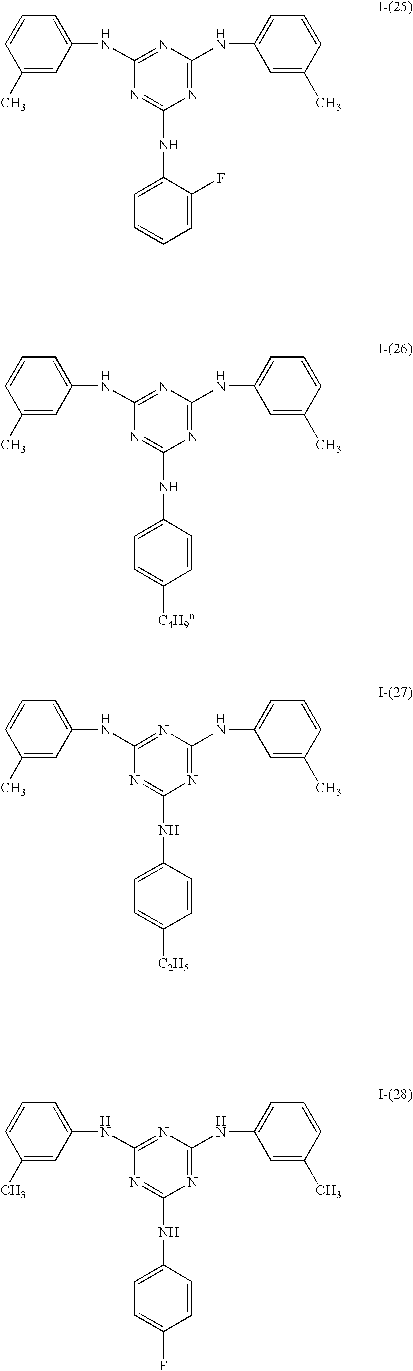

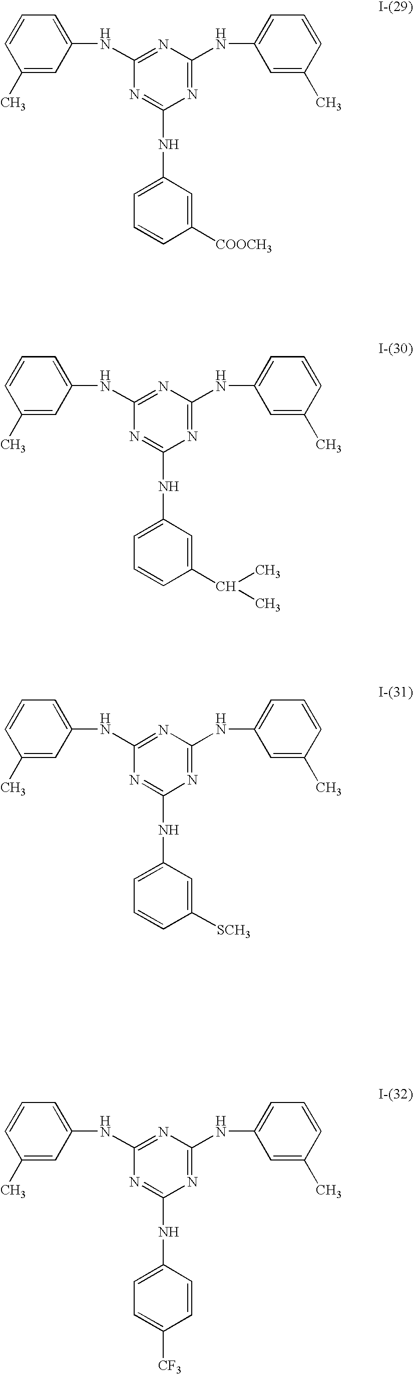

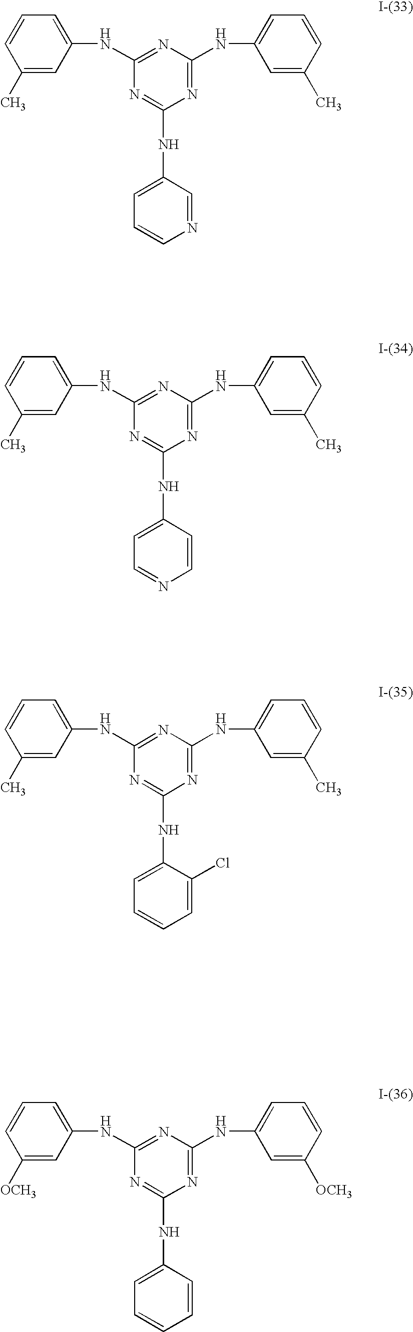

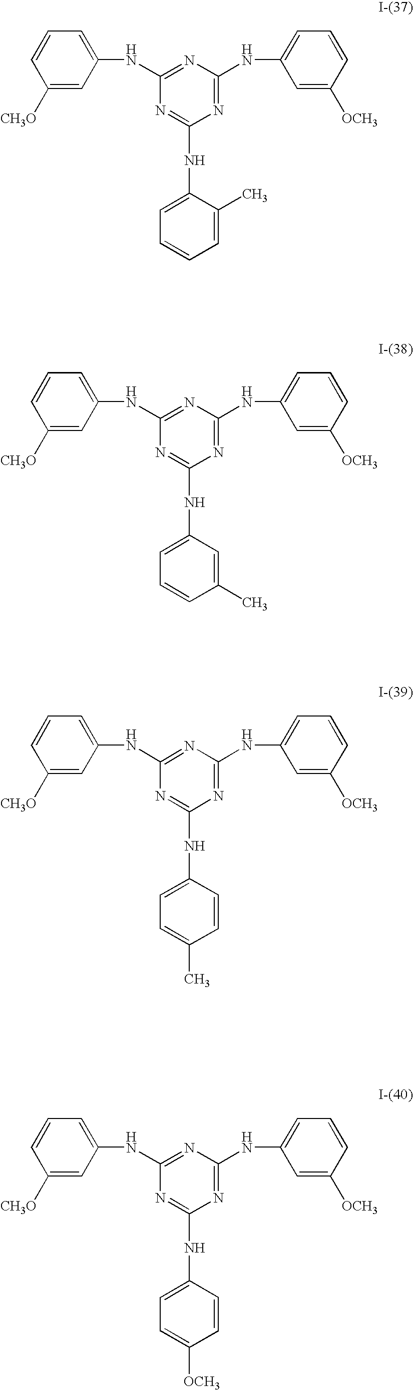

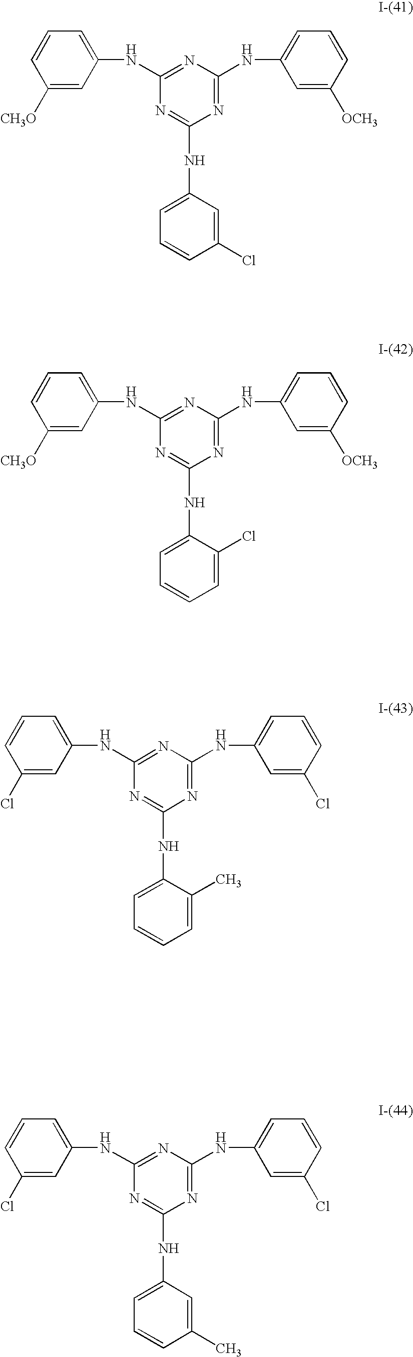

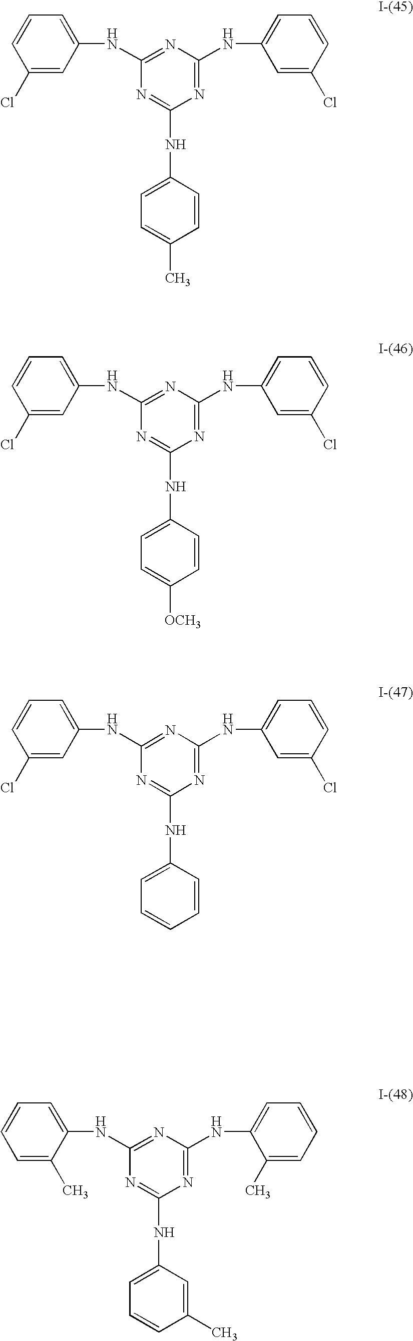

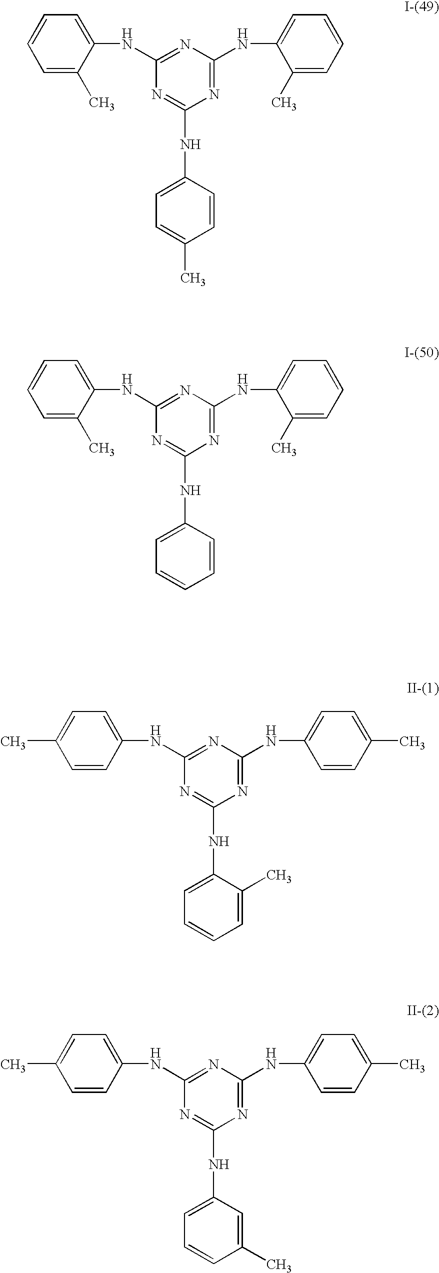

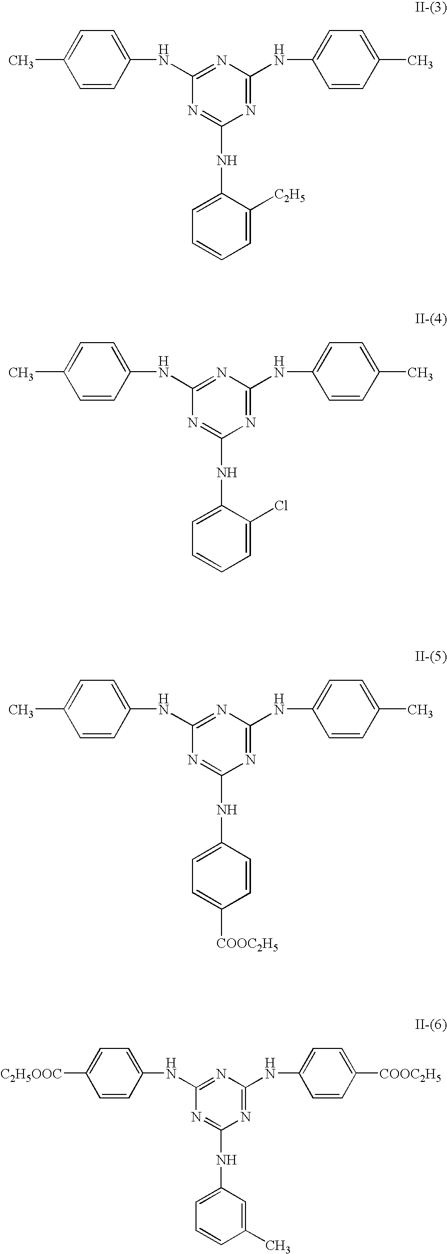

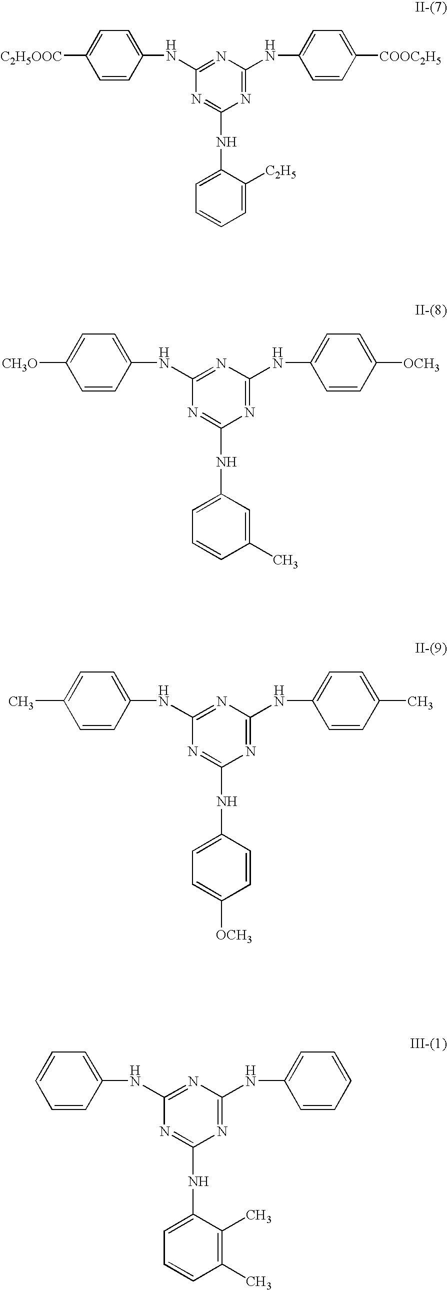

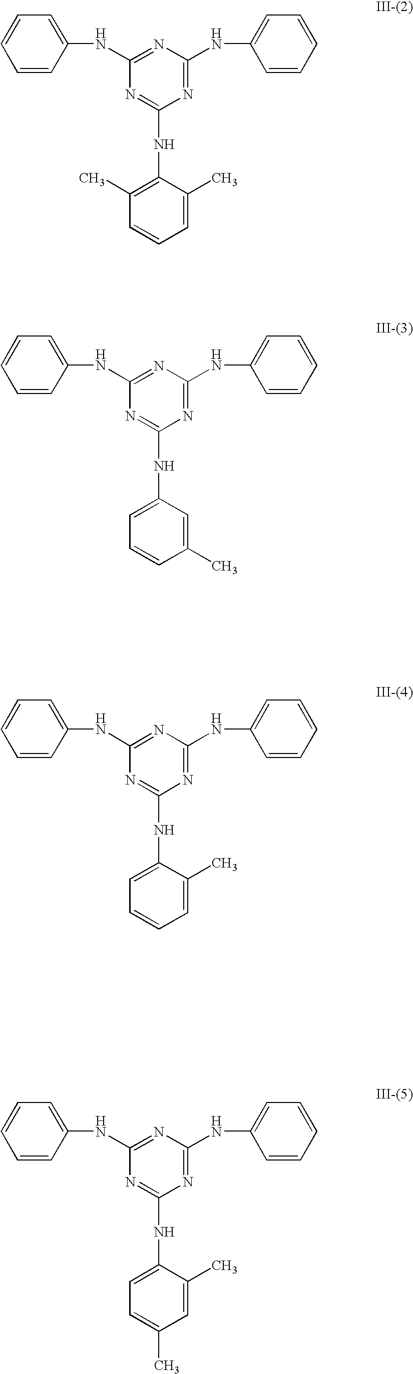

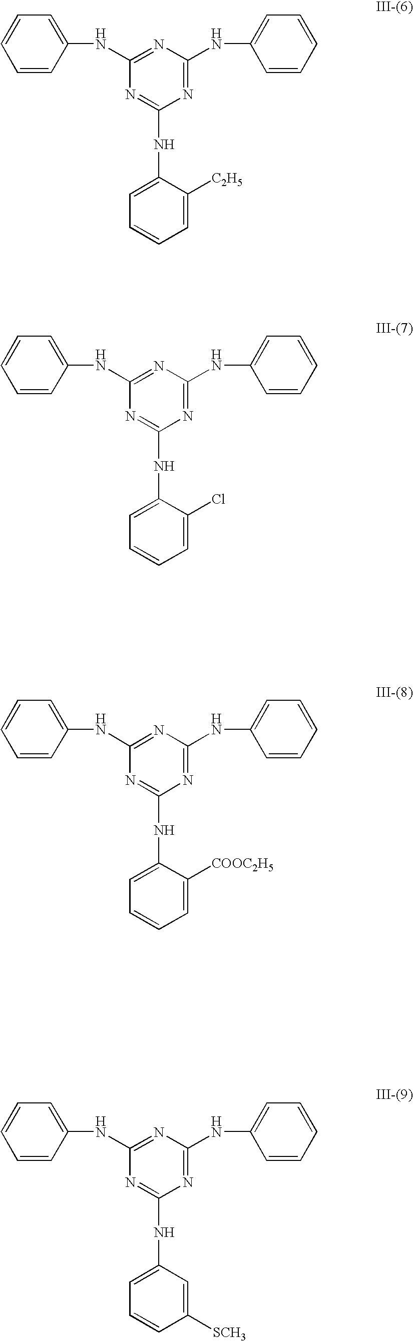

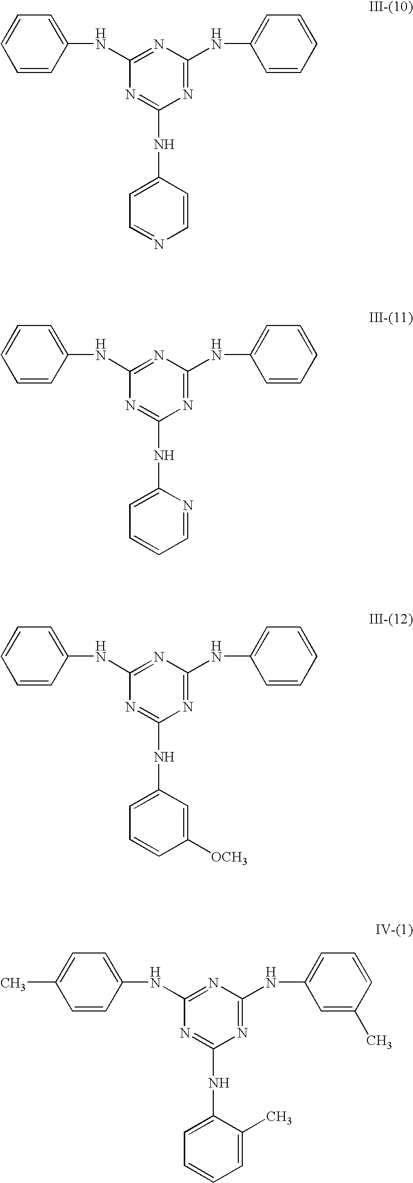

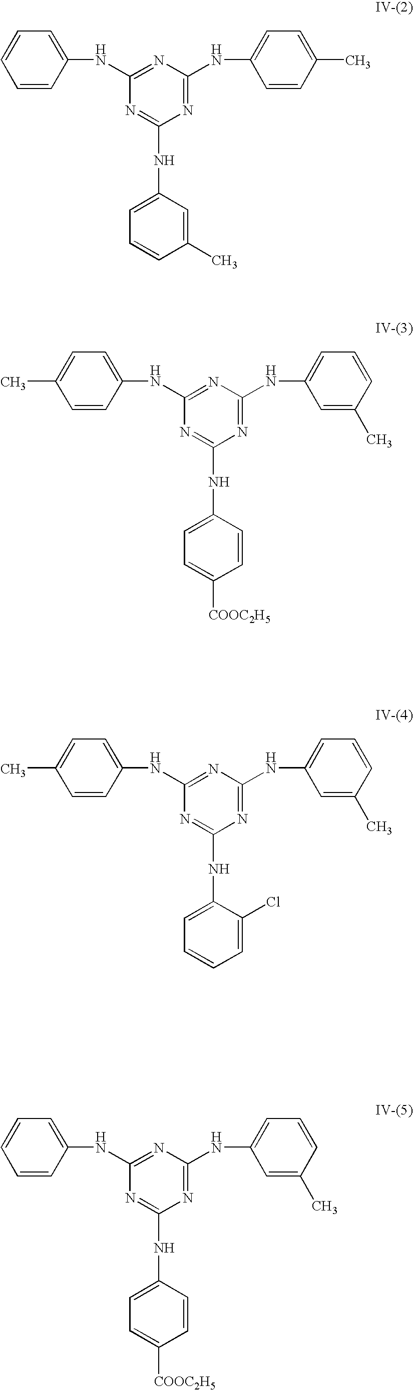

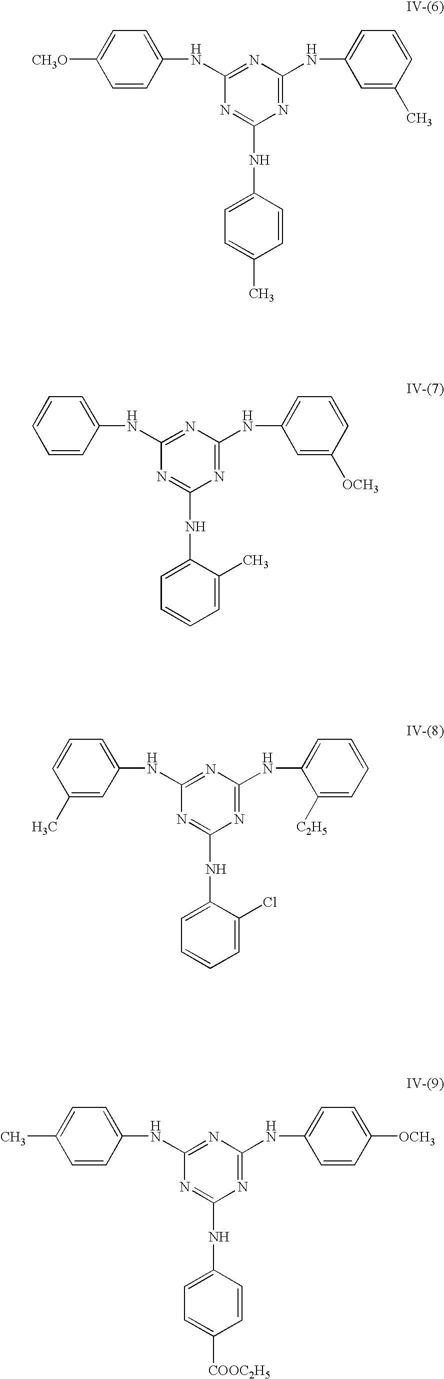

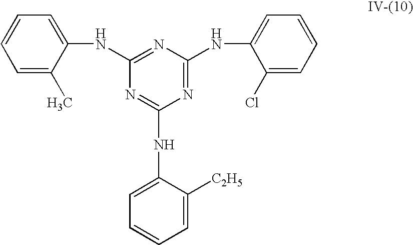

### [Synthesis Method of Cellulose Acylate]

The basic principle of the synthesis method of cellulose acylate is described in Migita, et al., Mokuzai Kagaku (Wood Chemistry), pp. 180-190, Kyoritsu Shuppan (1968). A representative synthesis method is a liquid phase acetylation method using a carboxylic anhydride-an acetic acid-a sulfuric acid catalyst. More specifically, a cellulose raw material such as cotton linter and wood pulp is pretreated with an appropriate amount of acetic acid and then charged into a previously cooled carboxylating mixed solution to esterify the cellulose, thereby synthesizing a complete cellulose acylate (the total of acyl substitution degrees at the 2-position, 3-position and 6-position is almost 3.00). The carboxylating mixed solution generally contains an acetic acid as a solvent, a carboxylic anhydride as an esterifying agent, and a sulfuric acid as a catalyst. The carboxylic anhydride is usually used stoichiometrically in excess of the total of the cellulose with which the carboxylic acid reacts, and the moisture present in the system. After the completion of acylation reaction, an aqueous solution of neutralizer (for example, carbonate, acetate or oxide of calcium, magnesium, iron, aluminum or zinc) is added for hydrolyzing the excess carboxylic anhydride remaining in the system and partially neutralizing the esterification catalyst. The obtained complete cellulose acylate is kept at 50 to 90° C. in the presence of a slight amount of an acetylation reaction catalyst (generally, the remaining sulfuric acid), whereby the cellulose acylate is saponified and ripened and is changed to a cellulose acylate having desired acyl substitution degree and polymerization degree. At the time when the desired cellulose acylate is obtained, the cellulose acylate solution is charged into water or dilute sulfuric acid (alternatively, water or dilute sulfuric acid is charged into the cellulose acylate solution) with or without neutralizing the catalyst remaining in the system by using a neutralizing agent described above, thereby separating the cellulose acylate, and after washing and stabilization treatment, the cellulose acylate is obtained.

In the cellulose acylate film of the present invention, the polymer component constituting the film preferably comprises substantially the preferred cellulose acylate described above. The term “substantially” means 55 mass % or more (preferably 70 mass % or more, more preferably 80 mass % or more) of the polymer component.

As the raw material used in the film production, a cellulose acylate particle is preferred. Also, 90 mass % or more of the particle used preferably has a particle diameter of 0.5 to 5 mm, and 50 mass % or more of the particle used preferably has a particle diameter of 1 to 4 mm. The cellulose acylate particle preferably has a shape close to sphere as much as possible.

The polymerization degree of the cellulose acylate preferably used in the present invention is, in terms of viscosity average polymerization degree, preferably from 200 to 700, more preferably 250 to 550, still more preferably from 250 to 400, yet still more preferably from 250 to 350. The average molecular weight can be measured by the limiting viscosity method of Uda, et al. (Kazuo Uda and Hideo Saito, JOURNAL OF THE SOCIETY OF FIBER SCIENCE AND TECHNOLOGY, JAPAN, Vol. 18, No. 1, pp. 105-120 (1962)). Furthermore, this is described in detail in JP-A-9-95538.

When low molecular components are removed, the average molecular weight (polymerization degree) increases, but the viscosity becomes lower than that of normal cellulose acylate and this is useful. The cellulose acylate reduced in low molecular components can be obtained by removing low molecular components from a cellulose acylate synthesized by a normal method. The low molecular components can be removed by washing the cellulose acylate with an appropriate organic solvent. In the case of producing a cellulose acylate reduced in low molecular components, the amount of the sulfuric acid catalyst in the acetylation reaction is preferably adjusted to be from 0.5 to 25 parts by mass per 100 parts by mass of cellulose. When the amount of the sulfuric acid catalyst is adjusted to this range, a cellulose acylate preferred also in view of the molecular weight distribution (having a uniform molecular weight distribution) can be synthesized.

In use for the production of the cellulose acylate film of the present invention, the water content of the cellulose acylate is preferably 2 mass % or less, more preferably 1 mass % or less. In particular, a cellulose acylate having a water content of 0.7 mass % or less is preferred. The cellulose acylate in general contains water and the water content is known to be from 2.5 to 5 mass %. For obtaining this water content of cellulose acylate in the present invention, the cellulose acylate needs to be dried, and the method therefor is not particularly limited as long as the objective water content can be obtained.

The raw material cotton and synthesis method of the cellulose acylate for use in the present invention are described in detail in JIII Journal of Technical Disclosure, No. 2001-1745, pp. 7-12, Japan Institute of Invention and Innovation (Mar. 15, 2001).

The cellulose acylate film of the present invention can be obtained by dissolving the above-described specific cellulose acylate and, if desired, additives in an organic solvent and forming a film from the resulting solution.

### [Additives]

In the present invention, examples of the additive which can be used in the above-described cellose acylate solution include a plasticizer, an ultraviolet absorbent, a deterioration inhibitor, a retardation (optical anisotropy) developer, a fine particle, a separation accelerator and an infrared absorbent. In the present invention, the retardation developer described above is preferably used. Also, at least one or more members of a plasticizer, an ultraviolet absorbent and a separation accelerator are preferably used.

These additives may be a solid or an oily product, that is, the additive is not particularly limited in its melting point and boiling point. These are described, for example, in JP-A-2001-151901.

As regards the ultraviolet absorbent, an arbitrary kind of ultraviolet absorbent may be selected according to the purpose and, for example, salicylic acid ester-based, benzophenone-based, benzotriazole-based, triazine-based, benzoate-based, cyanoacrylate-based and nickel complex salt-based absorbents may be used. Among these, preferred are benzophenone-based, benzotriazole-based and salicylic acid ester-based absorbents. Examples of the benzophenone-based ultraviolet absorbent include 2,4-dihydroxybenzophenone, 2-hydroxy-4-acetoxybenzophenone, 2-hydroxy-4-methoxybenzophenone, 2,2′-dihydroxy-4-methoxybenzophenone, 2,2′-dihydroxy-4,4′-methoxybenzophenone, 2-hydroxy-4-n-octoxybenzophenone, 2-hydroxy-4-dodecyloxybenzophenone and 2-hydroxy-4-(2-hydroxy-3-methacryloxy)propoxybenzophenone. Examples of the benzotriazole-based ultraviolet absorbent include 2-(2′-hydroxy-3′-tert-butyl-5′-methylphenyl)-5-chlorobenzotriazole, 2-(2′-hydroxy-5′-tert-butylphenyl)benzotriazole, 2-(2′-hydroxy-3′,5′-di-tert-amylphenyl)-benzotriazole, 2-(2′-hydroxy-3′,5′-di-tert-butylphenyl)-5-chlorobenzotriazole and 2-(2′-hydroxy-5′-tert-octylphenyl)benzotriazole. Examples of the salicylic acid ester-based ultraviolet absorbent include phenyl salicylate, p-octylphenyl salicylate and p-tert-butylphenyl salicylate. Among these ultraviolet absorbents, preferred are 2-hydroxy-4-methoxybenzophenone, 2,2′-dihydroxy-4,4′-methoxybenzophenone, 2-(2′-hydroxy-3′-tert-butyl-5′-methylphenyl)-5-chlorobenzotriazole, 2-(2′-hydroxy-5′-tert-butylphenyl)benzotriazole, 2-(2′-hydroxy-3′,5′-di-tert-amylphenyl)benzotriazole and 2-(2′-hydroxy-3′,5′-di-tert-butylphenyl)-5-chlorobenzotriazole.

As for the ultraviolet absorbent, a plurality of ultraviolet absorbents differing in the absorption wavelength are preferably used in combination, because a high shielding effect can be obtained over a wide wavelength range. The ultraviolet absorbent for liquid crystal preferably has excellent capability of absorbing ultraviolet light at a wavelength of 370 nm or less from the standpoint of preventing deterioration of liquid crystal and at the same time, less absorbs visible light at a wavelength 400 nm or more in view of liquid crystal display property. The particularly preferred ultraviolet absorbent is the above-described benzotriazole-based compound, benzophenone-based compound or salicylic acid ester-based compound. Above all, the benzotriazole-based compound is preferred because of less occurrence of unnecessary coloration for the cellulose ester.

Furthermore, as for the ultraviolet absorbent, compounds described in JP-A-60-235852, JP-A-3-199201, JP-A-5-1907073, JP-A-5-194789, JP-A-5-271471, JP-A-6-107854, JP-A-6-118233, JP-A-6-148430, JP-A-7-11056, JP-A-7-11055, JP-A-7-11056, JP-A-8-29619, JP-A-8-239509 and JP-A-2000-204173 may also be used.

The amount of the ultraviolet absorbent added is preferably from 0.001 to 5 mass %, more preferably from 0.01 to 1 mass %, based on the cellulose acylate. If the amount added is less than 0.001 mass %, the effect by the addition cannot be sufficiently brought out, whereas if the amount added exceeds 5 mass %, the ultraviolet absorbent sometimes bleeds out to the film surface.

The ultraviolet absorbent may be added simultaneously at the time of dissolving the cellulose acylate or may be added to the dope after the dissolution. In particular, a mode of adding the ultraviolet absorbent solution to the dope immediately before casting by using a static mixer or the like is preferred, because the spectral absorption characteristics can be easily adjusted.

The deterioration inhibitor can prevent deterioration or decomposition of the cellulose triacetate or the like. Examples of the deterioration inhibitor include compounds such as butylamine, hindered amine compound (JP-A-8-325537), guanidine compound (JP-A-5-271471), benzotriazole-based UV absorbent (JP-A-6-235819) and benzophenone-based UV absorbent (JP-A-6-118233).

The plasticizer is preferably a phosphoric acid ester or a carboxylic acid ester. Also, the plasticizer is more preferably selected from triphenyl phosphate (TPP), tricresyl phosphate (TCP), cresyl diphenyl phosphate, octyl diphenyl phosphate, diphenyl biphenyl phosphate, trioctyl phosphate, tributyl phosphate, dimethyl phthalate (DMP), diethyl phthalate (DEP), dibutyl phthalate (DBP), dioctyl phthalate (DOP), diphenyl phthalate (DPP), diethylhexyl phthalate (DEHP), triethyl O-acetylcitrate (OACTE), tributyl O-acetylcitrate (OACTB), acetyltriethyl citrate, acetyltributyl citrate, butyl oleate, methylacetyl ricinoleate, dibutyl sebacate, triacetin, tributyrin, butylphthalyl butyl glycolate, ethylphthalyl ethyl glycolate, methylphthalyl ethyl glycolate and butylphthalyl butyl glycolate. The plasticizer is still more preferably (di)pentaerythritol esters, glycerol esters or diglycerol esters.

Examples of the separation accelerator include ethyl esters of citric acid, and examples of the infrared absorbent include those described in JP-A-2001-194522.

These additives may be added at any stage in the dope preparation process, but a step of adding the additives to prepare a dope may be added as a final preparation step of the dope preparation process. The amount of each material added is not particularly limited as long as its function can be exerted. When the cellulose acylate film is a multilayer film, the kind or amount added of the additive may be different among respective layers. This is a conventionally known technique described, for example, in JP-A-2001-151902. By selecting the kind or amount added of such an additive, the cellulose acylate film is preferably adjusted to have a glass transition point Tg of 70 to 150° C. as measured by a dynamic viscoelasticity meter (Vibron: DVA-225 (manufactured by IT Keisoku Seigyo K.K.)) and an elastic modulus of 1,500 to 4,000 MPa as measured by a tensile tester (Storograph-R2 (manufactured by Toyo Seiki Seisaku-Sho, Ltd.)), more preferably a glass transition point Tg of 80 to 135° C. and an elastic modulus of 1,500 to 3,000 MPa. That is, in view of processability into a polarizing plate or suitability for fabrication process of a liquid crystal display device, the cellulose acylate film of the present invention preferably has a glass transition point Tg and an elastic modulus in the ranges above.

### [Fine Particulate Matting Agent]

The cellulose acylate film of the present invention preferably contains a fine particle as a matting agent. Examples of the fine particle for use in the present invention include silicon dioxide, titanium dioxide, aluminum oxide, zirconium oxide, calcium carbonate, talc, clay, calcined kaolin, calcined calcium silicate, hydrated calcium silicate, aluminum silicate, magnesium silicate and calcium phosphate. A fine particle containing silicon is preferred in terms of giving low turbidity, and silicon dioxide is more preferred. The fine particulate silicon dioxide is preferably a fine particle having a primary average particle diameter of 20 nm or less and an apparent specific gravity of 70 g/liter ore more. A fine particle having a primary average particle diameter as small as 5 to 16 nm is more preferred, because the haze of the film can be decreased. The apparent specific gravity is preferably from 90 to 200 g/liter or more, more preferably from 100 to 200 g/liter or more. A larger apparent specific gravity is preferred because a liquid dispersion having a higher concentration can be prepared and the haze and aggregate are improved.

The fine particles usually form a secondary particle having an average particle diameter of 0.1 to 3.0 μm and in the film, this particle is present as an aggregate of primary particles and forms irregularities of 0.1 to 3.0 μm on the film surface. The secondary average particle diameter is preferably from 0.2 to 1.5 μm, more preferably from 0.4 to 1.2 μm, and most preferably from 0.6 to 1.1 μm. As for the primary and secondary particle diameters, particles in the film are observed through a scanning electron microscope, and the diameter of a circle circumscribing a particle is defined as the particle diameter. Also, 200 particles at different places are observed and the average value thereof is defined as the average particle diameter.

The fine particulate silicon dioxide used may be a commercially available product such as Aerosil R972, R972V, R974, R812, 200, 200V, 300, R202, OX50 and TT600 (all produced by Nihon Aerosil Co., Ltd.). The fine particulate zirconium oxide is commercially available under the trade name of, for example, Aerosil R976 or R811 (both produced by Nihon Aerosil Co., Ltd.), and these may be used.

Among these, Aerosil 200V and Aerosil R972V are preferred because these are fine particulate silicon dioxide having an average primary particle diameter of 20 nm or less and an apparent specific gravity of 70 g/liter or more and provide a high effect of decreasing the coefficient of friction while maintaining low turbidity of the optical film.

In the present invention, in order to obtain a cellulose acylate film containing particles having a small secondary average particle diameter, several methods may be employed at the preparation of a liquid dispersion of fine particles. For example, there is a method where a solvent and fine particles are mixed with stirring to previously prepare a liquid dispersion of fine particles, the obtained liquid dispersion of fine particles is added to a slight amount of a separately prepared cellulose acylate solution and then dissolved with stirring, and the resulting solution is further mixed with a main cellulose acylate dope solution. This preparation method is preferred in that dispersibility of fine particulate silicone dioxide is good and re-aggregation of fine particulate silicon dioxide scarcely occurs. In another method, a slight amount of a cellulose ester is added to a solvent and then dissolved with stirring, fine particles are added thereto and dispersed by a disperser to obtain a fine particle-added solution, and the fine particle-added solution is thoroughly mixed with a dope solution by an in-line mixer. The present invention is not limited to these methods, but the concentration of silicon dioxide at the time of mixing fine particulate silicon dioxide with a solvent and dispersing the fine particles is preferably from 5 to 30 mass %, more preferably from 10 to 25 mass %, and most preferably from 15 to 20 mass %. A higher dispersion concentration is preferred because the liquid turbidity for the amount added becomes low and the haze and aggregate are improved. In the dope solution of final cellulose acylate, the amount of the matting agent added is preferably from 0.01 to 110 g/m², more preferably from 0.03 to 0.3 g/m², and most preferably from 0.08 to 0.16 g/m².

Furthermore, additives described in detail in JIII Journal of Technical Disclosure, No. 2001-1745, page 16 et seq., Japan Institute of Invention and Innovation (Mar. 15, 2001) can be appropriately used.

As for the solvent used here, preferred examples of the lower alcohols include methyl alcohol, ethyl alcohol, propyl alcohol, isopropyl alcohol and butyl alcohol. The solvents other than the lower alcohol are not particularly limited, but the solvent used at the film formation of cellulose ester is preferably used.

### [Organic Solvent]

In the present invention, the cellulose acylate film is preferably produced by a solvent casting method, and the film is produced using a solution (dope) prepared by dissolving a cellulose acylate in an organic solvent. The organic solvent which is preferably used as a main solvent in the present invention is preferably a solvent selected from an ester, ketone or ether having a carbon number of 3 to 12 and a halogenated hydrocarbon having a carbon number of 1 to 7. The ester, ketone or ether may have a cyclic structure. A compound having any two or more functional groups of ester, ketone and ether (that is, —O—, —CO— and —COO—) may also be used as a main solvent, and the compound may have other functional groups such as alcoholic hydroxyl group. In the case of a main solvent having two or more kinds of functional groups, the number of carbon atoms of the solvent may be sufficient if it is in the range specified for a compound having any one of those functional groups.

For the cellulose acylate film of the present invention, a chlorine-containing halogenated hydrocarbon may be used as a main solvent or, as described in JIII Journal of Technical Disclosure, No. 2001-1745, pp. 12-16, a chlorine-free solvent may be used as a main solvent. In this respect, the cellulose acylate film of the present invention is not particularly limited.

Other solvents for the cellulose acylate solution or film of the present invention, including the dissolution method, are described in the following patent publications, and these are preferred embodiments. The solvents are described, for example, in JP-A-2000-95876, JP-A-12-95877, JP-A-10-324774, JP-A-8-152514, JP-A-10-330538, JP-A-9-95538, JP-A-9-95557, JP-A-10-235664, JP-A-12-63534, JP-A-11-21379, JP-A-10-182853, JP-A-10-278056, JP-A-10-279702, IP-A-10-323853, JP-A-10-237186, JP-A-11-60807, JP-A-11-152342, JP-A-11-292988 and JP-A-11-60752. In these patent publications, not only the solvents preferred for the cellulose acylate of the present invention but also physical properties of their solutions and co-existing substances to be present together are described, and these are preferred embodiments also in the present invention.

### [Preparation of Dope]

In the preparation of the cellulose acylate solution (dope) for use in the present invention, the method for dissolving the cellulose acylate is not particularly limited, and the cellulose acylate may be dissolved at room temperature or dissolved by using a cooling dissolution method, a high temperature dissolution method or a combination thereof. In this respect, the preparation method of a cellulose acylate solution is described, for example, in JP-A-5-163301, JP-A-61-106628, JP-A-58-127737, JP-A-9-95544, JP-A-10-95854, JP-A-10-45950, JP-A-2000-53784, JP-A-11-322946, JP-A-11-322947, JP-A-2-276830, JP-A-2000-273239, JP-A-11-71463, JP-A-04-259511, JP-A-2000-273184, JP-A-11-323017 and JP-A-11-302388. The methods for dissolving cellulose acylate in an organic solvent described in these patent publications can be appropriately employed also in the present invention. In particular, as for the chlorine-free solvent system, the dissolution is performed by the method described in detail in JIII Journal of Technical Disclosure, No. 2001-1745, pp. 22-25, Japan Institute of Invention and Innovation (Mar. 15, 2001). Furthermore, the dope solution of cellulose acylate for use in the present invention is usually subjected to concentration of solution and filtration, and these are also described in detail in JIII Journal of Technical Disclosure, No. 2001-1745, page 25, Japan Institute of Invention and Innovation (Mar. 15, 2001). In the case of dissolving the cellulose acylate at a high temperature, the temperature is most often higher than the boiling point of the organic solvent used and in such a case, a system under pressure is used.

With respect to the concentration of the cellulose acylate solution, as described above, a high-concentration dope is characteristically obtained and therefore, a high-concentration cellulose acylate solution having excellent stability can be obtained even without relying on the concentrating means. In order to more facilitate the dissolution, after dissolving the cellulose acylate to a low concentration, the solution may be concentrated by using the concentrating means. The method for concentrating the solution is not particularly limited, but the solution may be concentrated, for example, by a method of introducing a low-concentration solution between a cylindrical body and a rotation trajectory in the outer circumference of a rotary blade rotating in the circumferential direction inside the cylindrical body and at the same time, creating a temperature difference between the cylindrical body and the solution, thereby obtaining a high-concentration solution while evaporating the solvent (see, for example, JP-A-4-259511); or a method of injecting a heated low-concentration solution into a vessel from a nozzle, flash-evaporating the solvent during traveling of the solution from the nozzle until reaching the inner wall of vessel, and extracting the solvent vapor from the vessel while extracting a high-concentration solution from the bottom of vessel (see, for example, U.S. Pat. Nos. 2,541,012, 2,858,229, 4,414,341 and 4,504,355).

In advance of casting, foreign matters in the solution, such as undissolved material, dust and impurity, are preferably removed by filtration with use of an appropriate filter medium. The filter used for the filtration of cellulose acylate solution preferably has an absolute filtration precision of 0.1 to 100 μm, more preferably from 0.5 to 25 μm. The thickness of the filter is preferably from 0.1 to 10 mm, more preferably from 0.2 to 2 mm. The filtration pressure is preferably 16 kgf/cm² or less, more preferably 12 kgf/cm² or less, still more preferably 10 kgf/cm² or less, yet still more preferably 2 kgf/cm² or less. As for the filter medium, a conventionally known material such as glass fiber, cellulose fiber, filter paper and fluororesin (e.g., ethylene tetrafluoride resin) can be preferably used. In particular, ceramic, metal and the like are preferred. The viscosity of the cellulose acylate solution immediately before film formation may be sufficient if it is in the range of enabling casting at the film formation. Usually, the solution is preferably prepared to have a viscosity of 10 to 2,000 Pa·s, more preferably from 30 to 1,000 Pa·s, still more preferably from 40 to 500 Pa·s. At this time, the temperature is not particularly limited as long as it is a temperature at the casting, but the temperature is preferably from −5 to 70° C., more preferably from −5 to 55° C.

Furthermore, in the present invention, when the cellulose acylate solution is prepared under the following conditions, a thick and uniform solution is obtained, drying uniformly proceeds in the subsequent drying step, a skin layer is less formed, generation of axial micro-slippage is suppressed, and reduction of optical unevenness, which is one of the effects of the present invention, is attained.

The number of stirring rotations per minute at the preparation of the solution is preferably from 50 to 90, more preferably from 55 to 90, still more preferably from 60 to 90. For the purpose of uniformly swelling the cellulose acylate with the solvent, the stirring time at the preparation of the solution is preferably 70 minutes or more, more preferably 80 minutes or more, still more preferably 90 minutes or more. Furthermore, the stirring is preferably performed with a temperature difference of 110° C. or more, more preferably 12° C. or more, still more preferably 15° C. or more.

### [Film Formation]

The film production method using the cellulose acylate solution is described below. As for the method and apparatus for producing the cellulose acylate film of the present invention, the solution casting film-forming method and solution casting film-forming apparatus conventionally employed for the production of a cellulose triacetate film are used. The dope (cellulose acylate solution) prepared in a dissolving machine (kettle) is once stored in a storing kettle and finalized by removing the bubbles contained in the dope. The dope is fed to a pressure-type die from the dope discharge port through a pressure-type quantitative pump capable of feeding a constant amount of solution with high precision, for example, by the rotation number and is uniformly cast on an endlessly running metal support in the casting part from the mouth ring (slit) of the pressure-type die, and the damp-dry dope film (also called web) is separated from the metal support at the separation point after traveling nearly one round of the metal support. The obtained web is nipped by clips at both ends, conveyed by a tenter while keeping the width, thereby dried, then conveyed by a roll group of a drying apparatus to complete the drying, and taken up in a predetermined length by a take-up machine. The combination of the tenter and the drying apparatus comprising a roll group varies depending on the purpose. In the solution casting film-forming method used for a silver halide photographic light-sensitive material or a functional protective film for electronic displays, in addition to the solution casting film-forming apparatus, a coating apparatus is added in many cases so as to apply a surface treatment to the film, such as subbing layer, antistatic layer, antihalation layer and protective layer. Each production step is simply described below, but the present invention is not limited thereto.

In producing a cellulose acylate film by a solvent cast method, the prepared cellulose acylate solution (dope) is cast on a drum or a band and the solvent is evaporated to form a film. The dope before casting is preferably adjusted to a concentration giving a solid content amount of 5 to 40 mass %. The surface of the drum or band is preferably finished to a mirror state. The dope is preferably cast on a drum or band having a surface temperature of 30° C. or less. In particular, the metal support temperature is preferably from −10 to 20° C. Furthermore, the techniques described in JP-A-2000-301555, JP-A-2000-301558, JP-A-07-032391, JP-A-03-193316, JP-A-05-086212, JP-A-62-037113, JP-A-02-276607, JP-A-55-014201, JP-A-02-111511 and JP-A-02-208650 may be applied in the present invention.

### [Casting]

Examples of the method for casting the solution include a method of uniformly extruding the prepared dope on a metal support from a pressure die, a doctor blade method of controlling the thickness of the dope once cast on a metal support by using a blade, and a reverse roll coater method of controlling the thickness by using a roll rotating in reverse. Among these, the method using a pressure die is preferred. The pressure die includes a coat hanger die, a T-die and the like, and any of these can be preferably used. Other than the methods described above, conventionally known various methods for casting and film-forming a cellulose triacetate solution can be employed, and the same effect as that described in each publication can be obtained by setting respective conditions while taking into consideration the difference in the boiling point or the like of the solvent used. The endlessly running metal support used in the production of the cellulose acylate film of the present invention is a drum with the surface being mirror-finished by chromium plating or a stainless steel belt (may also be called a band) mirror-finished by surface polishing. As for the pressure die used in the production of the cellulose acylate film of the present invention, one unit or two or more units may be disposed on the upper side of the metal support. One unit or two units are preferred. In the case of disposing two or more units, the amount of the dope cast may be divided at various ratios among the dies, or the dope may be fed to the dies at respective ratios from a plurality of precision quantitative gear pumps. The temperature of the cellulose acylate solution used for casting is preferably from −10 to 55° C., more preferably from 25 to 50° C. In this case, the temperature may be the same in all steps or may differ among the steps. When the temperature differs, it may be sufficient if the temperature immediately before casting is a desired temperature.

In the present invention, the width of the cast film when casting a dope containing the above-described cellulose acylate is from 2,000 to 4,000 mm, preferably from 2,200 to 3,600 mm, more preferably from 2,400 to 3,200 mm. This is a condition necessary as an optical film used in the application to a large-screen liquid crystal television.

### [Drying]

In the production of the cellulose acylate film, the dope on the metal support may be generally dried, for example, by a method of blowing hot air from the surface side of the metal support (drum or belt), that is, from the surface of the web on the metal support; a method of blowing hot air from the back surface of the drum or belt; or a liquid heat transfer method of bringing a liquid at a controlled temperature into contact with the drum or belt from the back surface opposite the dope casting surface, and heating the drum or belt through heat transfer, thereby controlling the surface temperature. The back surface liquid heat transfer method is preferred. The metal support surface before casting may be at any temperature as long as it is not more than the boiling point of the solvent used for the dope. However, in order to accelerate the drying or deprive the solution of its fluidity on the metal support, the surface temperature is preferably set to a temperature 1 to 10° C. lower than the boiling point of the solvent having a lowest boiling point out of the solvents used. Incidentally, this does not apply to the case where the cast dope is cooled and separated without drying it.

### [Stretching Treatment]

The cellulose acetate film of the present invention is preferably stretched to adjust the retardation. As a method of aggressively stretching the film in the width direction it is described, for example, in JP-A-62-115035, JP-A-4-152125, JP-A-4-284211, JP-A-4-298310 and JP-A-11-48271. It is preferred that the stretching is performed so as to elevate the in-plane retardation value of the cellulose acylate film.

The stretching of the film is performed at ordinary temperature or under heating condition. The heating temperature is preferably not more than the glass transition temperature of the film. The stretching of the film may be uniaxial stretching only in the longitudinal or transverse direction or may be simultaneous or successive biaxial stretching. The stretching is performed at a stretch ratio of 1 to 200%, preferably from 10 to 150%, more preferably from 10 to 100%. As for the birefringence of the optical film, the refractive index in the width direction is preferably larger than the refractive index in the lengthwise direction. Accordingly, the stretching is preferably performed at a larger ratio in the width direction. In the case of performing the stretching midway in the film-formation step, the film may be stretched in the state of containing a residual solvent, and the film can be stretched when the residual solvent amount is from 2 to 30%.

The film is preferably stretched in a state of the residual solvent amount being 1 mass % or less, that is, dry stretching is preferred. The dry stretching may be suitably employed when stretching a stock film which is produced and then taken up.

The thickness of the cellulose acylate film of the present invention obtained after drying varies depending on the use end but is preferably from 5 to 300 μm, more preferably from 20 to 100 μm, still more preferably from 20 to 60 μm. Particularly, in use for a VA liquid crystal display device, the film thickness is preferably from 20 to 100 μm but is preferably from 20 to 60 μm in view of the cost.

The film thickness may be adjusted to a desired thickness by controlling, for example, the concentration of solid contents contained in the dope, the slit gap of die mouth ring, the extrusion pressure from die, or the speed of metal support. The width of the thus-obtained cellulose acylate film is preferably from 2200 to 4200 mm, more preferably from 2400 to 3800 mm, still more preferably from 2600 to 3400 mm. The length of the film taken up is preferably from 100 to 10000 m, more preferably from 500 to 7000 m, still more preferably from 1000 to 6000 m, per roll. At the time of taking up the film, knurling is preferably provided on at least one edge. The width thereof is preferably from 3 to 50 mm, more preferably from 5 to 30 mm, and the height is preferably from 0.5 to 500 μm, more preferably from 1 to 200 μm. The knurling may be either one-sided pressing or double-sided pressing.

### [Haze]

The haze of the cellulose acylate film of the present invention is preferably from 0.01 to 2.0%, more preferably from 0.05 to 1.5%, still more preferably from 0.1 to 1.0%. If the haze exceeds 2%, light leakage increases when the film is laminated to a panel, and this is not preferred.

The haze can be determined by measuring the cellulose acylate film sample (40 mm×80 mm) of the present invention according to JIS K-6714 by means of a haze meter (HGM-2DP, manufactured by Suga Test Instruments Co., Ltd.) at 25° C. and 60% RH.

### [Polarizing Plate]

The polarizing plate comprises a polarizer and two transparent protective films disposed on both sides of the polarizer. The cellulose acylate film of the present invention is used at least as one protective film. The other protective film may be a normal cellulose acetate film. The polarizer includes an iodine-based polarizer, a dye-based polarizer using a dichromatic dye, and a polyene-based polarizer. The iodine-based polarizer and dye-based polarizer are generally produced using a polyvinyl alcohol-based film. In the case of using the cellulose acylate film of the present invention as a polarizing plate protective film, the polarizing plate is not particularly limited in its production method and can be produced by a general method. There is a method where the obtained cellulose acylate film is alkali-treated and by using an aqueous solution of completely saponified polyvinyl alcohol, the alkali-treated film is laminated to both surfaces of a polarizer obtained by dipping a polyvinyl alcohol film in an iodine solution and stretching it. Instead of the alkali treatment, an easy adhesion process described in JP-A-6-94915 and JP-A-6-118232 may be applied. Examples of the adhesive used for laminating the treated surface of the protective film to the polarizer include a polyvinyl alcohol-based adhesive such as polyvinyl alcohol and polyvinyl butyral, and a vinyl-based latex such as butyl acrylate. The polarizing plate is composed of a polarizer and protective films protecting both surfaces of the polarizer and is fabricated by further laminating a protect film to one surface of the polarizing plate and a separate film to the opposite surface. The protect film and separate film are used for the purpose of protecting the polarizing plate, for example, at the shipment of the polarizing plate or at the product inspection. In this case, the protect film is laminated for the purpose of protecting the polarizing plate surface and used on the surface opposite the surface through which the polarizing plate is laminated to a liquid crystal plate. The separate film is used for the purpose of covering the adhesive layer which adheres to a liquid crystal plate and used on the surface through which the polarizing plate is laminated to a liquid crystal plate.

The cellulose acylate film of the present invention is preferably laminated to a polarizer so that the transmission axis of the polarizer can agree with the slow axis of the cellulose acylate film of the present invention. Incidentally, a polarizing plate produced was evaluated in the polarizing plate cross-Nicol state and it was found that if the orthogonal precision between the slow axis of the cellulose acylate film of the present invention and the absorption axis (axis orthogonal to transmission axis) of the polarizer exceeds 1°, the polarization degree performance in the polarizing plate cross-Nicol state decreases to cause light-through. In this case, when the polarizing plate is combined with a liquid crystal cell, a sufficiently high black level or contrast cannot be obtained. Therefore, the slippage between the main refractive index nx direction of the cellulose acylate film of the present invention and the transmission axis direction of the polarizer is preferably within 1°, more preferably within 0.5°.

The single plate transmittance TT, parallel transmittance PT and cross transmittance CT of the polarizing plate are measured using UV3100PC (manufactured by Shimadzu Corporation). The measurement is performed in the range of 380 to 780 nm, and an average of 10 measurements is used for all of single plate transmittance, parallel transmittance and cross transmittance. The endurance test of the polarizing plate is performed as follows in two modes, that is, (1) a polarizing plate alone and (2) a polarizing plate laminated to glass through a pressure-sensitive adhesive. In the measurement of a polarizing plate alone, polarizing plates are combined such that the optical compensation film is sandwiched between two polarizers, and two samples having the same crossing are prepared and measured. For the glass lamination mode, the polarizing plate is laminated on glass such that the optical compensation film comes to the glass side, and two samples (about 5 cm×5 cm) are prepared. The single plate transmittance is measured by arranging the film side of this sample to face the light source. Two samples are measured, and the average of the obtained values is defined as the single plate transmittance. As regards the polarization performance, the single plate transmittance TT, the parallel transmittance PT and the cross transmittance CT are, in this order, preferably 40.0≦TT≦45.0, 30.0≦PT≦40.0 and CT≦2.0, more preferably 41.0≦TT≦44.5, 34≦PT≦39.0 and CT≦1.3 (units all are %). In the endurance test of the polarizing plate, the variation is preferably smaller.

In the polarizing plate of the present invention, when the polarizing plate is left standing at 60° C. and 95% RH for 500 hours, the variation ACT (%) of the single plate cross transmittance and the variation ΔP of the polarization degree preferably satisfy at least one of the following formulae (j) and (k):

−6.0≦ΔCT≦6.0 (j)

−10.0≦ΔP≦0.0 (k)

Here, the variation indicates a value obtained by subtracting the measured value before the test from the measured value after the test.

This requirement is preferably satisfied, because the stability of the polarizing plate during use or storage is ensured.

### [Surface Treatment]

The cellulose acylate film of the present invention may be surface-treated depending on the case, whereby the adhesion of the cellulose acylate film to each functional layer (for example, undercoat layer or back layer) can be enhanced. Examples of the surface treatment which can be used include a glow discharge treatment, an ultraviolet irradiation treatment, a corona treatment, a flame treatment and an acid or alkali treatment. The glow discharge treatment may be a low-temperature plasma occurring in a low-pressure gas of 10⁻³ to 20 Torr, and a plasma treatment in an atmospheric pressure is also preferred. The plasma-exciting gas indicates a gas which is plasma-excited under the above-described condition, and examples thereof include argon, helium, neon, krypton, xenon, nitrogen, carbon dioxide, fluorocarbons such as tetrafluoromethane, and a mixture thereof. These are described in detail in JIII Journal of Technical Disclosure, No. 2001-1745, pp. 30-32, Japan Institute of Invention and Innovation (Mar. 15, 2001). The atmospheric pressure plasma treatment taken notice of in recent years uses, for example, an irradiation energy of 20 to 500 Kgy at 10 to 1,000 Kev, preferably an irradiation energy of 20 to 300 Kgy at 30 to 500 Kev. Among these treatments, an alkali saponification treatment is preferred and this is very effective as the surface treatment of a cellulose acylate film.

The alkali saponification treatment is preferably performed by a method of dipping the cellulose acylate film directly in a bath containing a saponification solution or a method of coating a saponification solution on the cellulose acylate film.

Examples of the coating method include a dip coating method, a curtain coating method, an extrusion coating method, a bar coating method and an E-type coating method. Since the saponification solution is coated on the transparent support, the solvent of the coating solution for the alkali saponification treatment is preferably selected from those having good wettability and giving good surface state without allowing the solvent of the saponification solution to form irregularities on the transparent support surface. Specifically, an alcohol-based solvent is preferred, and isopropyl alcohol is more preferred. An aqueous solution of a surfactant may also be used as the solvent. The alkali in the coating solution for the alkali saponification is preferably an alkali dissolvable in the above-described solvent, more preferably KOH or NaOH. The pH of the saponification coating solution is preferably 10 or more, more preferably 12 or more. The reaction conditions at the alkali saponification are preferably room temperature and from 1 second to 5 minutes, more preferably from 5 seconds to 5 minutes, still more preferably from 20 seconds to 3 minutes. After the alkali saponification reaction, the saponification solution-coated surface is preferably washed with water or washed with an acid and then with water.

The polarizing plate of the present invention is a polarizing plate comprising a polarizer and two transparent protective films disposed on both sides of the polarizer, and at least one layer selected from a hardcoat layer, an antiglare layer and an antireflection layer is preferably provided on the surface of the protective film on one side. A sole functional layer or a plurality of functional layers required according to the purpose are provided on the cellulose acylate film of the present invention used as a protective film or on a transparent substrate (sometimes referred to as a support), whereby the optical film can be produced.

The transparent substrate includes a cellulose acylate film, and in view of flexibility and excellent transparency, a cellulose acylate film is preferred.

### [Antireflection Film]

One preferred embodiment of the optical film includes an antireflection film where layers are stacked on a substrate by taking into consideration, for example, the refractive index, film thickness, number of layers, and order of layers, such that the refractive index decreases by the effect of optical interference. The simplest construction of the antireflection layer is a construction where only a low refractive index layer is provided by coating on a substrate. In order to more reduce the reflectance, the antireflection layer is preferably constituted by combining a high refractive index layer having a refractive index higher than that of the substrate and a low refractive index layer having a refractive index lower than that of the substrate. Examples of the construction include a two-layer construction composed of high refractive index layer/low refractive index layer from the support side, and a construction formed by stacking three layers differing in the refractive index in the order of a medium refractive index layer (a layer having a refractive index higher than that of the substrate or hardcoat layer but lower than that of the high refractive index layer)/a high refractive index layer/a low refractive index layer. A construction where a larger number of antireflection layers are stacked is also proposed. Above all, in view of durability, optical characteristics, cost, productivity and the like, the antireflection layer is preferably coated on a substrate having thereon a hardcoat layer, in the order of a medium refractive index layer/a high refractive index layer/a low refractive index layer. Examples thereof include constructions described in JP-A-8-122504, JP-A-8-110401, JP-A-10-300902, JP-A-2002-243906 and JP-A-2000-111706.

Other functions may also be imparted to each layer, and examples thereof include an antifouling low refractive index layer and an antistatic high refractive index layer (see, for example, JP-A-10-206603 and JP-A-2002-243906).

Preferred examples of the layer construction for the antireflection film are set forth below. The antireflection film is not limited only to these layer constructions if the reflectance can be reduced by optical interference. In the following constructions, the substrate film indicates a support composed of a film.
Substrate film/low refractive index layer
Substrate film/antistatic layer/low refractive index layer
Substrate film/antiglare layer/low refractive index layer
Substrate film/antiglare layer/antistatic layer/low refractive index layer
Substrate film/hardcoat layer/antiglare layer/low refractive index layer
Substrate film/hardcoat layer/antiglare layer/antistatic layer/low refractive index layer
Substrate film/hardcoat layer/antistatic layer/antiglare layer/low refractive index layer
Substrate film/hardcoat layer/high refractive index layer/low refractive index layer
Substrate film/hardcoat layer/antistatic layer/high refractive index layer/low refractive index layer
Substrate film/hardcoat layer/medium refractive index layer/high refractive index layer/low refractive index layer
Substrate film/antiglare layer/high refractive index layer/low refractive index layer
Substrate film/antiglare layer/medium refractive index layer/high refractive index layer/low refractive index layer
Substrate film/antistatic layer/hardcoat layer/medium refractive index layer/high refractive index layer/low refractive index layer
Antistatic layer/substrate film/hardcoat layer/medium refractive index layer/high refractive index layer/low refractive index layer
Substrate film/antistatic layer/antiglare layer/medium refractive index layer/high refractive index layer/low refractive index layer
Antistatic layer/substrate film/antiglare layer/medium refractive index layer/high refractive index layer/low refractive index layer
Antistatic layer/substrate film/antiglare layer/high refractive index layer/low refractive index layer/high refractive index layer/low refractive index layer

Another preferred embodiment is an optical film where layers necessary for imparting hardcoat property, moisture-proof property, gas-barrier property, antiglare property, antifouling property and the like are provided without aggressively using optical interference.

Preferred examples of the layer construction for the film in the above-described embodiment are set forth below. In the following constructions, the substrate film indicates a support composed of a film.
Substrate film/hardcoat layer
Substrate film/hardcoat layer/hardcoat layer
Substrate film/antiglare layer
Substrate film/antiglare layer/antiglare layer
Substrate film/hardcoat layer/antiglare layer
Substrate film/antiglare layer/hardcoat layer
Substrate film/antistatic layer
Substrate film/antistatic layer/hardcoat layer
Substrate film/moisture-proof layer
Substrate film/gas-barrier layer
Substrate film/hardcoat layer/antifouling layer
Antistatic layer/substrate film/hardcoat layer
Antistatic layer/substrate film/antiglare layer
Antiglare layer/substrate film/antistatic layer

These layers can be formed by vapor deposition, atmospheric plasma, coating and the like. In view of productivity, these layers are preferably formed by coating.

Each constituent layer is described below.

### (A) Hardcoat Layer

In the film of the present invention, a hardcoat layer can be preferably provided on one surface of the transparent support so as to impart physical strength to the film. The hardcoat layer may be composed of a stack of two or more layers.

In view of optical design for obtaining an antireflection film, the refractive index of the hardcoat layer for use in the present invention is preferably from 1.48 to 2.00, more preferably from 1.52 to 1.90, still more preferably from 1.55 to 1.80. In the embodiment of having at least one low refractive index layer on a hardcoat layer, which is a preferred embodiment of the present invention, if the refractive index is less than the range above, the antireflection property decreases, whereas if it is excessively large, the color tint of reflected light tends to be intensified.

From the standpoint of imparting sufficient durability and impact resistance to the film, the thickness of the hardcoat layer is usually on the order of 0.5 to 50 μm, preferably from 1 to 20 μm, more preferably from 2 to 10 μm, and most preferably from 3 to 9 μm.

The hardness of the hardcoat layer is, in the pencil hardness test, preferably H or more, more preferably 2H or more, and most preferably 3H or more.

Furthermore, in the Taber test according to JIS K-5400, the abrasion loss of the specimen between before and after the test is preferably smaller.

The hardcoat layer is preferably formed through a crosslinking reaction or polymerization reaction of an ionizing radiation-curable compound, For example, a coating composition containing an ionizing radiation-curable polyfunctional monomer or polyfunctional oligomer is coated on a transparent support, and a crosslinking reaction or polymerization reaction of the polyfunctional monomer or polyfunctional oligomer is brought about, whereby the hardcoat layer can be formed.

The functional group in the ionizing radiation-curable polyfunctional monomer or polyfunctional oligomer is preferably a photo-, electron beam- or radiation-polymerizable functional group, more preferably a photopolymerizable functional group.

Examples of the photopolymerizable functional group include an unsaturated polymerizable functional group such as (meth)acryloyl group, vinyl group, styryl group and allyl group. Among these, a (meth)acryloyl group is preferred.

In place of or in addition to the monomer having a polymerizable unsaturated groups, a crosslinking functional group may be introduced into the binder. Examples of the crosslinking functional group include an isocyanate group, an epoxy group, an aziridine group, an oxazoline group, an aldehyde group, a carbonyl group, a hydrazine group, a carboxyl group, a methylol group and an active methylene group. In addition, a vinylsulfonic acid, an acid anhydride, a cyanoacrylate derivative, a melamine, an etherified methylol, an ester, a urethane or a metal alkoxide such as tetramethoxysilane can also be used as the monomer having a crosslinked structure. A functional group which exhibits crosslinking property as a result of the decomposition reaction, such as block isocyanate group, may also be used. That is, the crosslinking functional group for use in the present invention may be a functional group which does not directly cause a reaction but exhibits reactivity as a result of the decomposition. The binder having such a crosslinking functional group is coated and then heated, whereby a crosslinked structure can be formed.

In the hardcoat layer, a matte particle having an average particle size of 1.0 to 15.0 μm, preferably from 1.5 to 10.0 μm, such as inorganic compound particle or resin particle, may be incorporated for the purpose of imparting internal scattering property.

In the binder of the hardcoat layer, a high refractive index monomer, an inorganic fine particle or both may be added for the purpose of controlling the refractive index of the hardcoat layer. The inorganic fine particle has an effect of suppressing curing shrinkage ascribable to the crosslinking reaction, in addition to the effect of controlling the refractive index. In the present invention, a polymer which is produced as a result of polymerization of the above-described polyfunctional monomer and/or high refractive index monomer or the like after the formation of the hardcoat layer is referred to as a binder, including the inorganic particle dispersed therein.

The haze of the hardcoat layer varies depending on the function imparted to the optical film.

In the case of maintaining the sharpness of an image by keeping low the reflectance on the surface and not imparting a light-scattering function to the inside and surface of the hardcoat layer, the haze value is preferably as low as possible. Specifically, the haze value is preferably 10% or less, more preferably 5% or less, and most preferably 2% or less.

On the other hand, in the case of imparting an antiglare function by the effect of surface scattering of the hardcoat layer, the surface haze is preferably from 5 to 15%, more preferably from 5 to 10%.

Also, in the case of imparting a function of making less perceivable the liquid crystal panel pattern, color unevenness, brightness unevenness or glaring by the effect of internal scattering of the hardcoat layer or a function of enlarging the viewing angle by the effect of scattering, the internal haze value (a value obtained by subtracting the surface haze value from the entire haze value) is preferably from 10 to 90%, more preferably form 15 to 80%, and most preferably from 20 to 70%.

In the film of the present invention, the surface haze and internal haze can be freely set according to the purpose.

As for the surface irregularity shape of the hardcoat layer, out of properties indicating the surface roughness, for example, the centerline average roughness (Ra) is preferably set to be 0.08 μm or less so as to obtain a clear surface for the purpose of maintaining the sharpness of an image. Ra is more preferably 0.07 μm or less, still more preferably 0.06 μm or less. In the film of the present invention, the surface irregularities of the film are governed by the surface irregularities of the hardcoat layer and by adjusting the centerline average roughness of the hardcoat layer, the antireflection film can be made to have a centerline average roughness within the above-described range.

For the purpose of maintaining the sharpness of an image, the transmitted image clarity is preferably adjusted in addition to the adjustment of the surface irregularity shape. The transmitted image clarity of a clear antireflection film is preferably 60% or more. The transmitted image clarity is generally an index for the degree of blurring of an image transmitted through and reflected on the film and as this value is larger, the image viewed through the film is clearer and better. The transmitted image clarity is preferably 70% or more, more preferably 80% or more.

### [Photoinitiator]

Examples of the photoradical polymerization initiator include acetophenones, benzoins, benzophenones, phosphine oxides, ketals, anthraquinones, thioxanthones, azo compounds, peroxides (see, for example, JP-A-2001-139663), 2,3-dialkyldione compounds, disulfide compounds, fluoroamine compounds, aromatic sulfoniums, lophine dimers, onium salts, borate salts, active esters, active halogens, inorganic complexes and coumarins.

These initiators may be used individually or as a mixture.

Various examples are also described in Saishin UV Koka Gijutsu (Newest UV Curing Technologies), page 159, Technical Information Institute Co., Ltd. (1991), and Kiyomi Kato, Shigaisen Koka System (Ultraviolet Curing System), pp. 65-148, Sogo Gijutsu Center (1989), and these are useful in the present invention.

Preferred examples of the commercially available photoradical polymerization initiator include KAYACURE (e.g., DETX-S, BP-100, BDMK, CTX, BMS, 2-EAQ, ABQ, CPTX, EPD, ITX QTX, BTC, MCA) produced by Nippon Kayaku Co., Ltd.; Irgacure (e.g., 651, 184, 500, 819, 907, 369, 1173, 1870, 2959, 4265, 4263) produced by Ciba Specialty Chemicals Corp.; Esacure (KIP100F, KB1, EB3, BP, X33, KT046, KT37, KIP150, TZT) produced by Sartomer Company Inc.; and a mixture thereof.

The photopolymerization initiator is preferably used in an amount of 0.1 to 15 parts by mass, more preferably from 1 to 10 parts by mass, per 100 parts by mass of the polyfunctional monomer.

### [Surface State Improver]

In the coating solution used for producing any layer on the support, at least either a fluorine-based surface state improver or a silicone-based surface state improver is preferably added so as to improve the surface state failure (e.g., coating unevenness, drying unevenness, point defect).

The surface state improver preferably changes the surface tension of the coating solution by 1 mN/m or more. Here, when the surface tension of the coating solution is changed by 1 mN/m or more, this means that the surface tension of the coating solution after the addition of the surface state improver, including the concentration process at the coating/drying, is changed by 1 mN/m or more as compared with the surface tension of the coating solution where the surface state improver is not added. A surface state improver reducing the surface tension of the coating solution by 1 mN/m or more is preferred, a surface state improver reducing the surface tension by 2 mN/m or more is more preferred, and a surface state improve reducing the surface tension by 3 mN/m or more is still more preferred.

Preferred examples of the fluorine-based surface state improver include a compound having a fluoroaliphatic group. Preferred examples of the compound include compounds described in JP-A-2005-115359, JP-A-2005-221963 and JP-A-2005-234476.

### (B) Antiglare Layer

The antiglare layer is formed for the purpose of providing the film with antiglare property by surface scattering and preferably hardcoat property for enhancing the scratch resistance of the film.

Known examples of the method for imparting antiglare property include a method of forming the antiglare layer by laminating a matte shaped film having fine irregularities on its surface described in JP-A-6-16851; a method of forming the antiglare layer by varying the irradiation dose of ionizing radiation and thereby bringing out curing shrinkage of an ionizing radiation-curable resin described in JP-A-2000-206317; a method of decreasing through drying the weight ratio of a good solvent for light-transparent resin and thereby gelling and solidifying the light-transparent fine particle and light-transparent resin to form irregularities on the film coating surface described in JP-A-2000-338310; a method of imparting surface irregularities by externally applying a pressure described in JP-A-2000-275404; and a method of forming surface irregularities by utilizing phase separation which occurs in the process of a solvent evaporating from a mixed solution comprising a plurality of polymers described in JP-A-2005-195819. These known methods can be utilized.

The antiglare layer which can be used in the present invention is preferably an antiglare layer containing, as essential components, a binder capable of imparting hardcoat property, a light-transparent particle for imparting antiglare property, and a solvent, where the irregularities on the surface are formed by the protrusion of the light-transparent particle itself or by the protrusion of an aggregate of a plurality of particles.

The antiglare layer formed by the dispersed matte particles comprises a binder and a light-transparent particle dispersed in the binder. The antiglare layer having antiglare property preferably has both antiglare property and hardcoat property.

Specific preferred examples of the matte particle include an inorganic compound particle such as silica particle and TiO₂ particle; and a resin particle such as acryl particle, crosslinked acryl particle, polystyrene particle, crosslinked styrene particle, melamine resin particle and benzogtianamine resin particle. Among these, a crosslinked styrene particle, a crosslinked acryl particle and a silica particle are more preferred. The shape of the matte particle may be either spherical or amorphous.

Also, two or more kinds of matte particles differing in the particle diameter may be used in combination. The matte particle having a larger particle diameter can impart antiglare property and the matte particle having a smaller particle diameter can impart another optical property. For example, when an antiglare antireflection film is laminated on a high definition display of 133 ppi or more, a trouble in view of display image grade, called “glaring”, is sometimes generated. The “glaring” is ascribable to loss of brightness uniformity resulting from enlargement or shrinkage of a pixel due to irregularities present on the antiglare antireflection film surface, but this can be greatly improved by using together a matte particle having a particle diameter smaller than that of the antiglare property-imparting matte particle and having a refractive index different from that of the binder.

The matte particle is contained in the antiglare layer such that the amount of the matte particle in the formed antiglare hardcoat layer becomes preferably from 10 to 1,000 mg/m², more preferably from 100 to 700 mg/m².

The thickness of the antiglare layer is preferably from 1 to 20 μm, more preferably from 2 to 10 μm. Within this range, the hardcoat property and properties in view of curling and brittleness can be satisfied.

The centerline average roughness (Ra) of the antiglare hardcoat layer is preferably from 0.09 to 0.40 μm. If the centerline average roughness exceeds 0.40 μm, there arises a problem such as glaring or surface whitening due to reflection of outside light. The transmitted image clarity is preferably from 5 to 60%.

The strength of the antiglare layer is, in the pencil hardness test, preferably H or more, more preferably 2H or more, still more preferably 3H or more.

### [Light-Scattering Layer]

The light-scattering layer is formed for the purpose of providing the film with light scattering property by at least either surface scattering or internal scattering and hardcoat property for enhancing the scratch resistance of the film. Accordingly, the light-scattering layer comprises a binder for imparting hardcoat property, a matte particle for imparting light scattering property, and, if desired, an inorganic filler for elevating the refractive index, preventing crosslinking shrinkage and intensifying the strength. Furthermore, when such a light-scattering layer is provided, the light-scattering layer functions also as an antiglare layer and the polarizing plate comes to have an antiglare layer.

From the standpoint of imparting hardcoat property, the thickness of the light-scattering layer is preferably from 1 to 10 μm, more preferably from 1.2 to 6 μm. If the thickness is too small, the hard property is insufficient, whereas if it is too large, the curling or brittleness is worsened and the suitability for processing is not satisfied.

The binder of the light-scattering layer is preferably a polymer having a saturated hydrocarbon chain or a polyether chain as the main chain, more preferably a polymer having a saturated hydrocarbon chain as the main chain. Also, the binder polymer preferably has a crosslinked structure. The binder polymer having a saturated hydrocarbon chain as the main chain is preferably a polymer of an ethylenically unsaturated monomer. The binder polymer having a saturated hydrocarbon chain as the main chain and having a crosslinked structure is preferably a (co)polymer of a monomer having two or more ethylenically unsaturated groups. In order to obtain a binder polymer having a high refractive index, a monomer containing in the structure an aromatic ring or at least one atom selected from a halogen atom (except for fluorine), a sulfur atom, a phosphorus atom and a nitrogen atom may also be selected.

Examples of the monomer having two or more ethylenically unsaturated groups include an ester of polyhydric alcohol and (meth)acrylic acid (e.g., ethylene glycol di(meth)acrylate, butanediol di(meth)acrylate, hexanediol di(meth)acrylate, 1,4-cyclohexane diacrylate, pentaerythritol tetra(meth)acrylate, pentaerythritol tri(meth)acrylate, trimethylolpropane tri(meth)acrylate, trimethylolethane tri(meth)acrylate, dipentaerythritol tetra(meth)acrylate, dipentaerythritol penta(meth)acrylate, dipentaerythritol hexa(meth)acrylate, pentaerythritol hexa(meth)acrylate, 1,2,3-cyclohexane tetramethacrylate, polyurethane polyacrylate, polyester polyacrylate), an ethylene oxide-modified product of the ester above, a vinylbenzene and a derivative thereof (e.g., 1,4-divinylbenzene, 4-vinylbenzoic acid-2-acryloyl ethyl ester, 1,4-divinylcyclohexanone), a vinylsulfone (e.g., divinylsulfone) an acrylamide (e.g., methylenebisacrylamide), and a methacrylamide. These monomers may be used in combination of two or more thereof.

Specific examples of the high refractive index monomer include bis(4-methacryloylthiophenyl)sulfide, vinylnaphthalene, vinylphenyl sulfide and 4-methacryloxyphenyl-4′-methoxyphenyl thioether. These monomers may also be used in combination of two or more thereof.

The polymerization of such a monomer having ethylenically unsaturated groups can be performed by the irradiation of ionizing radiation or under heat in the presence of a photoradical initiator or a thermal radical initiator.

Accordingly, the antireflection film can be formed by preparing a coating solution containing a monomer having ethylenically unsaturated groups, a photoradical initiator or thermal radical initiator, a matte particle and an inorganic filler, coating the coating solution on the protective film, and curing the coating through a polymerization reaction by the irradiation of ionization radiation or under heat. As for the photoradical initiator and the like, known materials can be used.

The polymer having a polyether as the main chain is preferably a ring-opening polymer of a polyfunctional epoxy compound. The ring-opening polymerization of a poly-functional epoxy compound can be performed by the irradiation of ionizing radiation or under heat in the presence of a photoacid generator or a heat-acid generator.

Accordingly, the antireflection film can be formed by preparing a coating solution containing a polyfunctional epoxy compound, a photoacid generator or heat-acid generator, a matte particle and an inorganic filler, coating the coating solution on the protective film, and curing the coating through a polymerization reaction by the irradiation of ionizing radiation or under heat.

A crosslinking functional group may be introduced into the polymer by using a monomer having a crosslinking functional group in place of or in addition to the monomer having two or more ethylenically unsaturated groups, and a crosslinked structure may be introduced into the binder polymer through a reaction of the crosslinking functional group.

Examples of the crosslinking functional group include an isocyanate group, an epoxy group, an aziridine group, an oxazoline group, an aldehyde group, a carbonyl group, a hydrazine group, a carboxyl group, a methylol group and an active methylene group. In addition, a vinylsulfonic acid, an acid anhydride, a cyanoacrylate derivative, a melamine, an etherified methylol, an ester, a urethane, and a metal alkoxide such as tetramethoxysilane can also be used as the monomer for introducing the crosslinked structure. A functional group which exhibits crosslinking property as a result of the decomposition reaction, such as blocked isocyanate group, may also be used. That is, the crosslinking functional group for use in the present invention may be a functional group which does not directly cause a reaction but exhibits reactivity as a result of the decomposition.

The binder polymer having a crosslinking functional group is coated and then heated, whereby a crosslinked structure can be formed.

In the light-scattering layer, a matte particle larger than the filler particle and having an average particle diameter of 1 to 10 μm, preferably from 1.5 to 7.0 μm, such as inorganic compound particle or resin particle, is contained for the purpose of imparting antiglare property.

Specific preferred examples of the matte particle include an inorganic compound particle such as silica particle and TiO₂ particle; and a resin particle such as acrylic particle, crosslinked acrylic particle, polystyrene particle, crosslinked styrene particle, melamine resin particle and benzoguanamine resin particle. Among these, a crosslinked styrene particle, a crosslinked acryl particle, a crosslinked acrylstyrene particle and a silica particle are more preferred. The shape of the matte particle may be either spherical or amorphous.

Also, two or more kinds of matte particles differing in the particle diameter may be used in combination. The matte particle having a larger particle diameter can impart antiglare property and the matte particle having a smaller particle diameter can impart another optical property.

The particle diameter distribution of the matte particle is most preferably monodisperse, and individual particles preferably have the same particle diameter as much as possible. For example, when a particle having a particle diameter 20% or more larger than the average particle diameter is defined as a coarse particle, the percentage of the coarse particle in the total number of particles is preferably 1% or less, more preferably 0.1% or less, still more preferably 0.01% or less. The matte particle having such a particle diameter distribution is obtained by classifying the particles after a normal synthesis reaction, and when the number of classifications is increased or the level of classification is elevated, a matting agent having a more preferred distribution can be obtained.

The matte particle is contained in the light-scattering layer such that the amount of the matte particle in the formed light-scattering layer becomes preferably from 10 to 1,000 mg/m², more preferably from 100 to 700 mg/m².

The particle size distribution of the matte particle is measured by the Coulter counter method, and the measured distribution is converted into a particle number distribution.

In the light-scattering layer, for elevating the refractive index of the layer, an inorganic filler comprising an oxide of at least one metal selected from titanium, zirconium, aluminum, indium, zinc, tin and antimony and having an average particle diameter of 0.2 μm or less, preferably 0.1 μm or less, more preferably 0.06 μm or less is preferably contained in addition to the above-described matte particle.

Conversely, for increasing the difference in the refractive index from the matte particle, in the light-scattering layer using a high refractive index matte particle, a silicon oxide is also preferably used so that the refractive index of the layer can be kept rather low. The preferred particle diameter is the same as that of the above-described inorganic filler.

Specific examples of the inorganic filler for use in the light-scattering layer include TiO₂, ZrO₂, Al₂O₃, In₂O₃, ZnO, SnO₂, Sb₂O₃, ITO and SiO₂. Among these, TiO₂ and ZrO₂ are preferred from the standpoint of elevating the refractive index. It is also preferred to subject the surface of the inorganic filler to a silane coupling treatment or a titanium coupling treatment. A surface treating agent having a functional group capable of reacting with the binder species on the filler surface is preferably used.

The amount of the inorganic filler added is preferably from 10 to 90%, more preferably from 20 to 80%, still more preferably from 30 to 75%, based on the entire mass of the light-scattering layer.

Such as filler causes no scattering because the particle diameter is sufficiently smaller than the wavelength of light, and the dispersion where the filler is dispersed in the binder polymer behaves as an optically uniform substance.

The bulk refractive index of a mixture of the binder and the inorganic filler in the light-scattering layer is preferably from 1.50 to 2.00, more preferably from 1.51 to 1.80. For adjusting the refractive index to this range, the kinds of the binder and inorganic filler and the ratio of amounts thereof may be appropriately selected. How to select can be easily known by previously performing an experiment.

Particularly, in order to ensure surface uniformity of the light-scattering layer by preventing coating unevenness, drying unevenness, point defect or the like, the coating composition for the formation of the light-scattering layer contains either a fluorine-containing surfactant, a silicone-containing surfactant or both. Above all, a fluorine-containing surfactant is preferably used, because the effect of improving surface failures such as coating unevenness, drying unevenness and point defect of the antireflection film of the present invention can be brought out with a smaller amount of the surfactant added. It is a purpose to impart suitability for high-speed coating while enhancing the surface uniformity and thereby elevate the productivity.

### (C) High Refractive Index Layer, Medium Refractive Index Layer

In the film of the present invention, when a high refractive index layer and a medium refractive index layer are provided to utilize the optical interference together with a low refractive index layer described later, the antireflection property can be enhanced.

In the following context of the present invention, these high refractive index layer and medium refractive index layer are sometimes collectively referred to as a high refractive index layer. Incidentally, in the present invention, the terms “high”, “medium” and “low” in the high refractive index layer, medium refractive index layer and low refractive index indicate the relative size of refractive index among layers. In terms of the relationship with the transparent support, the refractive index preferably satisfies the relationships of transparent support>low refractive index layer, and high refractive index layer>transparent support.

Also, in the context of the present invention, the high refractive layer, medium refractive layer and low refractive index layer are sometimes collectively referred to as an antireflection layer.

For producing an antireflection film by forming a low refractive index layer on a high refractive index layer, the refractive index of the high refractive index layer is preferably from 1.55 to 2.40, more preferably from 1.60 to 2.20, still more preferably from 1.65 to 2.10, and most preferably from 1.80 to 2.00.

In the case of producing an antireflection film by providing, in order, a medium refractive index layer, a high refractive index layer and a low refractive index layer from the support side, the refractive index of the high refractive index layer is preferably from 1.65 to 2.40, more preferably from 1.70 to 2.20. The refractive index of the medium refractive index layer is adjusted to a value between the refractive index of the low refractive index layer and the refractive index of the high refractive index layer. The refractive index of the medium refractive index layer is preferably from 1.55 to 1.80.

Specific examples of the inorganic particle for use in the high refractive index layer and medium refractive index layer include TiO₂, ZrO₂, Al₂O₃, In₂O₃, ZnO, SnO₂, Sb₂O₃, ITO and SiO₂. TiO₂ and ZrO₂ are preferred in view of elevating the refractive index. It is also preferred to subject the surface of the inorganic filler to a silane coupling treatment or a titanium coupling treatment. A surface treating agent having a functional group capable of reacting with the binder species on the filler surface is preferably used.

The content of the inorganic particle in the high refractive index layer is preferably from 10 to 90 mass %, more preferably from 15 to 80 mass %, still more preferably from 15 to 75 mass %, based on the mass of the high refractive index layer. Two or more kinds of inorganic particles may be used in combination in the high refractive index layer.

In the case of having a low refractive index layer on the high refractive index layer, the refractive index of the high refractive index layer is preferably higher than the refractive index of the transparent support.

In the high refractive index layer, a binder obtained by a crosslinking or polymerization reaction of an aromatic ring-containing ionizing radiation-curable compound, an ionizing radiation-curable compound containing a halogen element (e.g., Br, I, Cl) except for fluorine, an ionizing radiation-curable compound containing an atom such as S, N and P, or the like may also be preferably used.

The film thickness of the high refractive index layer may be appropriately designed according to the usage. In the case of using the high refractive index layer as an optical interference layer described later, the film thickness is preferably from 30 to 200 nm, more preferably from 50 to 170 nm, still more preferably from 60 to 150 nm.

In the case of not containing a particle imparting an antiglare function, the haze of the high refractive index layer is preferably as low as possible. The haze is preferably 5% or less, more preferably 3% or less, still more preferably 1% or less. The high refractive index layer is preferably formed on the transparent support directly or through another layer.

### (D) Low Refractive Index Layer

A low refractive index layer is preferably used for reducing the reflectance of the film of the present invention.

The refractive index of the low refractive index layer is preferably from 1.20 to 1.46, more preferably from 1.25 to 1.46, still more preferably from 1.30 to 1.40.

The thickness of the low refractive index layer is preferably from 50 to 200 nm, more preferably from 70 to 100 nm. The haze of the low refractive index layer is preferably 3% or less, more preferably 2% or less, and most preferably 1% or less. The strength of the low refractive index layer is specifically, in the pencil hardness test with a load of 500 g, preferably H or more, more preferably 2H or more, and most preferably 3H or more.

Also, in order to improve the antifouling performance of the optical film, the contact angle for water on the surface is preferably 90° or more, more preferably 95° or more, still more preferably 100° or more.

The preferred embodiment of the composition for the cured product includes (1) a composition containing a fluorine-containing polymer having a crosslinking or polymerizable functional group, (2) a composition mainly comprising a hydrolysis condensate of a fluorine-containing organosilane material, and (3) a composition containing a monomer having two or more ethylenically unsaturated groups and an inorganic fine particle having a hollow structure.

### (1) Fluorine-Containing Compound Having Crosslinking or Polymerizable Functional Group

The fluorine-containing compound having a crosslinking or polymerizable functional group includes a copolymer of a fluorine-containing monomer with a monomer having a crosslinking or polymerizable functional group. Examples of the fluorine-containing monomer include fluoroolefins (e.g., fluoroethylene, vinylidene fluoride, tetrafluoroethylene, hexafluoroethylene, hexafluoropropylene, perfluoro-2,2-dimethyl-1,3-dioxol), partially or completely fluorinated alkyl ester derivatives of (meth)acrylic acid (e.g., Viscoat 6FM (produced by Osaka Organic Chemical Industry Ltd.), M-2020 (produced by Daikin Industries, Ltd.)), and completely or partially fluorinated vinyl ethers.

One embodiment of the monomer for imparting a crosslinking group is a (meth)acrylate monomer previously having a crosslinking functional group in the molecule, such as glycidyl methacrylate. Another embodiment is a method where a fluorine-containing copolymer is synthesized using a monomer having a functional group such as hydroxyl group and thereafter, a monomer for modifying the substituent to introduce a crosslinking or polymerizable functional group is further used. Examples of the monomer include a (meth)acrylate monomer having a carboxyl group, a hydroxyl group, an amino group, a sulfonic acid group or the like (for example, a (meth)acrylic acid, a methylol (meth)acrylate, a hydroxylalkyl(meth)acrylate and an allyl acrylate). The latter embodiment is disclosed in JP-A-10-25388 and JP-A-10-147739.

The fluorine-containing copolymer may appropriately contain a copolymerizable component in view of solubility, dispersibility, coatability, antifouling property and antistatic property. Particularly, for imparting antifouling property•slipperiness, silicone is preferably introduced and this may be introduced into the main chain and the side chain.

Examples of the method for introducing a polysiloxane partial structure into the main chain include a method using a polymer-type initiator such as azo group-containing polysiloxane amide (as the commercial product, VPS-0501 and VPS-1001 (trade names), produced by Wako Pure Chemicals Industries, Ltd.) described in JP-A-6-93100. Examples of the method for introducing it into the side chain include a method of introducing a polysiloxane having a reactive group at one terminal (for example, Silaplane Series (produced by Chisso Corp.)) by a polymer reaction described in J. Appl. Polym. Sci., Vol. 2000, page 78 (1955) and JP-A-56-28219; and a method of polymerizing a polysiloxane-containing silicon macromer.

With the polymer above, as described in JP-A-2000-17028, a curing agent having a polymerizable unsaturated group may be appropriately used in combination. Also, combination use with a compound having a fluorine-containing polyfunctional polymerizable unsaturated group described in JP-A-2002-145952 is preferred. Examples of the compound having a polyfunctional polymerizable unsaturated group include the above-described monomer having two or more ethylenically unsaturated groups. A hydrolysis condensate of organosilane described in JP-A-2004-170901 is also preferred, and a hydrolysis condensate of organosilane containing a (meth)acryloyl group is more preferred.

These compounds are preferred particularly when a compound having a polymerizable unsaturated group is used for the polymer body, because the combination use is greatly effective for the improvement of scratch resistance.

In the case where the polymer itself does not have sufficiently high curability by itself, necessary curability can be imparted by blending a crosslinking compound. For example, when the polymer body contains a hydroxyl group, various amino compounds are preferably used as the curing agent. The amino group used as the crosslinking group is a compound containing two or more in total of either one or both of a hydroxylalkylamino group and an alkoxyalkylamino group, and specific examples thereof include a melamine-based compound, a urea-based compound, a benzoguanamine-based compound and a glycoluril-based compound. For the curing of such a compound, an organic acid or a salt thereof is preferably used.

Specific examples of such a fluorine-containing polymer are described in JP-A-2003-222702 and JP-A-2003-183322.

### (2) Hydrolysis Condensate of Fluorine-Containing Organosilane Material

The composition mainly comprising a hydrolysis condensate of a fluorine-containing organosilane compound is also preferred because of low refractive index and high hardness of the film coating surface. A condensate of a compound containing a hydrolyzable silanol at one terminal or both terminals with respect to the fluorinated alkyl group and a tetraalkoxysilane is preferred. Specific examples of the composition are described in JP-A-2002-265866 and Japanese Patent 317,152.

### (3) Composition Containing Monomer Having Two or More Ethylenically Unsaturated Groups and Inorganic Fine Particle Having Hollow Structure

A still another preferred embodiment is a low refractive index layer comprising a low refractive index particle and a binder. The low refractive index particle may be either organic or inorganic, but a particle having a cavity in the inside thereof is preferred. Specific examples of the hollow particle include those described for the silica-based particle in JP-A-2002-79616. The refractive index of the particle is preferably from 1.15 to 1.40, more preferably from 1.20 to 1.30. The binder includes the monomer having two or more ethylenically unsaturated groups in the paragraph of the above-mentioned light-scattering layer. In the low refractive index layer for use in the present invention, a polymerization initiator described above in the paragraph of Antireflection Film is preferably added. In the case of containing a radical polymerizable compound, the polymerization initiator can be used in an amount of 1 to 10 parts by mass, preferably from 1 to 5 parts by mass, based on the compound.

In the low refractive index layer for use in the present invention, an inorganic particle can be used in combination. In order to impart scratch resistance, it is preferred to use a fine particle having a particle diameter corresponding to from 15 to 150%, preferably from 30 to 100%, more preferably from 45 to 60%, of the thickness of the low refractive index layer.

In the low refractive index layer for use in the present invention, a known polysiloxane-based or fluorine-based antifouling agent, slipping agent or the like may be appropriately added for the purpose of imparting properties such as antifouling property, water resistance, chemical resistance and slipperiness.

### (E) Antistatic Layer

In the present invention, an antistatic layer is preferably provided from the standpoint of preventing electrostatic charge on the film surface. Examples of the method for forming the antistatic layer include conventionally known methods such as a method of coating an electrically conductive coating solution containing an electrically conductive fine particle and a reactive curable resin, and a method of vapor-depositing or sputtering a transparent film-forming metal or metal oxide or the like to form an electrically conductive thin film. The electrically conductive layer may be formed on the support directly or through a primer layer strengthening the adhesion to the support. Also, the antistatic layer may be used as a part of the antireflection film. In this case, when the antistatic layer is used as a layer closer to the outermost surface layer, sufficiently high antistatic property can be obtained even if the layer thickness is small.

The thickness of the antistatic layer is preferably from 0.01 to 10 μm, more preferably from 0.03 to 7 μm, still more preferably from 0.05 to 5 μm. The surface resistance of the antistatic layer is preferably from 10⁵ to 10¹² Ω/sq, more preferably from 10⁵ to 10⁹ Ω/sq, and most preferably from 10⁵ to 10⁸ Ω/sq. The surface resistance of the antistatic layer may be measured by a four-probe method.

It is preferred that the antistatic layer is substantially transparent. Specifically, the haze of the antistatic layer is preferably 10% or less, more preferably 5% or less, still more preferably 3% or less, and most preferably 1% or less. The transmittance for light at a wavelength of 550 nm is preferably 50% or more, more preferably 60% or more, still more preferably 65% or more, and most preferably 70% or more.

The antistatic layer for use in the present invention has excellent strength. Specifically, the strength of the antistatic layer is, in terms of the pencil hardness with a load of 1 kg, preferably H or more, more preferably 2H or more, still more preferably 3H or more, and most preferably 4H or more.

### [Coating Solvent]

Out of these constituent layers, the layer coated in adjacency to the substrate film preferably contains at least one or more kinds of solvents capable of dissolving the substrate film and at least one or more kinds of solvents incapable of dissolving the substrate film. By virtue of such an embodiment, excessive penetration of the adjacent layer component into the substrate film can be prevented and at the same time, the adhesion between the adjacent layer and the substrate film can be ensured. Furthermore, at least one species out of the solvents capable of dissolving the substrate film preferably has a boiling point higher than the boiling point of at least one species out of the solvents incapable of dissolving the substrate film. The difference in the boiling point between a solvent having a highest boiling point out of the solvents capable of dissolving the substrate film and a solvent having a highest boiling point out of the solvents incapable of dissolving the substrate is more preferably 30° C. or more, and most preferably 40° C. or more.

The mass ratio (A/B) between the total amount (A) of the solvents capable of dissolving the transparent substrate film and the total amount (B) of the solvents incapable of dissolving the transparent substrate film is preferably from 5/95 to 50/50, more preferably from 10/90 to 40/60, still more preferably from 15/85 to 30/70.

### [Liquid Crystal Display Device]

The liquid crystal display device of the present invention comprises either the cellulose acylate film of the present invention or the polarizing plate of the present invention. A liquid crystal display device using a pair of electrodes, one on the top of the liquid crystal cell and another on the bottom of the liquid crystal cell, is preferred. It is also preferred that at least one protective film of the polarizing plate is the above-described protective film, that is, the cellulose acylate film. Furthermore, an embodiment where at least one layer out of a hardcoat layer, an antiglare layer and an antireflection layer is provided on one protective film is also preferred. By virtue of such a construction, a lightweight and thin liquid crystal display device can be obtained.

Examples of the liquid crystal cell which can be fabricated into a liquid crystal display device by using the polarizing plate of the present invention are set forth below.

The polarizing plate of the present invention can be used for liquid crystal cells in various display modes. The display mode includes various display modes such as TN (twisted nematic), IPS (in-plane switching), FLC (ferroelectric liquid crystal), AFLC (anti-ferroelectric liquid crystal), OCB (optically compensatory bend), STN (super twisted nematic), VA (vertically aligned) and HAN (hybrid aligned nematic). Among these display modes, the polarizing plate is preferably used for the VA mode and the OCB mode, more preferably for the VA mode.

In the VA-mode liquid crystal cell, rod-like liquid crystalline molecules are oriented substantially in the vertical alignment at the time of not applying a voltage.

The VA mode liquid crystal cell includes (1) a VA-mode liquid crystal cell in a narrow sense where rod-shaped liquid crystalline molecules are oriented substantially in the vertical alignment at the time of not applying a voltage and oriented substantially in the horizontal alignment at the time of applying a voltage (described in JP-A-2-176625), (2) an (MVA-mode) liquid crystal cell where the VA mode is modified to be multi-domain type by projections so as to enlarge the viewing angle {described in SID97, Digest of tech. Papers, (preprints), 28, p. 845 (1997)}, (3) an (n-ASM-mode or CPA-mode) liquid crystal where rod-like liquid crystalline molecules are oriented substantially in the vertical alignment at the time of not applying a voltage and oriented in the twisted multi-domain alignment at the time of applying a voltage {described in Sharp Technical Report, No. 80, page 11}, (4) a SURVAIVAL-mode liquid crystal cell where molecules are oriented in the multi-domain alignment by an oblique electric field {Gekkan Display (Monthly Display), May, page 14 (1999)}, and a PVA-mode liquid crystal cell {18th, IDRC Proceedings, page 383 (1998)}.

The VA-mode liquid crystal display device includes a liquid crystal display device comprising, as shown in FIG. 3, a liquid crystal cell (VA-mode cell) and two polarizing plates disposed on both sides thereof (a polarizing plate comprising TAC1, a polarizer and TAC2). The liquid crystal cell carries a liquid crystal between two electrode substrates, though not particularly shown.

In one embodiment of the transmissive liquid crystal display device of the present invention, the cellulose acylate film of the present invention is used as an optical compensation sheet, and one sheet is disposed between the liquid crystal cell and one polarizing plate, or two sheets are disposed, that is, one between the liquid crystal cell and one polarizing plate, and another between the liquid crystal cell and another polarizing plate.

In another embodiment of the transmissive liquid crystal display device of the present invention, the cellulose acylate film is used as a protective film of the polarizing plate disposed between the liquid crystal cell and the polarizer. The cellulose acylate film may be used for the protective film between the liquid crystal cell and the polarizer only in one polarizing plate, or the cellulose acylate film may be used for two protective films each between the liquid crystal cell and the polarizer in both polarizing plates. When laminating to the liquid crystal cell, the cellulose acylate film (TAC1) of the present invention is preferably arranged to lie on the VA cell side. In the case of using the cellulose acylate film for the protective film between the liquid crystal cell and the polarizer only in one polarizing plate, the polarizing plate may be either the upper polarizing plate (observer side) or the lower polarizing plate (light source side, backlight side), and there is no problem in view of function. However, when the polarizing plate used as the upper polarizing plate, a functional film needs to be provided on the observer side (top side) and the production yield may decrease. Therefore, use as the lower polarizing plate is considered to favor a higher yield and be a more preferred embodiment.

A liquid crystal display device where the polarizing plates on both the light source side and the observer side of FIG. 3 are formed by the polarizing plate of the present invention is the liquid crystal display device of the second embodiment, and a liquid crystal display device where only the polarizing plate on the light source side is formed by the polarizing plate of the present invention is the liquid crystal display device of the third embodiment.

The protective film (TAC2) in FIG. 3 may be a normal cellulose acylate film, and the film thickness thereof is preferably equal to or smaller than the thickness of the cellulose acylate film of the present invention and is preferably, for example, from 40 to 80 μm. Examples thereof include, but are not limited to, commercially available KC4UX2M (40 μm, produced by Konica Opto Corp.), KC5UX (60 μm, produced by Konica Opto Corp.) and TD80 (80 μm, produced by Fuji Photo Film Co., Ltd.).

### EXAMPLES

The present invention is described in greater detail below by referring to Examples, but the present invention is limited to these Examples.

### Example 1

### Production of Cellose Acylate Film

### (Cellulose Acylate)

Cellulose acylates differing in the kind of acyl group and the acyl substitution degree, shown in Table 1, were prepared. These cellulose acylates were obtained by adding a sulfuric acid (7.8 parts by mass per 100 parts by mass of cellulose) as a catalyst, adding a carboxylic acid working out to a raw material of the acyl substituent, and performing an acylation reaction at 40° C. Thereafter, the total substitution degree was adjusted by adjusting the amount of the sulfuric acid catalyst, the amount of water, and the ripening time. The ripening was performed at a temperature of 40° C. Furthermore, the low molecular weight components of the cellulose acylate were removed by the washing with acetone.

### (Preparing Cellulose Acylate Solution)

The cellulose acylate composition shown below was charged into a mixing tank and stirred to dissolve respective components, and the resulting solution was heated at 90° C. for about 10 minutes and then filtered through filter paper having an average pore size of 34 μm and further through a sintered metal filter having an average pore size of 10 μm to prepare a cellulose acylate solution.

### (Composition of Cellose Acylate Solution)

| | | |
|---|---|---|
| Cellulose acylate shown in Table 1 | 100.0 | parts by mass |
| Triphenyl phosphate | 7.8 | parts by mass |
| Biphenyl diphenyl phosphate | 3.9 | parts by mass |
| Methylene chloride | 313.0 | parts by mass |
| Methanol | 47.0 | parts by mass |

### (Preparing Matting Agent Liquid Dispersion)

The following composition of matting agent liquid dispersion containing the cellulose acylate solution prepared above was charged into a disperser to prepare a matting agent liquid dispersion.

### (Composition of Matting Agent Liquid Dispersion)

| | |
|---|---|
| Silica particle having an average particle | 2.0 parts by mass |
| diameter of 16 nm (aerosil R972, produced by | |
| Nihon Aerosil Co., Ltd.) | |
| Methylene chloride | 72.4 parts by mass |
| Methanol | 10.8 parts by mass |
| Cellulose acylate solution | 10.3 parts by mass |

### (Preparing Retardation Developer Solution)

The following composition of Retardation Developer Solution A containing the cellulose acylate solution prepared above was charged into a mixing tank and dissolved with stirring under heat to prepare Retardation Developer Solution A.

### (Composition of Retardation Developer Solution A)

| | |
|---|---|
| Retardation Developer A | 20.0 parts by mass |
| Methylene chloride | 58.3 parts by mass |
| Methanol | 8.7 parts by mass |
| Cellulose acylate solution | 12.8 parts by mass |

Retardation Developer A:

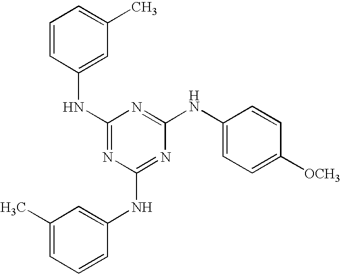

100 Parts by mass of the cellulose acylate solution, 1.35 parts by mass of the matting agent liquid dispersion, 11.7 parts by mass (in Tables 1 to 4) of a plasticizer, and 6 parts by mass (in Tables 3 and 4) of Retardation Developer Solution A were mixed to prepare a dope for film formation. This dope was used for the production of films of Samples 101 to 109, 011 to 014, 201 to 209, 021 to 024, 301 to 309, 031 to 034, 401 to 409, and 041 to 044. The 6% addition of the retardation developer shown in Tables 3 and 4 indicates the parts by mass of the retardation developer assuming that the amount of the cellulose acylate is 100 parts by mass.

Incidentally, in the Tables, CAP stands for cellulose acetate propionate (a cellulose ester derivative where the acyl group comprises an acetate group and a propionyl group).

### (Casting Film Formation)

The dope prepared above was cast using a band casting machine. The film forming was performed with a cast width of 2,000 mm, and the film with a residual solvent amount of 50 to 90 mass % separated from the band was stretched in the width direction at a stretch ratio of 0 to 40% by using a tenter under the condition of a stretching temperature in the range from about −10 to +30° C. with respect to Tg to produce a cellulose acylate film (thickness: 80 or 40 μm, Samples 101 to 109, 011 to 014, 201 to 209, 021 to 024, 301 to 309, 031 to 034, 401 to 409, and 041 to 044). The stretch ratio of the tenter is shown in Tables 1 to 4, and the stretch ratio of 0% means unstretching. Incidentally, the tenter stretching was performed in a state of the film having a residual solvent amount of 10 to 20 mass %.

### (Film Evaluation)

—Measurement of PV value of Film Thickness—

The PV value (difference between a highest point (peak) and a lowest point (valley)) of the film thickness was measured using FUINON Laser Interferometer FX-03 manufactured by Fujinon Corporation. At this time, the measurement area was in the diameter range of φ=60 mm, and the average value when measured 10 times was calculated.

### —Standard Deviation of Slow Axis Angle Variation—

The slow axis angle variation was measured by an automatic birefringence meter (KOBRA 21DH, manufactured by Oji Test Instruments). The slow axis angle was measured at equally-spaced 13 points over the entire width in the width direction (the sample at one point was in a size of 70 mm×100 mm), and the difference between the maximum value and the minimum value of the angles is taken as the variation in slow axis angle.

Furthermore, the slow axis angle variation was measured for a portion of 100 points at 1-m intervals (100-m portion) in the longitudinal direction and after calculating the average value of the slow axis angle variation, the standard deviation of the slow axis angle variation was determined

### —Optical Unevenness—

The cellulose acylate film was sandwiched between polarizing plates in cross-Nicol arrangement, and the optical unevenness was observed with an eye by 5 evaluators and classified into the following levels of rating.

⊚: Optical unevenness is not observed, and best level.

◯: Weak optical unevenness is slightly observed, but good level.

Δ: Optical unevenness is slightly observed, but practically allowable level.

X: Optical unevenness is observed, and practically unallowable level.

TABLE 1
Physical Properties of Unstretched Film (mixed fatty acid ester); no Re adjusting agent

| | | | | | | | | | | Optical Characteristics of Film | | | | | |
|---|---|---|---|---|---|---|---|---|---|---|---|---|---|---|---|
| | | | | | | | | | | | | | Standard | | |
| | | | | Pr Group | | | | Film | PV | | | | Deviation | | |
| | | Ac Group | | | | Total | | Thick- | Value | | | | of | | |
| | | | Substi- | | Substi- | Substi- | | ness | of Film | | | | Slow Axis | Optical | |
| Sam- | Kind | | tution | | tution | tution | Stretch | after | Thick- | | | Slow | Angle | Une- | |
| ple | of | | Degree | | Degree | Degree | Ratio | Drying | ness | Re | Rth | Axis | Variation | ven- | |
| No. | Cotton | Kind | A | Kind | B | A + B | [%] | [μm] | [μm] | [nm] | [nm] | Angle [°] | [°] | ness | Remarks |
| 101 | CAP | Ac | 1.30 | Pr | 1.10 | 2.40 | 0 | 80 | 0.60 | 3 | 143 | 0.4 | 0.6 | ◯ | Invention |
| 102 | ″ | ″ | 1.00 | ″ | 1.40 | 2.40 | 0 | 80 | 0.40 | 2 | 126 | 0.4 | 0.3 | ⊚ | Invention |
| 103 | ″ | ″ | 0.70 | ″ | 1.70 | 2.40 | 0 | 80 | 0.50 | 3 | 108 | 0.3 | 0.3 | ⊚ | Invention |
| 104 | ″ | ″ | 0.40 | ″ | 2.00 | 2.40 | 0 | 80 | 0.50 | 4 | 90 | 0.3 | 0.3 | ⊚ | Invention |
| 011 | ″ | ″ | 1.60 | ″ | 0.80 | 2.40 | 0 | 80 | 1.30 | 3 | 161 | 1.3 | 1.4 | X | Compar- |
| | | | | | | | | | | | | | | | ison |
| 012 | ″ | ″ | 0.10 | ″ | 2.30 | 2.40 | 0 | 80 | 1.50 | 3 | 72 | 1.2 | 1.7 | X | Compar- |
| | | | | | | | | | | | | | | | ison |
| 105 | ″ | ″ | 1.30 | ″ | 1.40 | 2.70 | 0 | 80 | 0.30 | 2 | 53 | 0.3 | 0.6 | ◯ | Invention |
| 106 | ″ | ″ | 0.40 | ″ | 2.30 | 2.70 | 0 | 80 | 0.40 | 3 | 28 | 0.3 | 0.2 | ⊚ | Invention |
| 107 | ″ | ″ | 1.30 | ″ | 0.80 | 2.10 | 0 | 80 | 0.50 | 5 | 252 | 0.2 | 0.3 | ⊚ | Invention |
| 108 | ″ | ″ | 0.70 | ″ | 1.40 | 2.10 | 0 | 80 | 0.50 | 5 | 198 | 0.4 | 0.3 | ⊚ | Invention |
| 109 | ″ | ″ | 0.40 | ″ | 1.70 | 2.10 | 0 | 80 | 0.40 | 4 | 171 | 0.6 | 0.3 | ⊚ | Invention |
| 013 | ″ | ″ | 1.30 | ″ | 0.50 | 1.80 | 0 | 80 | 1.60 | 5 | 380 | 1.1 | 1.5 | X | Compar- |
| | | | | | | | | | | | | | | | ison |
| 014 | ″ | ″ | 0.30 | ″ | 2.65 | 2.95 | 0 | 80 | 1.80 | 1 | −2 | 2.2 | 20 | X | Compar- |
| | | | | | | | | | | | | | | | ison |

*1: A 2/1 (parts by mass) mixture of TPP (triphenyl phosphate) and BDP (biphenyl diphenyl phosphate).

TABLE 2
Physical Properties of Stretched Film (mixed fatty acid ester); no Re adjusting agent

| | | | | | | | | | | Optical Characteristics of Film | | | | | |
|---|---|---|---|---|---|---|---|---|---|---|---|---|---|---|---|
| | | | | | | | | | | | | | Standard | | |
| | | | | Pr Group | | | | Film | PV | | | | Deviation | | |
| | | Ac Group | | | | Total | | Thick- | Value | | | | of | | |
| | | | Substi- | | Substi- | Substi- | | ness | of Film | | | | Slow Axis | Optical | |
| Sam- | Kind | | tution | | tution | tution | Stretch | after | Thick- | | | Slow | Angle | Une- | |
| ple | of | | Degree | | Degree | Degree | Ratio | Drying | ness | Re | Rth | Axis | Variation | ven- | |
| No. | Cotton | Kind | A | Kind | B | A + B | [%] | [μm] | [μm] | [nm] | [nm] | Angle [°] | [°] | ness | Remarks |
| 201 | CAP | Ac | 1.30 | Pr | 1.10 | 2.40 | 30 | 80 | 0.60 | 30 | 181 | 0.3 | 0.5 | ◯ | Invention |
| 202 | ″ | ″ | 1.00 | ″ | 1.40 | 2.40 | 30 | 80 | 0.40 | 26 | 164 | 0.3 | 0.3 | ⊚ | Invention |
| 203 | ″ | ″ | 0.70 | ″ | 1.70 | 2.40 | 30 | 80 | 0.50 | 17 | 146 | 0.2 | 0.3 | ⊚ | Invention |
| 204 | ″ | ″ | 0.40 | ″ | 2.00 | 2.40 | 30 | 80 | 0.50 | 10 | 128 | 0.3 | 0.3 | ⊚ | Invention |
| 021 | ″ | ″ | 1.60 | ″ | 0.80 | 2.40 | 30 | 80 | 1.30 | 50 | 200 | 1.2 | 1.5 | X | Compar- |
| | | | | | | | | | | | | | | | ison |
| 022 | ″ | ″ | 0.10 | ″ | 2.30 | 2.40 | 30 | 80 | 1.50 | 20 | 110 | 1.2 | 1.6 | X | Compar- |
| | | | | | | | | | | | | | | | ison |
| 205 | ″ | ″ | 1.30 | ″ | 1.40 | 2.70 | 30 | 80 | 0.30 | 23 | 91 | 0.2 | 0.6 | ◯ | Invention |
| 206 | ″ | ″ | 0.40 | ″ | 2.30 | 2.70 | 30 | 80 | 0.40 | 20 | 66 | 0.3 | 0.2 | ⊚ | Invention |
| 207 | ″ | ″ | 1.30 | ″ | 0.80 | 2.10 | 30 | 80 | 0.50 | 79 | 290 | 0.2 | 0.3 | ⊚ | Invention |
| 208 | ″ | ″ | 0.70 | ″ | 1.40 | 2.10 | 30 | 80 | 0.50 | 56 | 236 | 0.4 | 0.4 | ⊚ | Invention |
| 209 | ″ | ″ | 0.40 | ″ | 1.70 | 2.10 | 35 | 80 | 0.40 | 44 | 209 | 0.6 | 0.4 | ⊚ | Invention |
| 023 | ″ | ″ | 1.30 | ″ | 0.50 | 1.80 | 30 | 80 | 1.60 | 130 | 418 | 1.0 | 1.4 | X | Compar- |
| | | | | | | | | | | | | | | | ison |
| 024 | ″ | ″ | 0.30 | ″ | 2.65 | 2.95 | 30 | 80 | 1.80 | −20 | 21 | 1.8 | 12.0 | X | Compar- |
| | | | | | | | | | | | | | | | ison |

*1: A 2/1 (parts by mass) mixture of TPP (triphenyl phosphate) and BDP (biphenyl diphenyl phosphate).

TABLE 3
Physical Properties of Stretched Film (mixed fatty acid ester); Re adjusting agent was added (6% addition)

| | | | | | | | | | | Optical Characteristics of Film | | | | | |
|---|---|---|---|---|---|---|---|---|---|---|---|---|---|---|---|
| | | | | | | | | | | | | | Standard | | |
| | | | | Pr Group | | | | Film | PV | | | | Deviation | | |
| | | Ac Group | | | | Total | | Thick- | Value | | | | of | | |
| | | | Substi- | | Substi- | Substi- | | ness | of Film | | | | Slow Axis | Optical | |
| Sam- | Kind | | tution | | tution | tution | Stretch | after | Thick- | | | Slow | Angle | Une- | |
| ple | of | | Degree | | Degree | Degree | Ratio | Drying | ness | Re | Rth | Axis | Variation | ven- | |
| No. | Cotton | Kind | A | Kind | B | A + B | [%] | [μm] | [μm] | [nm] | [nm] | Angle [°] | [°] | ness | Remarks |
| 301 | CAP | Ac | 1.30 | Pr | 1.10 | 2.40 | 30 | 80 | 0.60 | 60 | 260 | 0.4 | 0.6 | ◯ | Invention |
| 302 | ″ | ″ | 1.00 | ″ | 1.40 | 2.40 | 30 | 80 | 0.40 | 56 | 240 | 0.3 | 0.3 | ⊚ | Invention |
| 303 | ″ | ″ | 0.70 | ″ | 1.70 | 2.40 | 30 | 80 | 0.50 | 47 | 220 | 0.3 | 0.4 | ⊚ | Invention |
| 304 | ″ | ″ | 0.40 | ″ | 2.00 | 2.40 | 30 | 80 | 0.50 | 40 | 200 | 0.3 | 0.3 | ⊚ | Invention |
| 031 | ″ | ″ | 1.60 | ″ | 0.80 | 2.40 | 30 | 80 | 1.30 | 80 | 276 | 1.2 | 1.3 | X | Compar- |
| | | | | | | | | | | | | | | | ison |
| 032 | ″ | ″ | 0.10 | ″ | 2.30 | 2.40 | 30 | 80 | 1.50 | 53 | 190 | 1.1 | 1.2 | X | Compar- |
| | | | | | | | | | | | | | | | ison |
| 305 | ″ | ″ | 1.30 | ″ | 1.40 | 2.70 | 35 | 80 | 0.30 | 53 | 200 | 0.3 | 0.6 | ◯ | Invention |
| 306 | ″ | ″ | 0.40 | ″ | 2.30 | 2.70 | 30 | 80 | 0.40 | 48 | 142 | 0.4 | 0.3 | ⊚ | Invention |
| 307 | ″ | ″ | 1.30 | ″ | 0.80 | 2.10 | 30 | 80 | 0.50 | 130 | 370 | 0.3 | 0.4 | ⊚ | Invention |
| 308 | ″ | ″ | 0.70 | ″ | 1.40 | 2.10 | 30 | 80 | 0.50 | 80 | 300 | 0.5 | 0.4 | ⊚ | Invention |
| 309 | ″ | ″ | 0.40 | ″ | 1.70 | 2.10 | 30 | 80 | 0.40 | 70 | 276 | 0.4 | 0.4 | ⊚ | Invention |
| 033 | ″ | ″ | 1.30 | ″ | 0.50 | 1.80 | 30 | 80 | 1.60 | 180 | 503 | 1.3 | 1.3 | X | Compar- |
| | | | | | | | | | | | | | | | ison |
| 034 | ″ | ″ | 0.30 | ″ | 2.65 | 2.95 | 30 | 80 | 1.80 | 0 | 100 | 1.9 | 13.0 | X | Compar- |
| | | | | | | | | | | | | | | | ison |

*1: A 2/1 (parts by mass) mixture of TPP (triphenyl phosphate) and BDP (biphenyl diphenyl phosphate).

TABLE 4
Physical Properties of Stretched Film (mixed fatty acid ester); Re adjusting agent was added (6% addition)

| | | | | | | | | | | Optical Characteristics of Film | | | | | |
|---|---|---|---|---|---|---|---|---|---|---|---|---|---|---|---|
| | | | | | | | | | | | | | Standard | | |
| | | | | Pr Group | | | | Film | PV | | | | Deviation | | |
| | | Ac Group | | | | Total | | Thick- | Value | | | | of | | |
| | | | Substi- | | Substi- | Substi- | | ness | of Film | | | | Slow Axis | Optical | |
| Sam- | Kind | | tution | | tution | tution | Stretch | after | Thick- | | | Slow | Angle | Une- | |
| ple | of | | Degree | | Degree | Degree | Ratio | Drying | ness | Re | Rth | Axis | Variation | ven- | |
| No. | Cotton | Kind | A | Kind | B | A + B | [%] | [μm] | [μm] | [nm] | [nm] | Angle [°] | [°] | ness | Remarks |
| 401 | CAP | Ac | 1.30 | Pr | 1.10 | 2.40 | 35 | 40 | 0.60 | 55 | 130 | 0.4 | 0.5 | ◯ | Invention |
| 402 | ″ | ″ | 1.00 | ″ | 1.40 | 2.40 | 35 | 40 | 0.40 | 52 | 125 | 0.3 | 0.4 | ⊚ | Invention |
| 403 | ″ | ″ | 0.70 | ″ | 1.70 | 2.40 | 35 | 40 | 0.50 | 47 | 120 | 0.4 | 0.3 | ⊚ | Invention |
| 404 | ″ | ″ | 0.40 | ″ | 2.00 | 2.40 | 37 | 40 | 0.50 | 40 | 115 | 0.3 | 0.3 | ⊚ | Invention |
| 041 | ″ | ″ | 1.60 | ″ | 0.80 | 2.40 | 30 | 40 | 1.30 | 40 | 140 | 1.4 | 1.2 | X | Compar- |
| | | | | | | | | | | | | | | | ison |
| 042 | ″ | ″ | 0.10 | ″ | 2.30 | 2.40 | 30 | 40 | 1.50 | 30 | 100 | 1.2 | 1.1 | X | Compar- |
| | | | | | | | | | | | | | | | ison |
| 405 | ″ | ″ | 1.30 | ″ | 1.40 | 2.70 | 30 | 40 | 0.30 | 42 | 110 | 0.2 | 0.6 | ◯ | Invention |
| 406 | ″ | ″ | 0.40 | ″ | 2.30 | 2.70 | 30 | 40 | 0.40 | 48 | 92 | 0.3 | 0.3 | ⊚ | Invention |
| 407 | ″ | ″ | 1.30 | ″ | 0.80 | 2.10 | 30 | 40 | 0.50 | 50 | 170 | 0.3 | 0.3 | ⊚ | Invention |
| 408 | ″ | ″ | 0.70 | ″ | 1.40 | 2.10 | 30 | 40 | 0.50 | 42 | 150 | 0.4 | 0.4 | ⊚ | Invention |
| 409 | ″ | ″ | 0.40 | ″ | 1.70 | 2.10 | 30 | 40 | 0.40 | 40 | 120 | 0.3 | 0.3 | ⊚ | Invention |
| 043 | ″ | ″ | 1.30 | ″ | 0.50 | 1.80 | 30 | 40 | 1.60 | 70 | 220 | 1.4 | 1.4 | X | Compar- |
| | | | | | | | | | | | | | | | ison |
| 044 | ″ | ″ | 0.30 | ″ | 2.65 | 2.95 | 30 | 40 | 1.80 | 0 | 50 | 2.1 | 13.5 | X | Compar- |
| | | | | | | | | | | | | | | | ison |

*1: A 2/1 (parts by mass) mixture of TPP (triphenyl phosphate) and BDP (biphenyl diphenyl phosphate).

In Table 1, as seen from the comparison of Samples 101 to 104 where the total substitution degree is constant, Rth decreases when the propionyl substitution degree is increased. This is considered because the increase of a bulky propionyl group brings about an increase of free volume and an increase of non-crystallinity, as a result, Rth is decreased. The same tendency is seen from the comparison of Samples 105 and 106 and the comparison of Samples 107 to 109.

When the process of the dope being dried was orthoscopically observed through a polarizing microscope, in Samples 102 to 104 and 106 to 109 of the present invention, the thickness of the surface skin layer was from 10 to 50 μm and was very small for the total thickness of 400 μm immediately after casting, the drying uniformly proceeded in the thickness direction to cause no axial deviation, and the degree of generation of optical unevenness was extremely low. In Samples 101 and 105 of the present invention, the thickness of the skin layer observed through a polarizing microscope was from 60 to 70 μm, revealing that the standard deviation of the slow axis angle variation was large, and the performance in view of optical unevenness was good but in a level where unevenness was slightly observed. In Comparative Samples 011 to 014, the skin layer was formed to a large thickness of 120 to 200 μm, the drying did not proceed throughout the thickness, an axial deviation was generated due to formation of the skin layer, the standard deviation of the slow axis angle variation was very large as 1.4 to 20°, and the optical unevenness was seriously generated and highly visible.

The PV value of film thickness and the standard deviation of slow axis angle variation were respectively 1 μm or more and 1° or more in Comparative Samples 011 to 014, whereas in all samples of the present invention, these were respectively 1 μm or less and 1° or less and the performance in terms of optical unevenness was also good.

In Table 2, the film of Table 1 was stretched, and in Tables 3 and 4, a retardation adjusting agent was added. The same tendency as in Table 1 applies to the samples of Tables 2 to 4. More specifically, from the comparison of Samples 201 to 204, 301 to 304, and 401 to 404, where the total substitution degree is constant, the Rth are decreased with increasing the propionyl substitution degree. This is also seen in the comparison of Samples 205 and 206, 305 and 306, 405 and 406, 207 to 209, 307 to 309, and 407 to 409. Also, in samples where a retardation adjusting agent is added, the Re and Rth developability is high and the haze tends to be slightly increased.

### (Preparation of Dope Solution D202)

| | | |
|---|---|---|
| Cellulose acetate propionate (composition is | 100 | parts by mass |
| shown in Table 5) | | |
| Triphenyl phosphate | 8 | parts by mass |
| Ethyl phthalyl ethyl glycolate | 2 | parts by mass |
| Methylene chloride | 300 | parts by mass |
| Ethanol | 60 | parts by mass |

These components were charged into a closed vessel and completely dissolved with stirring under heat, and the resulting solution was filtered by using Azumi Roshi No. 24 produced by Azumi Filter Paper Co., Ltd. to prepare Dope Solution D202. On the film-production line, Dope Solution D202 was filtered through Finemet NF produced by Nippon Seisen Co., Ltd.

### (Preparation of Silicon Dioxide Liquid Dispersion C)

| | |
|---|---|
| Aerosil 972V (produced by Nihon Aerosil | 10 parts by mass |
| Co., Ltd.) (average primary particle diameter: | |
| 16 nm, apparent specific gravity: 90 g/liter) | |
| Ethanol | 75 parts by mass |

These components were mixed with stirring in a dissolver for 30 minutes and then dispersed by Manthon Gaulin. The liquid turbidity after the dispersion was 200 ppm. 75 Parts by mass of methylene chloride was charged into the silicon dioxide liquid dispersion while stirring, and the resulting dispersion was stirred and mixed in a dissolver for 30 minutes to prepare Silicon Dioxide Dilute Liquid Dispersion C.

### (Preparation of In-Line Additive Solution IN201)

| | |
|---|---|
| Methylene chloride | 100 parts by mass |
| Tinuvin 109 (produced by Ciba Specialty | 4 parts by mass |
| Chemicals Corp.) | |
| Tinuvin 171 (produced by Ciba Specialty | 4 parts by mass |
| Chemicals Corp.) | |
| Tinuvin 326 (produced by Ciba Specialty | 2 parts by mass |
| Chemicals Corp.) | |

These components were charged into a closed vessel and completely dissolved with stirring under heat, and the obtained solution was filtered.

To this solution, 20 parts by mass of Silicon Dioxide Dilute Liquid Dispersion C was added with stirring. After further stirring for 30 minutes, 5 parts by mass of cellulose ester (cellulose acetate propionate, acetyl group substitution degree: 1.90, propionyl group substitution degree: 0.80) was added with stirring. The resulting solution was further stirred for 60 minutes and then filtered through a polypropylene wind cartridge filter TCW—PPS-TN produced by Advantec Toyo Kaisha, Ltd. to prepare In-Line Additive Solution IN201.

On the in-line additive solution line. In-Line Additive Solution IN201 was filtered through Finemet NF produced by Nippon Seisen Co., Ltd. After adding 4 parts by mass of filtered In-Line Additive Solution IN201 to 100 parts by mass of filtered Dope Solution D0202, the solutions were thoroughly mixed by an in-line mixer (Toray Static Pipe Mixer Hi-Mixer, SWJ). The resulting solution was uniformly cast on a stainless steel band support to a width of 2,000 mm at a temperature of 35° C. by a belt casting apparatus. The solvent was evaporated on the stainless steel band support until the residual solvent amount became 100%, and the film was separated from the stainless steel band support. The solvent was evaporated at 55° C. from the web of cellulose ester film separated, and the film was slit to a width of 1,650 mm and then stretched by a tenter at 130° C. to 1.33 times in the TD direction (the direction perpendicular to the film conveying direction). The residual solvent amount when stretching was started by a tenter was 18%. The film was further conveyed by many rollers through drying zones of 120° C. and 110° C. to finalize the drying and then slit to a width of 1,400 mm and after knurling both edges of the film to a width of 15 mm and an average height of 10 μm, the film was taken up on a core having an inner diameter of 6 inches at an initial take-up tension of 220 N/m and a final tension of 110 N/m to obtain Cellulose Ester Film. The residual solvent amount of the cellulose ester film was 0.1%, the average film thickness was 80 μm, and the winding number was 2,600 m. Physical results of this cellulose ester film are shown in Table 5.

TABLE 5
Physical Properties of Stretched Film (mixed fatty acid ester); different in additive (plasticizer, ultraviolet
absorbent); no Re adjusting agent

| | | | | | | | | | | Optical Characteristics of Film | | | | | |
|---|---|---|---|---|---|---|---|---|---|---|---|---|---|---|---|
| | | | | | | | | | | | | | Standard | | |
| | | | | Pr Group | | | | Film | PV | | | | Deviation | | |
| | | Ac Group | | | | Total | | Thick- | Value | | | | of | | |
| | | | Substi- | | Substi- | Substi- | | ness | of Film | | | | Slow Axis | Optical | |
| Sam- | Kind | | tution | | tution | tution | Stretch | after | Thick- | | | Slow | Angle | Une- | |
| ple | of | | Degree | | Degree | Degree | Ratio | Drying | ness | Re | Rth | Axis | Variation | ven- | |
| No. | Cotton | Kind | A | Kind | B | A + B | [%] | [μm] | [μm] | [nm] | [nm] | Angle [°] | [°] | ness | Remarks |
| 501 | CAP | Ac | 1.30 | Pr | 1.10 | 2.40 | 35 | 80 | 0.70 | 45 | 150 | 0.3 | 0.5 | ◯ | Invention |
| 502 | ″ | ″ | 1.00 | ″ | 1.40 | 2.40 | 35 | 80 | 0.40 | 43 | 132 | 0.3 | 0.3 | ⊚ | Invention |
| 503 | ″ | ″ | 0.70 | ″ | 1.70 | 2.40 | 35 | 80 | 0.40 | 42 | 120 | 0.2 | 0.3 | ⊚ | Invention |
| 504 | ″ | ″ | 0.40 | ″ | 2.00 | 2.40 | 35 | 80 | 0.30 | 40 | 115 | 0.3 | 0.3 | ⊚ | Invention |
| 051 | ″ | ″ | 1.60 | ″ | 0.80 | 2.40 | 35 | 80 | 1.60 | 50 | 200 | 1.2 | 1.5 | X | Compar- |
| | | | | | | | | | | | | | | | ison |
| 052 | ″ | ″ | 0.10 | ″ | 2.30 | 2.40 | 35 | 80 | 1.70 | 20 | 110 | 1.2 | 1.6 | X | Compar- |
| | | | | | | | | | | | | | | | ison |
| 505 | ″ | ″ | 1.30 | ″ | 1.40 | 2.70 | 35 | 80 | 0.50 | 23 | 91 | 0.2 | 0.6 | ◯ | Invention |
| 506 | ″ | ″ | 0.40 | ″ | 2.30 | 2.70 | 35 | 80 | 0.30 | 20 | 66 | 0.3 | 0.2 | ⊚ | Invention |
| 507 | ″ | ″ | 1.30 | ″ | 0.80 | 2.10 | 35 | 80 | 0.50 | 79 | 290 | 0.2 | 0.3 | ⊚ | Invention |
| 508 | ″ | ″ | 0.70 | ″ | 1.40 | 2.10 | 35 | 80 | 0.50 | 56 | 236 | 0.4 | 0.4 | ⊚ | Invention |
| 509 | ″ | ″ | 0.40 | ″ | 1.70 | 2.10 | 35 | 80 | 0.40 | 44 | 209 | 0.6 | 0.4 | ⊚ | Invention |
| 053 | ″ | ″ | 1.30 | ″ | 0.50 | 1.80 | 35 | 80 | 1.60 | 130 | 418 | 1.0 | 1.4 | X | Compar- |
| | | | | | | | | | | | | | | | ison |
| 054 | ″ | ″ | 0.30 | ″ | 2.65 | 2.95 | 35 | 80 | 1.80 | −20 | 21 | 1.8 | 12.0 | X | Compar- |
| | | | | | | | | | | | | | | | ison |

*1: A 2/1 (parts by mass) mixture of TPP (triphenyl phosphate) and BDP (biphenyl diphenyl phosphate).

### Example 2

### Production of Polarizing Plate

### <Production of Polarizing Plate 01>

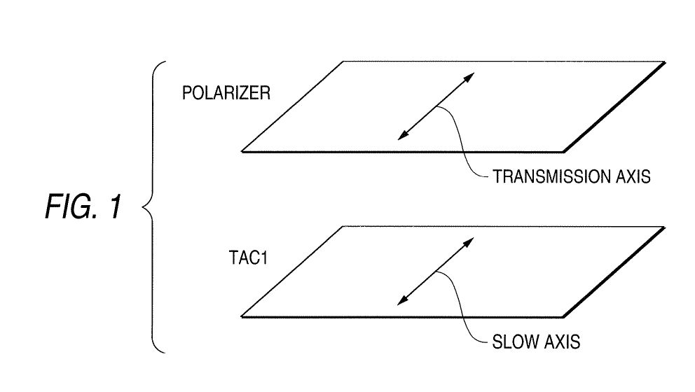

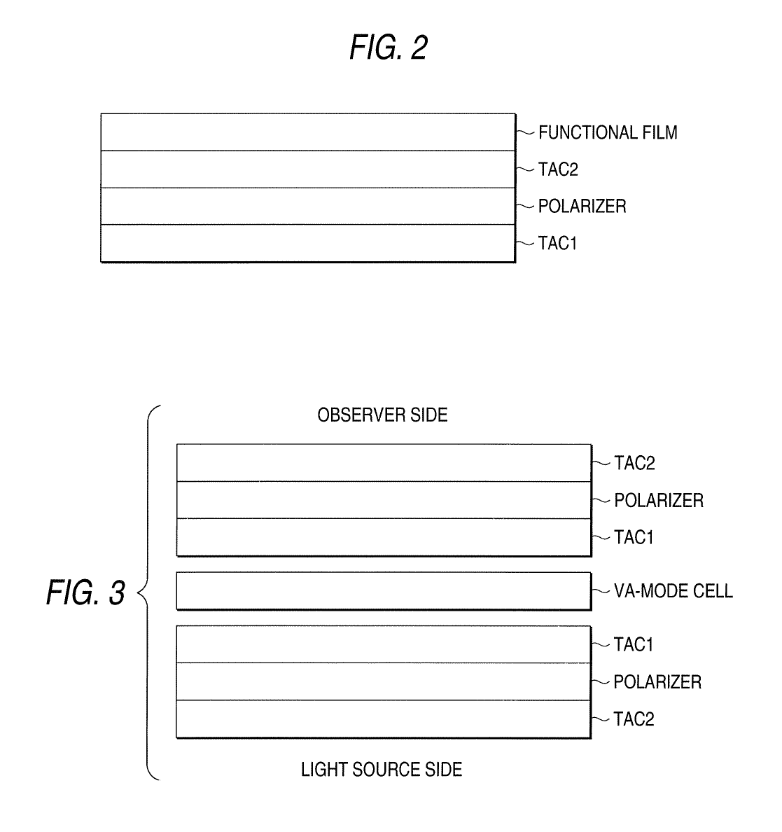

Iodine was adsorbed to a stretched polyvinyl alcohol film to produce a polarizer. The cellulose acylate film produced in Example 1 (Samples 305, 403 and 409 and Comparative Samples 032 and 041; corresponding to TAC1 of FIGS. 1 to 3) was laminated to one side of the polarizer similarly to TAC1 of FIG. 2 by using a polyvinyl alcohol-based adhesive. Here, the saponification treatment was performed under the following conditions.

An aqueous solution containing 1.5 mol/liter of sodium hydroxide was prepared and kept at 55° C. Also, an aqueous solution containing 0.005 mol/liter of dilute sulfuric acid was prepared and kept at 35° C. The cellulose acylate film produced was dipped in the aqueous sodium hydroxide solution prepared above for 2 minutes and then dipped in water to thoroughly wash out the aqueous sodium hydroxide solution. Subsequently, the film was dipped in the aqueous dilute sulfuric acid solution prepared above for 1 minute and then dipped in water to thoroughly wash out the aqueous dilute sulfuric acid solution. Thereafter, the sample was well dried at 120° C.

A commercially available cellulose triacetate film (FUJITAC TD80UF, produced by Fuji Photo Film Co., Ltd.; corresponding to TAC2 of FIG. 2) was subjected to a saponification treatment and laminated to the opposite side of the polarizer by using a polyvinyl alcohol-based adhesive.

At this time, as shown in FIG. 1, the transmission axis of the polarizer was disposed to run in parallel with the slow axis of the cellulose acylate film produced in Example 1. The transmission axis of the polarizer and the slow axis of the commercially available cellulose triacetate film were disposed to cross each other at right angles.

In this way, Polarizing Plates 01 (305A, 403A and 409A, and Comparative Samples 032A and 041A) were produced (corresponding to the optical compensation film-integrated polarizing plate of FIG. 2 without a functional film).

### <Production of Polarizing Plate 02>

### (Preparation of Coating Solution for Light-Scattering Layer)

A mixture (50 g) of pentaerythritol triacrylate and pentaerythritol tetraacrylate (PETA, produced by Nippon Kayaku Co., Ltd.) was diluted with 38.5 g of toluene, and 2 g of a polymerization initiator (Irgacure 184, produced by Ciba Specialty Chemicals Corp.) was added thereto and mixed with stirring. The refractive index of the film coating obtained by coating this solution and UV-curing it was 1.51.

To the solution prepared above, 1.7 g of a 30% toluene liquid dispersion of crosslinked polystyrene particles having an average particle size of 3.5 μm (SX-350, produced by The Soken Chemical & Engineering Co., Ltd., refractive index: 1.60) dispersed at 10,000 rpm for 20 minutes by a polytron disperser, and 13.3 g of a 30% toluene liquid dispersion of crosslinked acryl-styrene particles having an average particle diameter of 3.5 μm (produced by The Soken Chemical & Engineering Co., Ltd., refractive index: 1.55) were added. Thereafter, 0.75 g of a fluorine-based surface modifier (FP-1) and 10 g of a silane coupling agent (KBM-5103, produced by Shin-Etsu Chemical Co., Ltd.) were added to complete the solution.

The resulting mixed solution was filtered through a polypropylene-made filter having a pore size of 30 μm to prepare a coating solution for light-scattering layer.

### (Preparation of Sol Solution a)

In a reactor equipped with a stirrer and a reflux condenser, 120 parts of methyl ethyl ketone, 100 parts of acryloyloxypropyltrimethoxysilane (KBM-5103, produced by Shin-Etsu Chemical Co, Ltd.) and 3 parts of diisopropoxyaluminum ethyl acetoacetate were added and mixed, 30 parts of ion exchanged water was added thereto and after allowing the reaction to proceed at 60° C. for 4 hours, the reaction solution was cooled to room temperature to obtain Sol Solution a. The mass average molecular weight was 1,600 and out of the oligomer or greater components, the content of the components having a molecular weight of 1,000 to 20,000 was 100%. The analysis by gas chromatography revealed that the raw material acryloyloxypropyltrimethoxysilane was not remaining at all.

### (Preparation of Coating Solution for Low Refractive Index Layer)

A thermally crosslinking fluorine-containing polymer (13 g) having a refractive index of 1.42 (JN-7228, solid content concentration: 6%, produced by JSR Corp.), 1.3 g of silica sol (silica, product differing in the particle size from MEK-ST, average particle diameter: 45 nm, solid content concentration: 30%, produced by Nissan Chemicals Industries, Ltd.), 0.6 g of Sol Solution a, 5 g of methyl ethyl ketone and 0.6 g of cyclohexanone were added and stirred, and the resulting solution was filtered through a polypropylene-made filter having a pore size of 1 μm to prepare a coating solution for low refractive index layer.

(Production of Transparent Protective Film 01 with Antireflection Layer)

A 80 μm-thick triacetyl cellulose film (TAC-TD80U, produced by Fuji Photo Film Co., Ltd.; corresponding to TAC2 of FIG. 2) was unrolled, and the coating solution for functional layer (light-scattering layer) prepared above was coated thereon by using a doctor blade and a microgravure roll having a diameter of 50 mm and having a gravure pattern with a line number of 180 lines/inch and a depth of 40 μm, under such conditions that the rotation number of gravure roll was 30 rpm and the conveying rate was 30 m/min and after drying at 60° C. for 150 seconds, the coated layer was cured by irradiating an ultraviolet ray at an illuminance of 400 mW/cm² and an irradiation dose of 250 mJ/cm² with use of an air-cooled metal halide lamp of 160 W/cm (manufactured by Eye Graphics Co., Ltd.) under nitrogen purging to form a functional layer of 6 μm in thickness. The obtained film was taken up.

The triacetyl cellulose film having provided thereon the functional layer (light-scattering layer) was again unrolled, and the coating solution for low refractive index layer prepared above was coated on the light-scattering layer side by using a doctor blade and a microgravure roll having a diameter of 50 mm and having a gravure pattern with a line number of 180 lines/inch and a depth of 40 μm, under such conditions that the rotation number of gravure roll was 30 rpm and the conveying rate was 15 m/min and after drying at 120° C. for 150 seconds and further at 140° C. for 8 minutes, and an ultraviolet ray was irradiated thereon at an illuminance of 400 mW/cm² and an irradiation dose of 900 mJ/cm² by using an air-cooled metal halide lamp of 240 W/cm (manufactured by Eye Graphics Co., Ltd.) under nitrogen purging to form a low refractive index layer of 100 nm in thickness. The obtained film (corresponding to functional film/TAC2 of FIG. 2) was taken up.

### (Production of Polarizing Plate 02)

Iodine was adsorbed to a stretched polyvinyl alcohol film to produce a polarizer. Transparent Protective Film 01 with Antireflection Layer (corresponding to functional film/TAC2 of FIG. 2) produced above was subjected to the same saponification as performed in (Production of Polarizing Plate 01), and the surface not having a functional film was laminated to one side of the polarizer by using a polyvinyl alcohol-based adhesive.

The cellulose acylate film produced in Example 1 (Samples 305, 403 and 409 and Comparative Samples 032 and 041; corresponding to TAC1 of FIG. 1) was subjected to the same saponification treatment and laminated to the opposite side of the polarizer by using a polyvinyl alcohol-based adhesive to obtain a polarizing plate of the construction shown in FIG. 2.

The transmission axis of the polarizer was disposed to run in parallel with the slow axis of the cellulose acylate film produced in Example 1 (FIG. 1). The transmission axis of the polarizer and the slow axis of the commercially available cellulose triacetate film were disposed to cross each other at right angles. In this way, Polarizing Plate 02 (305B, 403B, 409B and Comparative Samples 032B and 041B; polarizing plate integrated with functional film and optical compensation film (FIG. 2)) was produced.

The spectral reflectance of the polarizing plate at an incident angle of 5° in the wavelength region of 380 to 780 nm was measured from the functional film side by using a spectrophotometer (manufactured by JASCO Corp.), and the integrating sphere average reflectance in the range from 450 to 650 nm was determined and found to be 2.3% on all the samples.

The polarizing plate combined such that the cellulose acylate film of the present invention came to the inner side of the polarizer was measured on the single plate transmittance TT, parallel transmittance PT and cross transmittance CT in the range of 380 to 780 nm at 25° C. and 60% RH by using a spectrophotometer (UV3100PC), and the average value in the region of 400 to 700 nm and the polarization degree P were determined, as a result, TT was from 40.8 to 44.7, PT was from 34 to 38.8, CT was 1.0 or less, and P was from 99.98 to 99.99. Also, the cross transmittances T(380), T(410) and T(700) at wavelengths of 380 nm, 410 nm and 700 nm were 1.0 or less, 0.5 or less, and 0.3 or less, respectively.

Furthermore, in the endurance test of polarizing plate at 60° C. and 95% RH for 500 hours, all samples were in the ranges of −0.1≦ΔCT≦0.2 and −2.0≦ΔP≦0, and in the test at 60° C. and 90% RH, the results were −0.05≦ΔCT≦0.15 and −1.5 ΔP≦0.

### <Production of Polarizing Plate 03>

### (Preparation of Coating Solution for Hardcoat Layer)

To 750.0 parts by mass of trimethylolpropane triacrylate (TMPTA, produced by Nippon Kayaku Co., Ltd.), 270.0 parts by mass of poly(glycidyl methacrylate) having a mass average molecular weight of 3,000, 730.0 g of methyl ethyl ketone, 500.0 g of cyclohexanone and 50.0 g of a photopolymerization initiator (Irgacure 184, produced by Nippon Ciba Geigy) were added and stirred. The resulting solution was filtered through a polypropylene-made filter having a pore size of 0.4 μm to prepare a coating solution for hardcoat layer.

### (Preparation of Titanium Dioxide Fine Particle Liquid Dispersion)

The titanium dioxide fine particle used was a titanium dioxide fine particle containing cobalt and being surface-treated with aluminum hydroxide and zirconium hydroxide (MPT-129, produced by Ishihara Sangyo Kaisha, Ltd.).

To 257.1 g of this particle, 38.6 g of a dispersant shown below and 704.3 g of cyclohexanone were added, and the resulting mixture was dispersed by a Dyno mill to prepare a titanium dioxide liquid dispersion having a mass average diameter of 70 nm.

### Dispersant:

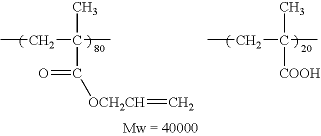

### (Preparation of Coating Solution for Medium Refractive Index Layer)

To 88.9 g of the titanium dioxide liquid dispersion prepared above, 58.4 g of a mixture of dipentaerythritol pentaacrylate and dipentaerythritol hexaacrylate (DPHA), 3.1 g of a photopolymerization initiator (Irgacure 907), 1.1 g of a photosensitizer (Kayacure DETX, produced by Nippon Kayaku Co., Ltd.), 482.4 g of methyl ethyl ketone and 1,869.8 g of cyclohexanone were added and stirred. After thorough stirring, the resulting solution was filtered through a polypropylene-made filter having a pore size of 0.4 μm to prepare a coating solution for medium refractive index layer.

### (Preparation of Coating Solution for High Refractive Index Layer)

To 586.8 g of the titanium dioxide liquid dispersion prepared above, 47.9 g of a mixture of dipentaerythritol pentaacrylate and dipentaerythritol hexaacrylate (DPHA, produced by Nippon Kayaku Co., Ltd.), 4.0 g of a photopolymerization initiator (Irgacure 907, produced by Nippon Ciba Geigy), 1.3 g of a photosensitizer (Kayacure DETX, produced by Nippon Kayaku Co., Ltd.), 455.8 g of methyl ethyl ketone and 1,427.8 g of cyclohexanone were added and stirred. The resulting solution was filtered through a polypropylene-made filter having a pore size of 0.4 μm to prepare a coating solution for high refractive index layer.

### (Preparation of Coating Solution for Low Refractive Index Layer)

Copolymer (P-1) shown below was dissolved in methyl isobutyl ketone to a concentration of 7 mass % and thereto, a terminal methacrylate group-containing silicon resin X-22-164C (produced by Shin-Etsu Chemical Co., Ltd.) in an amount of 3% based on the solid content, and a photoradical generator Irgacure 907 (trade name) in an amount of 5 mass % based on the solid content were added to prepare a coating solution for low refractive index layer.

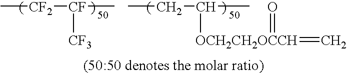

(Production of Transparent Protective Film 02 with Antireflection Layer)

On a 80 μm-thick triacetyl cellulose film (TD-80UF, produced by Fuji Photo Film Co., Ltd.), the coating solution for hardcoat layer was coated by a gravure coater and after drying at 100° C., the coated layer was cured by irradiating an ultraviolet ray at an illuminance of 400 mW/cm² and an irradiation dose of 300 mJ/cm² with use of an air-cooled metal halide lamp of 160 W/cm (manufactured by Eye Graphics Co., Ltd.) while nitrogen purging the system to give an atmosphere having an oxygen concentration of 1.0 vol % or less, whereby a hardcoat layer of 8 μm in thickness was formed.

On the hardcoat layer, the coating solution for medium refractive index layer, the coating solution for high refractive index layer and the coating solution for low refractive index layer were continuously coated using a gravure coater having three coating stations.

The drying conditions of the medium refractive index layer were 100° C. and 2 minutes and as for the ultraviolet curing conditions, curing was performed by using an air-cooled metal halide lamp of 180 W/cm² (manufactured by Eye Graphics Co., Ltd.) at an illuminance of 400 mW/cm² and an irradiation dose of 400 mJ/cm² while nitrogen purging the system to give an atmosphere having an oxygen concentration of 1.0 vol % or less. The medium refractive index layer after curing had a refractive index of 1.630 and a film thickness of 67 nm.

The drying conditions of both the high refractive index layer and the low refractive index layer were 90° C. for 1 minute and then 100° C. for 1 minute and as for the UV curing conditions, curing was performed by using an air-cooled metal halide lamp of 240 W/cm² (manufactured by Eye Graphics Co., Ltd.) at an illuminance of 600 mW/cm² and an irradiation dose of 600 mJ/cm² while nitrogen purging the system to give an atmosphere having an oxygen concentration of 1.0 vol % or less.

The high refractive index layer after curing had a refractive index of 1.905 and a film thickness of 107 nm, and the low refractive index layer had a refractive index of 1.440 and a film thickness of 85 nm. In this way, Transparent Protective Film O₂ with Antireflection Layer was produced (corresponding to functional film/TAC2 of FIG. 2).

### (Production of Polarizing Plate 03)

Polarizing Plate 03 (305C, 403C, 409C and Comparative Samples 032C and 041C; polarizing plate integrated with functional film and optical compensation film (the polarizing plate shown in FIG. 2)) was produced in the same manner as in Polarizing Plate 02 except for using Transparent Protective Film O₂ with Antireflection Layer in place of Transparent Protective Film 01 with Antireflection Layer.

The spectral reflectance of the polarizing plate at an incident angle of 5° in the wavelength region of 380 to 780 nm was measured from the functional film side by using a spectrophotometer (manufactured by JASCO Corp.), and the integrating sphere average reflectance in the range from 450 to 650 nm was determined and found to be 0.4% on all the samples.

### Example 3-1

### Mounting to VA Panel (Two-Sheet Type)

A liquid crystal display device of FIG. 3 was produced. That is, an upper polarizing plate (TAC2 (with or without functional film), polarizer, TAC1), a VA-mode liquid crystal cell (upper substrate, liquid crystal layer, lower substrate) and a lower polarizing plate (TAC1, polarizer, TAC2) were stacked in order from the viewing direction (top), and a backlight source was further disposed.

### <Production of Liquid Crystal Cell>

The liquid crystal cell was produced by setting the cell gap between the substrates to 3.6 μm, injecting dropwise a liquid crystal material (“MLC6608”, produced by Merck) having a negative dielectric anisotropy between the substrates, and sealing the gap to form a liquid crystal layer between the substrates. The retardation (that is, a product Δn·d of the thickness d (μm) of the liquid crystal layer and the refractive index anisotropy Δn) of the liquid crystal layer was set to 300 nm. Incidentally, the liquid crystal material was oriented in the vertical alignment.

In a liquid crystal display device (FIG. 3) using the vertically aligned liquid crystal cell above, as the upper and lower polarizing plates, one sheet of the polarizing plate 01 (403A) produced in of Example 2 using the cellulose acylate film (which functions as an optical compensation sheet) (403) produced in Example 1 was laminated through a pressure-sensitive adhesive on each of the observer side and the backlight side such that the cellulose acylate film (TAC1) produced in Example 1 came to the liquid crystal cell side. At this time, a cross-Nicol arrangement was employed by arranging the transmission axis of the polarizing plate on the observer side to run in the vertical direction and arranging the transmission axis of the polarizing plate on the backlight side to run in the horizontal direction.

The fabricated liquid crystal display device was observed, as a result, a neutral black display could be realized in the frontal direction as well as in the viewing angle direction. Also, the viewing angle was measured in 8 steps from black display (L1) to white display (L8) (the range where the contrast ratio was 10 or more and the black side was free from tone reversal) by using a measuring apparatus (EZ-Contrast 160D, manufactured by ELDIM).

The results shown in Table 6 below were obtained by using any polarizing plate. In the liquid crystal display device of the present invention comprising the polarizing plate of the present invention, a wide viewing angle could be realized.

In Table 6, the “transmission axis” indicates the transmission axis of the upper polarizing plate.

### Example 3-2

### Mounting to VA Panel (Two-Sheet Type)

In a liquid crystal display device (FIG. 3) using the vertically aligned liquid crystal cell above, one sheet of the polarizing plate 01 (403A) produced in Example 2 using the cellulose acylate film (which functions as an optical compensation sheet) (403) produced in Example 1, as the lower polarizing plate, and one sheet of the polarizing plate 02 (403B) produced in Example 2, as the upper polarizing plate, were laminated through a pressure-sensitive adhesive on the observer side and the backlight side, respectively, such that the cellulose acylate film (TAC1) produced in Example 1 came to the liquid crystal cell side. At this time, a cross-Nicol arrangement was employed by arranging the transmission axis of the polarizing plate on the observer side to run in the vertical direction and arranging the transmission axis of the polarizing plate on the backlight side to run in the horizontal direction.

The fabricated liquid crystal display device was observed, as a result, a neutral black display could be realized in the frontal direction as well as in the viewing angle direction. Also, the viewing angle was measured in 8 steps from black display (L1) to white display (L8) (the range where the contrast ratio was 10 or more and the black side was free from tone reversal) by using a measuring apparatus (EZ-Contrast 160D, manufactured by ELDIM).

The results shown Table 6 below were obtained by using any polarizing plate. In the liquid crystal display device of the present invention comprising the polarizing plate of the present invention, a wide viewing angle could be realized.

### Example 3-3

### Mounting to VA Panel (Two-Sheet Type)

In a liquid crystal display device (FIG. 3) using the vertically aligned liquid crystal cell above, one sheet of the polarizing plate 01 (403A) produced in Example 2 using the cellulose acylate film (which functions as an optical compensation sheet) (403) produced in Example 1, as the lower polarizing plate, and one sheet of the polarizing plate 03 (403C) produced in Example 2, as the upper polarizing plate, were laminated through a pressure-sensitive adhesive on the observer side and the backlight side, respectively, such that the cellulose acylate film (TAC1) produced in Example 1 came to the liquid crystal cell side. At this time, a cross-Nicol arrangement was employed by arranging the transmission axis of the polarizing plate on the observer side to run in the vertical direction and arranging the transmission axis of the polarizing plate on the backlight side to run in the horizontal direction.

The fabricated liquid crystal display device was observed, as a result, a neutral black display could be realized in the frontal direction as well as in the viewing angle direction. Also, the viewing angle was measured in 8 steps from black display (L1) to white display (L8) (the range where the contrast ratio was 10 or more and the black side was free from tone reversal) by using a measuring apparatus EZ-Contrast 160D, manufactured by ELDIM).

The results shown Table 6 were obtained by using any polarizing plate. In the liquid crystal display device of the present invention comprising the polarizing plate of the present invention, a wide viewing angle could be realized.

### Comparative Example 3-1

### Mounting to VA Panel (Two-Sheet Type)

In a liquid crystal display device (FIG. 3) using the vertically aligned liquid crystal cell, as the upper and lower polarizing plates, one sheet of the polarizing plate 01 (041A) produced in Example 2 using the cellulose acylate film (which functions as an optical compensation sheet) (041) produced in Comparative Example was laminated through a pressure-sensitive adhesive on each of the observer side and the backlight side such that the cellulose acylate film (TAC1) produced in Example 1 came to the liquid crystal cell side. At this time, a cross-Nicol arrangement was employed by arranging the transmission axis of the polarizing plate on the observer side to run in the vertical direction and arranging the transmission axis of the polarizing plate on the backlight side to run in the horizontal direction.

The fabricated liquid crystal display device was observed, as a result, a neutral black display could be realized in the frontal direction as well as in the viewing angle direction. Also, the viewing angle was measured in 8 steps from black display (L1) to white display (L8) (the range where the contrast ratio was 10 or more and the black side was free from tone reversal) by using a measuring apparatus (EZ-Contrast 160D, manufactured by ELDIM).

The results for the above-mentioned polarizing plates are shown in Table 6 below. It is seen that the viewing angle is narrow as compared with the liquid crystal display device using the polarizing plate of the present invention.

### Comparative Example 3-2

### Mounting to VA Panel (Two-Sheet Type)

In a liquid crystal display device (FIG. 3) using the vertically aligned liquid crystal cell, one sheet of the polarizing plate 01 (041A) produced in Example 2 using the cellulose acylate film (which functions as an optical compensation sheet) (041) produced in Comparative Example, as the lower polarizing plate, and one sheet of the polarizing plate 02 (041B) produced in Example 2, as the upper polarizing plate, were laminated through a pressure-sensitive adhesive on the observer side and the backlight side, respectively, such that the cellulose acylate film (TAC1) produced in Example 1 came to the liquid crystal cell side. At this time, a cross-Nicol arrangement was employed by arranging the transmission axis of the polarizing plate on the observer side to run in the vertical direction and arranging the transmission axis of the polarizing plate on the backlight side to run in the horizontal direction.

The fabricated liquid crystal display device was observed, as a result, a neutral black display could be realized in the frontal direction as well as in the viewing angle direction. Also, the viewing angle was measured in 8 steps from black display (L1) to white display (L8) (the range where the contrast ratio was 10 or more and the black side was free from tone reversal) by using a measuring apparatus (EZ-Contrast 160D, manufactured by ELDIM).

The results for the above-mentioned polarizing plates are shown in Table 6 below. It is seen that the viewing angle is narrow as compared with the liquid crystal display device using the polarizing plate of the present invention.

### Comparative Example 3-3

### Mounting to VA Panel (Two-Sheet Type)

In a liquid crystal display device (FIG. 3) using the vertically aligned liquid crystal cell, one sheet of the polarizing plate 01 (041A) produced in Example 2 using the cellulose acylate film (which functions as an optical compensation sheet) (041) produced in Comparative Example, as the lower polarizing plate, and one sheet of the polarizing plate 03 (041C) produced in Example 2, as the upper polarizing plate, were laminated through a pressure-sensitive adhesive on the observer side and the backlight side, respectively, such that the cellulose acylate film (TAC1) produced in Example 1 came to the liquid crystal cell side. At this time, a cross-Nicol arrangement was employed by arranging the transmission axis of the polarizing plate on the observer side to run in the vertical direction and arranging the transmission axis of the polarizing plate on the backlight side to run in the horizontal direction.

The fabricated liquid crystal display device was observed, as a result, a neutral black display could be realized in the frontal direction as well as in the viewing angle direction. Also, the viewing angle was measured in 8 steps from black display (L1) to white display (L8) (the range where the contrast ratio was 10 or more and the black side was free from tone reversal) by using a measuring apparatus (EZ-Contrast 160D, manufactured by ELDIM).

The results for the above-mentioned polarizing plates are shown in Table 6 below. It is seen that the viewing angle is narrow as compared with the liquid crystal display device using the polarizing plate of the present invention.

TABLE 6

| | Viewing angle | |
|---|---|---|
| Liquid Crystal Display | Transmission | Direction at 45° |
| Device | Axis Direction | from Transmission Axis |
| Example 3-1 | >80° | >80° |
| Example 3-2 | >80° | >80° |
| Example 3-3 | >80° | >80° |
| Comparative Example 3-1 | 72° | 67° |
| Comparative Example 3-2 | 75° | 72° |
| Comparative Example 3-3 | 73° | 69° |

### Example 3-4

### Mounting to VA Panel (One-Sheet Type)

A liquid crystal display device of FIG. 3 was produced. That is, an upper polarizing plate (TAC2 (with or without functional film), polarizer, TAC1), a VA-mode liquid crystal cell (upper substrate, liquid crystal layer, lower substrate) and a lower polarizing plate (TAC1, polarizer, TAC2) were stacked in order from the viewing direction (top), and a backlight source was further disposed. In the following Examples, a commercially available polarizing plate (HLC2-5618, manufactured by Sanritz Corp.) was used for the upper polarizing plate, and an optical compensation film-integrated polarizing plate was used for the lower polarizing plate.

### <Production of Liquid Crystal Cell>

The liquid crystal cell was produced by setting the cell gap between the substrates to 3.6 μm, injecting dropwise a liquid crystal material (“MLC6608”, produced by Merck) having a negative dielectric anisotropy between the substrates, and sealing the gap to form a liquid crystal layer between the substrates. The retardation (that is, a product Δn·d of the thickness d (μm) of the liquid crystal layer and the refractive index anisotropy Δn) of the liquid crystal layer was set to 300 nm. Incidentally, the liquid crystal material was oriented in the vertical alignment.

In a liquid crystal display device (FIG. 3) using the vertically aligned liquid crystal cell above, one sheet of a commercially available super-high contrast product (BLC2-5618), as the upper polarizing plate, and one sheet of the polarizing plate 01 (305A) produced in Example 2 using the optical compensation sheet (305) produced in Example 1, as the lower polarizing plate, were laminated through a pressure-sensitive adhesive on the observer side and the backlight side, respectively, such that the cellulose acylate film (TAC1) produced in Example 1 came to the liquid crystal cell side. At this time, a cross-Nicol arrangement was employed by arranging the transmission axis of the polarizing plate on the observer side to run in the vertical direction and arranging the transmission axis of the polarizing plate on the backlight side to run in the horizontal direction.

The fabricated liquid crystal display device was observed, as a result, a neutral black display could be realized in the frontal direction as well as in the viewing angle direction. Also, the viewing angle was measured in 8 steps from black display (L1) to white display (L8) (the range where the contrast ratio was 10 or more and the black side was free from tone reversal) by using a measuring apparatus (EZ-Contrast 160D, manufactured by ELDIM).

The results for the above-mentioned polarizing plates are shown in Table 7 below. In the liquid crystal display device of the present invention comprising the polarizing plate of the present invention, a wide viewing angle could be realized.

In Table 7, the “transmission axis” indicates the transmission axis of the upper polarizing plate.

### Comparative Example 3-4

### Mounting to VA Panel (One-Sheet Type)

The production was performed thoroughly in the same manner as in Example 3-4 except for changing the lower polarizing plate of Example 3-4 to (032A).

The results for the above-mentioned polarizing plates are shown in Table 7 below. It is seen that the viewing angle is narrow as compared with the liquid crystal display device using the polarizing plate of the present invention.

TABLE 7

| | Viewing Angle | |
|---|---|---|
| Liquid Crystal | Transmission | Direction at 45° |
| Display Device | Axis Direction | from Transmission Axis |
| Example 3-4 | >80° | >80° |
| Comparative Example 3-4 | 72° | 70° |

### Example 4

The films in Table 8 were produced in the same manner as the films in Table 2 except for changing only the cast width, the substitution degree of mixed fatty acid ester, the stretch ratio, and the film thickness after drying.

From comparison of Samples 651 to 655 where the total substitution degree is fixed, it is seen that although the cast width is the same and 2,500 mm, when the propionyl substitution degree out of the substitution degree characteristics of CAP is sequentially increased, the PV value of film thickness, the slow axis angle, and the standard deviation of slow axis angle variation each does not exhibit monotonous dependency but an optimal region is present in the substitution degrees A and B and the optical unevenness is improved. Particularly, in Sample 651, drying in the thickness direction did not proceed uniformly due to the small propionyl substitution degree and optical unevenness was generated. Also, it is seen that in Samples 656 and 657 having a small total substitution degree and in Samples 660 and 661 having a large acetyl substitution degree, the PV value of film thickness is 1 μm or more, the slow axis angle is 1° or more, and the standard deviation of slow axis angle variation is as large as 1° or more, giving rise to reduction in the contrast of the display image, whereas in all of the samples of the present invention, the PV value of film thickness is less than 1 μm, both the slow axis angle and the standard deviation of slow axis angle variation are less than 1°, and the performance in terms of optical unevenness is good.

Furthermore, the films in Table 9 which were produced in the same manner as the films in Table 8 except for adding an Re adjusting agent are revealed to have the same tendency as above.

The films in Table 10 were produced in the same manner as the films in Table 8 except that at the film forming of the films shown in Table 8, unstretched film (residual solvent amount: from 0.5 to 0.7 wt %) was dry-stretched at Tg of film+10° C.

In the case of dry-stretched film, the optical unevenness of Films 802 to 805 of the present invention having a wider cast width is improved to a good level.

TABLE 8
Physical Properties of Stretched Film (mixed fatty acid ester); no Re adjusting agent

| | | | | | | | | | | | Optical Characteristics of Film | | | | | |
|---|---|---|---|---|---|---|---|---|---|---|---|---|---|---|---|---|
| | | | | | | | | | | | | | | Standard | | |
| | | | | Pr Group | | | | | Film | PV | | | | Deviation | | |
| | | Ac Group | | | | Total | | | Thick- | Value | | | | of | Opti- | |
| | Kind | | Substi- | | Substi- | Substi- | | | ness | of Film | | | Slow | Slow Axis | cal | |
| Sam- | of | | tution | | tution | tution | Cast | Stretch | after | Thick- | | | Axis | Angle | Une- | |
| ple | Cot- | | Degree | | Degree | Degree | Width | Ratio | Drying | ness | Re | Rth | Angle | Variation | ven- | |
| No. | ton | Kind | A | Kind | B | A + B | [mm] | [%] | [μm] | [μm] | [nm] | [nm] | [°] | [°] | ness | Remarks |
| 651 | CAP | Ac | 1.55 | Pr | 0.45 | 2.00 | 2500 | 45 | 50 | 1.60 | 52 | 125 | 1.6 | 2.2 | X | Compar- |
| | | | | | | | | | | | | | | | | ison |
| 652 | ″ | ″ | 1.40 | ″ | 0.60 | 2.00 | 2500 | 45 | 50 | 0.40 | 54 | 132 | 0.3 | 0.2 | Δ | Invention |
| 653 | ″ | ″ | 1.25 | ″ | 0.75 | 2.00 | 2500 | 45 | 50 | 0.30 | 54 | 125 | 0.2 | 0.2 | ◯ | Invention |
| 654 | ″ | ″ | 1.10 | ″ | 0.90 | 2.00 | 2500 | 45 | 50 | 0.30 | 53 | 120 | 0.3 | 0.3 | ◯ | Invention |
| 655 | ″ | ″ | 0.95 | ″ | 1.05 | 2.00 | 2500 | 45 | 50 | 0.40 | 53 | 117 | 0.5 | 0.4 | Δ | Invention |
| 656 | ″ | ″ | 1.10 | ″ | 0.60 | 1.70 | 2500 | 45 | 50 | 1.70 | 64 | 138 | 1.3 | 1.8 | X | Compar- |
| | | | | | | | | | | | | | | | | ison |
| 657 | ″ | ″ | 1.20 | ″ | 0.70 | 1.90 | 2500 | 45 | 50 | 1.60 | 56 | 129 | 1.1 | 1.2 | X | Compar- |
| | | | | | | | | | | | | | | | | ison |
| 658 | ″ | ″ | 1.30 | ″ | 0.80 | 2.10 | 2200 | 45 | 50 | 0.30 | 51 | 122 | 0.3 | 0.3 | ⊚ | Invention |
| 659 | ″ | ″ | 1.40 | ″ | 0.90 | 2.30 | 2200 | 45 | 50 | 0.40 | 45 | 120 | 0.3 | 0.3 | ◯ | Invention |
| 660 | ″ | ″ | 1.50 | ″ | 1.00 | 2.50 | 2200 | 45 | 50 | 1.20 | 41 | 112 | 1.5 | 1.3 | Δ | Compar- |
| | | | | | | | | | | | | | | | | ison |
| 661 | ″ | ″ | 1.60 | ″ | 1.10 | 2.70 | 2200 | 45 | 50 | 1.30 | 38 | 100 | 1.7 | 1.3 | X | Compar- |
| | | | | | | | | | | | | | | | | ison |

*1: A 2/1 (parts by mass) mixture of TPP (triphenyl phosphate) and BDP (biphenyl diphenyl phosphate).

TABLE 9
Physical Properties of Stretched Film (mixed fatty acid ester); Re adjusting agent was added (6% addition)

| | | | | | | | | | | | Optical Characteristics of Film | | | | | |
|---|---|---|---|---|---|---|---|---|---|---|---|---|---|---|---|---|
| | | | | | | | | | | | | | | Standard | | |
| | | | | Pr Group | | | | | Film | PV | | | | Deviation | | |
| | | Ac Group | | | | Total | | | Thick- | Value | | | | of | Opti- | |
| | Kind | | Substi- | | Substi- | Substi- | | | ness | of Film | | | Slow | Slow Axis | cal | |
| Sam- | of | | tution | | tution | tution | Cast | Stretch | after | Thick- | | | Axis | Angle | Une- | |
| ple | Cot- | | Degree | | Degree | Degree | Width | Ratio | Drying | ness | Re | Rth | Angle | Variation | ven- | |
| No. | ton | Kind | A | Kind | B | A + B | [mm] | [%] | [μm] | [μm] | [nm] | [nm] | [°] | [°] | ness | Remarks |
| 751 | CAP | Ac | 1.55 | Pr | 0.45 | 2.00 | 2500 | 40 | 40 | 1.90 | 54 | 128 | 1.8 | 2.4 | X | Compar- |
| | | | | | | | | | | | | | | | | ison |
| 752 | ″ | ″ | 1.40 | ″ | 0.60 | 2.00 | 2500 | 40 | 40 | 0.50 | 55 | 135 | 0.3 | 0.2 | Δ | Invention |
| 753 | ″ | ″ | 1.25 | ″ | 0.75 | 2.00 | 2500 | 40 | 40 | 0.35 | 55 | 127 | 0.3 | 0.2 | ◯ | Invention |
| 754 | ″ | ″ | 1.10 | ″ | 0.90 | 2.00 | 2500 | 40 | 40 | 0.40 | 53 | 123 | 0.4 | 0.3 | ◯ | Invention |
| 755 | ″ | ″ | 0.95 | ″ | 1.05 | 2.00 | 2500 | 40 | 40 | 0.40 | 53 | 120 | 0.5 | 0.4 | Δ | Invention |
| 756 | ″ | ″ | 1.10 | ″ | 0.60 | 1.70 | 2500 | 40 | 40 | 1.90 | 66 | 140 | 1.5 | 1.9 | X | Compar- |
| | | | | | | | | | | | | | | | | ison |
| 757 | ″ | ″ | 1.20 | ″ | 0.70 | 1.90 | 2500 | 40 | 40 | 1.70 | 58 | 130 | 1.2 | 1.4 | X | Compar- |
| | | | | | | | | | | | | | | | | ison |
| 758 | ″ | ″ | 1.30 | ″ | 0.80 | 2.10 | 2200 | 40 | 40 | 0.40 | 51 | 122 | 0.3 | 0.2 | ⊚ | Invention |
| 759 | ″ | ″ | 1.40 | ″ | 0.90 | 2.30 | 2200 | 40 | 40 | 0.40 | 45 | 120 | 0.4 | 0.3 | ◯ | Invention |
| 760 | ″ | ″ | 1.50 | ″ | 1.00 | 2.50 | 2200 | 40 | 40 | 1.20 | 41 | 112 | 1.5 | 1.3 | Δ | Compar- |
| | | | | | | | | | | | | | | | | ison |
| 761 | ″ | ″ | 1.60 | ″ | 1.10 | 2.70 | 2200 | 40 | 40 | 1.30 | 38 | 100 | 1.7 | 1.3 | X | Compar- |
| | | | | | | | | | | | | | | | | ison |

*1: A 2/1 (parts by mass) mixture of TPP (triphenyl phosphate) and BDP (biphenyl diphenyl phosphate).

TABLE 10
Physical Properties of Stretched Film (mixed fatty acid ester); no Re adjusting agent, dry stretching

| | | Ac Group | | Bu/Pr Group | | | | | |
|---|---|---|---|---|---|---|---|---|---|
| | Kind of | | Substitution | | Substitution | Total Substitution Degree | Cast Width | Residual Solvent Amount at | |
| Sample No. | Cotton | Kind | Degree A | Kind | Degree B | A + B | [mm] | Stretching [wt %] | Remarks |
| 801 | CAP | Ac | 1.55 | Pr | 0.45 | 2.00 | 2500 | 0.6 | Comparison |
| 802 | ″ | ″ | 1.40 | ″ | 0.60 | 2.00 | 2500 | 0.6 | Invention |
| 803 | ″ | ″ | 1.25 | ″ | 0.75 | 2.00 | 2500 | 0.7 | Invention |
| 804 | ″ | ″ | 1.10 | ″ | 0.90 | 2.00 | 2500 | 0.5 | Invention |
| 805 | ″ | ″ | 0.95 | ″ | 1.05 | 2.00 | 2500 | 0.6 | Invention |
| 806 | ″ | ″ | 1.10 | ″ | 0.60 | 1.70 | 2500 | 0.6 | Comparison |
| 807 | ″ | ″ | 1.20 | ″ | 0.70 | 1.90 | 2500 | 0.5 | Comparison |
| 808 | ″ | ″ | 1.30 | ″ | 0.80 | 2.10 | 2200 | 0.5 | Invention |
| 809 | ″ | ″ | 1.40 | ″ | 0.90 | 2.30 | 2200 | 0.5 | Invention |
| 810 | ″ | ″ | 1.50 | ″ | 1.00 | 2.50 | 2200 | 0.5 | Comparison |
| 811 | ″ | ″ | 1.60 | ″ | 1.10 | 2.70 | 2200 | 0.6 | Comparison |

| | | | | Optical Characteristics of Film | | | | | |
|---|---|---|---|---|---|---|---|---|---|
| | | | | | | | Standard Deviation | | |
| Sample | Stretch Ratio | Film Thickness after | PV Value of Film | Re | Rth | Slow Axis | of Slow Axis | | |
| No. | [%] | Drying [μm] | Thickness [μm] | [nm] | [nm] | Angle [°] | Angle Variation [°] | Optical Unevenness | Remarks |
| 801 | 50 | 50 | 1.50 | 54 | 133 | 1.9 | 2.4 | X | Comparison |
| 802 | 50 | 50 | 0.30 | 54 | 130 | 0.3 | 0.2 | ◯ | Invention |
| 803 | 50 | 50 | 0.30 | 55 | 124 | 0.2 | 0.2 | ⊚ | Invention |
| 804 | 50 | 50 | 0.30 | 54 | 122 | 0.3 | 0.3 | ⊚ | Invention |
| 805 | 50 | 50 | 0.40 | 53 | 118 | 0.5 | 0.4 | ◯ | Invention |
| 806 | 50 | 50 | 1.80 | 62 | 136 | 1.6 | 1.7 | X | Comparison |
| 807 | 50 | 50 | 1.50 | 55 | 127 | 1.3 | 1.2 | X | Comparison |
| 808 | 50 | 50 | 0.30 | 52 | 123 | 0.3 | 0.3 | ⊚ | Invention |
| 809 | 50 | 50 | 0.40 | 44 | 121 | 0.3 | 0.3 | ◯ | Invention |
| 810 | 50 | 50 | 1.50 | 42 | 113 | 1.7 | 1.4 | Δ | Comparison |
| 811 | 50 | 50 | 1.70 | 39 | 103 | 1.8 | 1.3 | X | Comparison |

*1: A 2/1 (parts by mass) mixture of TPP (triphenyl phosphate) and BDP (biphenyl diphenyl phosphate).

The present invention provides an optical film having excellent retardation developability at the front as well as in the thickness direction, favoring small haze, and enhancing the contrast when mounted on a liquid crystal panel. Also, the present invention can reduce the optical unevenness relating to the axial variation in the micro region and decrease the display unevenness when mounted on a liquid crystal panel. Furthermore, the present invention can provide a liquid crystal display device with high contrast and less display unevenness and a polarizing plate for use in the liquid crystal display device.

The entire disclosure of each and every foreign patent application from which the benefit of foreign priority has been claimed in the present application is incorporated herein by reference, as if fully set forth.

What is claimed is:

1. A cellulose acylate film comprising a cellulose acylate satisfying formulae (I) to (III),
2.0≦A+B≦2.8 Formula (I)
0.3≦A≦1.4 Formula (II)
0.6≦B≦2.5 Formula (III)
wherein in formulae (I) to (III), A is the substitution degree by an acetyl group to the hydroxyl group of the glucose unit of the cellulose acylate, and B is the substitution degree by an acyl group having a carbon number of 3 or more to the hydroxyl group of the glucose unit of the cellulose acylate, and
wherein a width of a cast film when casting a dope comprising the cellulose acylate is from 2,000 to 4,000 mm, and
the cellulose acylate film is formed through the cast film.

2. The cellulose acylate film as claimed in claim 1,
wherein the cellulose acylate further satisfies formulae (I′) to (III′):
2.0≦A+B≦2.3 Formula (I′)
1.1≦A≦1.4 Formula (II′)
0.6≦B≦0.9 Formula (III′)
wherein in formulae (I′) to (III′), A and B have the same definitions as in formulae (I) to (III).

3. The cellulose acylate film as claimed in claim 1,
wherein the acyl group having a carbon number of 3 or more is a propionyl group.

4. The cellulose acylate film as claimed in claim 1,
wherein retardation values of the cellulose acylate film satisfy formulae (IV) and (V):
90 nm≦Rth≦160 nm Formula (IV)
30 nm≦Re≦80 nm Formula (V)
wherein in formulae (IV) and (V), Rth is a retardation value in a thickness direction of the cellulose acylate film for light at a wavelength of 590 nm at a humidity in an environment of 25° C. and 60% RH, and Re is a retardation value in an in-plane direction of the cellulose acylate film for light at a wavelength of 590 nm at a humidity in an environment of 25° C. and 60% RH (unit: nm).

5. The cellulose acylate film as claimed in claim 1,
wherein a standard deviation of a slow axis angle variation of the cellulose acylate film is 1.0° or less, and
a PV value of a thickness of the cellulose acylate film is 1.0 μm or less.

6. The cellulose acylate film as claimed in claim 1, which comprises at least one kind of retardation developer comprising a rod-like or discotic compound.

7. The cellulose acylate film as claimed in claim 1, which has been subjected to stretching with a stretch ratio of from 10 to 100%.

8. The cellulose acylate film as claimed in claim 1, which has been subjected to stretching,
wherein, at the starting time of the stretching, the cellulose acylate film had had a residual solvent amount of 1 mass % or less.

9. The cellulose acylate film as claimed in claim 1, which has a thickness of from 20 to 60 μm.

10. A polarizing plate comprising:
a polarizer: and
two transparent protective films disposed on both sides of the polarizer,
wherein at least one of the two transparent protective films is the cellulose acylate film as claimed in claim 1.

11. A polarizing plate as claimed in 10, further comprising, on a surface of one of the two transparent protective films, at least one of a hardcoat layer, an antiglare layer and an antireflection layer.

12. A liquid crystal display device comprising the cellulose acylate film as claimed in claim 1.

13. A liquid crystal display device comprising the polarizing plate as claimed in claim 10.

14. An OCB- or VA-mode liquid crystal display device comprising:
two sheets each of which is the polarizing plate as claimed in claim 10; and
a cell between the two sheets.
